(19) United States
(12) Patent Application Publication
(10) Pub. No.: US 2025/0029450 A1
(43) Pub. Date: Jan. 23, 2025

(54) COLLECTION MECHANIC AND PICK FEATURE SYSTEMS AND METHODS IN ELECTRONIC GAMING

(71) Applicant: Aristocrat Technologies, Inc., Las Vegas, NV (US)

(72) Inventors: Jeffrey Uss, Reno, NV (US); Daniel Marston, Reno, NV (US)

(21) Appl. No.: 18/477,952

(22) Filed: Sep. 29, 2023

Related U.S. Application Data
(60) Provisional application No. 63/514,862, filed on Jul. 21, 2023.

(51) Int. Cl. G07F 17/32

(52) U.S. Cl. CPC G07F 17/3267; G07F 17/3213; G07F 17/3225; G07F 17/329

(57) ABSTRACT

An electronic gaming device including a memory and a processor is described. The processor is configured to cause display of an electronic game including an advanceable path and cause advancement across the advanceable path based on the collection of the collectibles. The processor is also configured to determine that a first threshold of advancement across the advanceable path has been achieved and initiate a pick feature in response to the first threshold being achieved. The processor is also configured to, for at least one play in the pick feature, receive a selection of an advancement option of a plurality of advancement options, determine an amount of advancement between the first threshold of advancement and a second threshold of advancement across the advanceable path associated with the advancement option, cause the amount of advancement to be displayed, and cause the pick feature to end upon an end condition being satisfied.

### CROSS REFERENCE TO RELATED APPLICATIONS

This application claims the benefit of priority to U.S. Provisional Patent Application No. 63/514,862, filed Jul. 21, 2023, which is hereby incorporated by reference herein in its entirety.

### TECHNICAL FIELD

The field of disclosure relates generally to electronic gaming, and more specifically, to collection mechanic and pick feature systems and methods in electronic gaming.

### BACKGROUND

Electronic gaming machines (“EGMs”) or gaming devices provide a variety of wagering games such as slot games, video poker games, video blackjack games, roulette games, video bingo games, keno games and other types of games that are frequently offered at casinos and other locations. Play on EGMs typically involves a player establishing a credit balance by inputting money, or another form of monetary credit, and placing a monetary wager (from the credit balance) on one or more outcomes of an instance (or single play) of a primary or base game. In some cases, a player may qualify for a special mode of the base game, a secondary game, or a bonus round of the base game by attaining a certain winning combination or triggering event in, or related to, the base game, or after the player is randomly awarded the special mode, secondary game, or bonus round. In the special mode, secondary game, or bonus round, the player is given an opportunity to win extra game credits, game tokens or other forms of payout. In the case of “game credits” that are awarded during play, the game credits are typically added to a credit meter total on the EGM and can be provided to the player upon completion of a gaming session or when the player wants to “cash out.”

“Slot” type games are often displayed to the player in the form of various symbols arrayed in a row-by-column grid or matrix. Specific matching combinations of symbols along predetermined paths (or paylines) through the matrix indicate the outcome of the game. The display typically highlights winning combinations/outcomes for identification by the player. Matching combinations and their corresponding awards are usually shown in a “pay-table” which is available to the player for reference. Often, the player may vary his/her wager to include differing numbers of paylines and/or the amount bet on each line. By varying the wager, the player may sometimes alter the frequency or number of winning combinations, frequency or number of secondary games, and/or the amount awarded.

Typical games use a random number generator (RNG) to randomly determine the outcome of each game. The game is designed to return a certain percentage of the amount wagered back to the player over the course of many plays or instances of the game, which is generally referred to as return to player (RTP). The RTP and randomness of the RNG ensure the fairness of the games and are highly regulated. Upon initiation of play, the RNG randomly determines a game outcome and symbols are then selected which correspond to that outcome. Notably, some games may include an element of skill on the part of the player and are therefore not entirely random.

### BRIEF DESCRIPTION

In one aspect, an electronic gaming device including at least one memory with instructions stored thereon and at least one processor in communication with the at least one memory is described. The instructions, when executed by the at least one processor, cause the at least one processor to cause display of an electronic game including an advanceable path wherein the advanceable path includes a plurality of thresholds and wherein a collection of collectibles is associated with advancement across the advanceable path and cause advancement across the advanceable path based on the collection of the collectibles over one or more plays of the electronic game. The instructions also cause the at least one processor to determine that a first threshold of advancement across the advanceable path has been achieved and initiate a pick feature in response to the first threshold being achieved. The instructions further cause the at least one processor to, for at least one play in the pick feature, receive a selection of an advancement option of a plurality of advancement options wherein each of the plurality of advancement options is associated with a number of collectibles, determine an amount of advancement between the first threshold of advancement and a second threshold of advancement across the advanceable path associated with the advancement option, cause the amount of advancement to be displayed, and cause the pick feature to end upon an end condition of a plurality of end conditions being satisfied wherein the plurality of end conditions includes at least one of the second threshold of advancement being satisfied or a predetermined amount of advancement not being achieved across a predetermined number of plays of the pick feature.

In another aspect, at least one non-transitory computer-readable storage medium with instructions stored thereon is described. The instructions, in response to execution by at least one processor, cause the at least one processor to cause display of an electronic game including an advanceable path wherein the advanceable path includes a plurality of thresholds and wherein a collection of collectibles is associated with advancement across the advanceable path and cause advancement across the advanceable path based on the collection of the collectibles over one or more plays of the electronic game. The instructions also cause the at least one processor to determine that a first threshold of advancement across the advanceable path has been achieved and initiate a pick feature in response to the first threshold being achieved. The instructions further cause the at least one processor to, for at least one play in the pick feature, receive a selection of an advancement option of a plurality of advancement options wherein each of the plurality of advancement options is associated with a number of collectibles, determine an amount of advancement between the first threshold of advancement and a second threshold of advancement across the advanceable path associated with the advancement option, cause the amount of advancement to be displayed, and cause the pick feature to end upon an end condition of a plurality of end conditions being satisfied wherein the plurality of end conditions includes at least one of the second threshold of advancement being satisfied or a predetermined amount of advancement not being achieved across a predetermined number of plays of the pick feature.

In another aspect, a method of electronic gaming implemented by at least one processor in communication with at least one memory is described. The method includes causing display of an electronic game including an advanceable path wherein the advanceable path includes a plurality of thresholds and wherein a collection of collectibles is associated with advancement across the advanceable path and causing advancement across the advanceable path based on the collection of the collectibles over one or more plays of the electronic game. The method also includes determining that a first threshold of advancement across the advanceable path has been achieved and initiating a pick feature in response to the first threshold being achieved. The method further includes, for at least one play in the pick feature, receiving a selection of an advancement option of a plurality of advancement options wherein each of the plurality of advancement options is associated with a number of collectibles, determining an amount of advancement between the first threshold of advancement and a second threshold of advancement across the advanceable path associated with the advancement option, causing the amount of advancement to be displayed, and causing the pick feature to end upon an end condition of a plurality of end conditions being satisfied wherein the plurality of end conditions includes at least one of the second threshold of advancement being satisfied or a predetermined amount of advancement not being achieved across a predetermined number of plays of the pick feature.

### BRIEF DESCRIPTION OF THE DRAWINGS

FIG. 1 is an exemplary diagram showing several EGMs networked with various gaming related servers.

FIG. 2A is a block diagram showing various functional elements of an exemplary EGM.

FIG. 2B depicts a casino gaming environment according to one example.

FIG. 2C is a diagram that shows examples of components of a system for providing online gaming according to some aspects of the present disclosure.

FIG. 3 illustrates, in block diagram form, an implementation of a game processing architecture algorithm that implements a game processing pipeline for the play of a game in accordance with various implementations described herein.

FIG. 4 illustrates an example screenshot and/or interface of an electronic game, in accordance with the present disclosure.

FIG. 5 illustrates another example screenshot and/or interface of the electronic game shown in FIG. 4.

FIG. 6 illustrates another example screenshot and/or interface of the electronic game shown in FIG. 4.

FIG. 7 illustrates another example screenshot and/or interface of the electronic game shown in FIG. 4.

FIG. 8 illustrates another example screenshot and/or interface of the electronic game shown in FIG. 4.

FIG. 9 illustrates another example screenshot and/or interface of the electronic game shown in FIG. 4.

FIG. 10 illustrates another example screenshot and/or interface of the electronic game shown in FIG. 4.

FIG. 11 illustrates another example screenshot and/or interface of the electronic game shown in FIG. 4.

FIG. 12 illustrates another example screenshot and/or interface of a transition to a pick feature in the electronic game shown in FIG. 4.

FIG. 13 illustrates an example screenshot and/or interface of a pick feature in the electronic game shown in FIG. 4.

FIG. 14 illustrates another example screenshot and/or interface of the pick feature shown in FIG. 13.

FIG. 15 illustrates another example screenshot and/or interface of the pick feature shown in FIG. 13.

FIG. 16 illustrates another example screenshot and/or interface of the pick feature shown in FIG. 13.

FIG. 17 illustrates another example screenshot and/or interface of the pick feature shown in FIG. 13.

FIG. 18 illustrates another example screenshot and/or interface of the pick feature shown in FIG. 13.

FIG. 19 illustrates another example screenshot and/or interface of the pick feature shown in FIG. 13.

FIG. 20 illustrates another example screenshot and/or interface of the pick feature shown in FIG. 13.

FIG. 21 illustrates another example screenshot and/or interface of the pick feature shown in FIG. 13.

FIG. 22 illustrates another example screenshot and/or interface of the pick feature shown in FIG. 13.

FIG. 23 illustrates an example screenshot and/or interface of a transition to a field goal feature in the pick feature shown in FIG. 13.

FIG. 24 illustrates another example screenshot and/or interface of the field goal feature shown in FIG. 23.

FIG. 25 illustrates another example screenshot and/or interface of the field goal feature shown in FIG. 23.

FIG. 26 illustrates another example screenshot and/or interface of the field goal feature shown in FIG. 23.

FIG. 27 illustrates another example screenshot and/or interface of the field goal feature shown in FIG. 23.

FIG. 28 illustrates another example screenshot and/or interface of the field goal feature shown in FIG. 23.

FIG. 29 illustrates another example screenshot and/or interface of the field goal feature shown in FIG. 23.

FIG. 30 illustrates another example screenshot and/or interface of the field goal feature shown in FIG. 23.

FIG. 31 illustrates another example screenshot and/or interface of the pick feature shown in FIG. 13.

FIG. 32 illustrates another example screenshot and/or interface of the pick feature shown in FIG. 13.

FIG. 33 illustrates another example screenshot and/or interface of the pick feature shown in FIG. 13.

FIG. 34 illustrates another example screenshot and/or interface of the pick feature shown in FIG. 13.

FIG. 35 illustrates another example screenshot and/or interface of the pick feature shown in FIG. 13.

FIG. 36 illustrates another example screenshot and/or interface of the pick feature shown in FIG. 13.

FIG. 37 illustrates another example screenshot and/or interface of the pick feature shown in FIG. 13.

FIG. 38 illustrates another example screenshot and/or interface of the pick feature shown in FIG. 13.

FIG. 39 illustrates another example screenshot and/or interface of the pick feature shown in FIG. 13.

FIG. 40 illustrates another example screenshot and/or interface of the pick feature shown in FIG. 13.

FIG. 41 illustrates another example screenshot and/or interface of the pick feature shown in FIG. 13.

FIG. 42 illustrates another example screenshot and/or interface of the pick feature shown in FIG. 13.

FIG. 43 illustrates another example screenshot and/or interface of the pick feature shown in FIG. 13.

FIG. 44 illustrates another example screenshot and/or interface of the pick feature shown in FIG. 13.

FIG. 45 illustrates another example screenshot and/or interface of the pick feature shown in FIG. 13.

FIG. 46 illustrates another example screenshot and/or interface of the pick feature shown in FIG. 13.

FIG. 47 illustrates another example screenshot and/or interface of the pick feature shown in FIG. 13.

FIG. 48 illustrates another example screenshot and/or interface of the pick feature shown in FIG. 13.

FIG. 49 illustrates another example screenshot and/or interface of the pick feature shown in FIG. 13.

FIG. 50 illustrates another example screenshot and/or interface of the pick feature shown in FIG. 13.

FIG. 51 illustrates another example screenshot and/or interface of the pick feature shown in FIG. 13.

FIG. 52 illustrates another example screenshot and/or interface of the pick feature shown in FIG. 13.

FIG. 53 illustrates another example screenshot and/or interface of the pick feature shown in FIG. 13.

FIG. 54 illustrates another example screenshot and/or interface of the pick feature shown in FIG. 13.

FIG. 55 illustrates another example screenshot and/or interface of the pick feature shown in FIG. 13.

FIG. 56 illustrates another example screenshot and/or interface of the pick feature shown in FIG. 13.

FIG. 57 illustrates another example screenshot and/or interface of the pick feature shown in FIG. 13.

FIG. 58 illustrates another example screenshot and/or interface of the pick feature shown in FIG. 13.

FIG. 59 illustrates an example screenshot and/or interface of a transition to a wheel feature in the electronic game shown in FIG. 4.

FIG. 60 illustrates another example screenshot and/or interface of the wheel feature shown in FIG. 59.

FIG. 61 illustrates another example screenshot and/or interface of the wheel feature shown in FIG. 59.

FIG. 62 illustrates another example screenshot and/or interface of the wheel feature shown in FIG. 59.

FIG. 63 illustrates another example screenshot and/or interface of the wheel feature shown in FIG. 59.

FIG. 64 illustrates another example screenshot and/or interface of the wheel feature shown in FIG. 59.

FIG. 65 illustrates another example screenshot and/or interface of the wheel feature shown in FIG. 59.

FIG. 66 illustrates an example screenshot and/or interface of a transition to a defense feature in the electronic game shown in FIG. 4.

FIG. 67 illustrates another example screenshot and/or interface of the defense feature shown in FIG. 66.

FIG. 68 illustrates another example screenshot and/or interface of the defense feature shown in FIG. 66.

FIG. 69 illustrates an example screenshot and/or interface of a jackpot award in the electronic game shown in FIG. 4.

FIG. 70 illustrates another example screenshot and/or interface of a jackpot award in the electronic game shown in FIG. 4.

FIG. 71 illustrates another example screenshot and/or interface of a jackpot award in the electronic game shown in FIG. 4.

FIG. 72 illustrates an example method of electronic gaming including a collection mechanic and a pick feature, in accordance with the present disclosure.

### DETAILED DESCRIPTION

Provided herein are collection mechanic and pick feature systems and methods in electronic gaming. As described herein, advancement between a starting position and an ending position on a path occurs (e.g., advancement across a football field). Reaching a predefined position on the path before the ending position triggers an additional feature (e.g., a pick feature). The additional feature allows for selection from a plurality of potential advancement options. Advancement occurs until the ending position is reached (e.g., a touchdown is achieved) or another ending condition (e.g., no remaining spins) occurs.

While football (e.g., gridiron football) example embodiments are described, it should be appreciated that additional and/or alternative embodiments (e.g., different from a football theme) are envisioned.

In the example embodiment, a football symbol advances down a virtual field toward the “red zone” (e.g., in the game of football, the area of the field between the 20-yard line and the goal line is often referred to as the “red zone”—a place where the chances of scoring are higher because of proximity to the goal line/end zone). Once the football symbol reaches the red zone, a red zone bonus is triggered. The red zone bonus is a pick feature where the player chooses one of three choices: run, pass, or audible. Once a selection is made, a number of yards gained is revealed, along with an outcome of a touchdown, a first down or a completed play (e.g., not resulting in a touchdown or first down).

Play continues until a first down or touchdown is achieved, or a fourth down outcome where the audible choice is replaced with a field goal choice (e.g., where upon selection of the field goal choice, a field goal may be scored). The feature ends with a touchdown score, field goal score, or a failed fourth down conversion.

The technical problems addressed herein include at least one of: (i) inability of known systems to limit and provide advancement amounts across an advanceable path to trigger a bonus game; (ii) inability of known systems to efficiently communicate advancement across an advanceable path (e.g., in a game with a pick feature); (iii) inability of known systems to provide a collection mechanic followed by a pick feature with another collection mechanic; and (iv) inability of known systems to provide variety in how advancement across an advanceable path is provided in an electronic game.

The resulting technical effects and/or technical benefits achieved by this disclosure include at least one of: (i) ability to limit and provide advancement amounts across an advanceable path to trigger a bonus game; (ii) ability to efficiently communicate advancement across an advanceable path (e.g., in a game with a pick feature); (iii) ability to provide a collection mechanic followed by a pick feature with another collection mechanic; (iv) ability to provide variety in how advancement across an advanceable path is provided in an electronic game; (v) displaying large quantities of complex information in a relatively small display area; (vi) communicating complex information with easy-to-understand animations on a display; (vii) clearly indicating when a player has entered a bonus game; (viii) efficiently communicating different game rules for the bonus game on the display during game play; and (ix) providing versatility as to which devices (e.g., EGMs, mobile devices, etc.) the games described herein may be played on because of the efficient display area designs described herein.

Various interface improvements are provided herein to efficiently and effectively communicate information. For instance, on the way to triggering the red zone bonus game and during the red zone bonus game, in the example embodiment described herein, various animations are provided to communicate advancement across a path and a current status of the game (e.g., number of yards remaining until the red zone is reached, a current “down,” a current distance to the end zone, etc).

Example embodiments described herein may be provided in combination or in isolation to summarize and present game mechanics in a manner that improves the efficiency of computer systems (e.g., electronic gaming systems including electronic gaming devices). Each example system provides an improved user interface displaying a limited set of information to players, potentially within a small screen, such that players can more quickly understand the current status of the game and navigate to the next play of the game (e.g., the base game, the red zone bonus game, a next play selection in the red zone bonus game, etc.). The systems and methods provide improved display device functionality (e.g., on a gaming device) by providing multiple visual indicators that communicate game mechanics described herein to players. The systems and methods provided herein also improve display and device efficiency by eliminating the need for complex information pages describing game mechanics to players. Because of at least the easily-understood animations, symbols, and indicators displayed, the games described herein can be played and understood on a single screen substantially smaller than some of the EGMs described herein (e.g., a mobile device such as a cell phone), thus removing the need for multiple displays with complex information screens including lengthy text.

Certain challenges also arise when providing a game with advancement across a path to trigger a bonus game (e.g., the red zone bonus game). For instance, in the example game described herein, technical challenges arise when selecting a number of yards to provide when advancing toward the red zone. As an example, the number of yards to advance needs to be limited as the ball approaches the red zone such that the ball does not advance past the twenty yard line, but rather reaches the twenty yard line when the red zone bonus is triggered. Accordingly, a technical solution is provided wherein different lookups and/or lookup tables are utilized depending on a current position of the ball on the field.

In other words, as the ball advances down the field, each time an amount of yards is to be provided (e.g., with each “losing” outcome of the base game), a different lookup table may be utilized depending on the current position of the ball on the field (e.g., with the selected lookup table only including amounts of yards to advance that would result in the ball advancing to a position between the current position of the ball and the red zone—but not into and/or past the red zone).

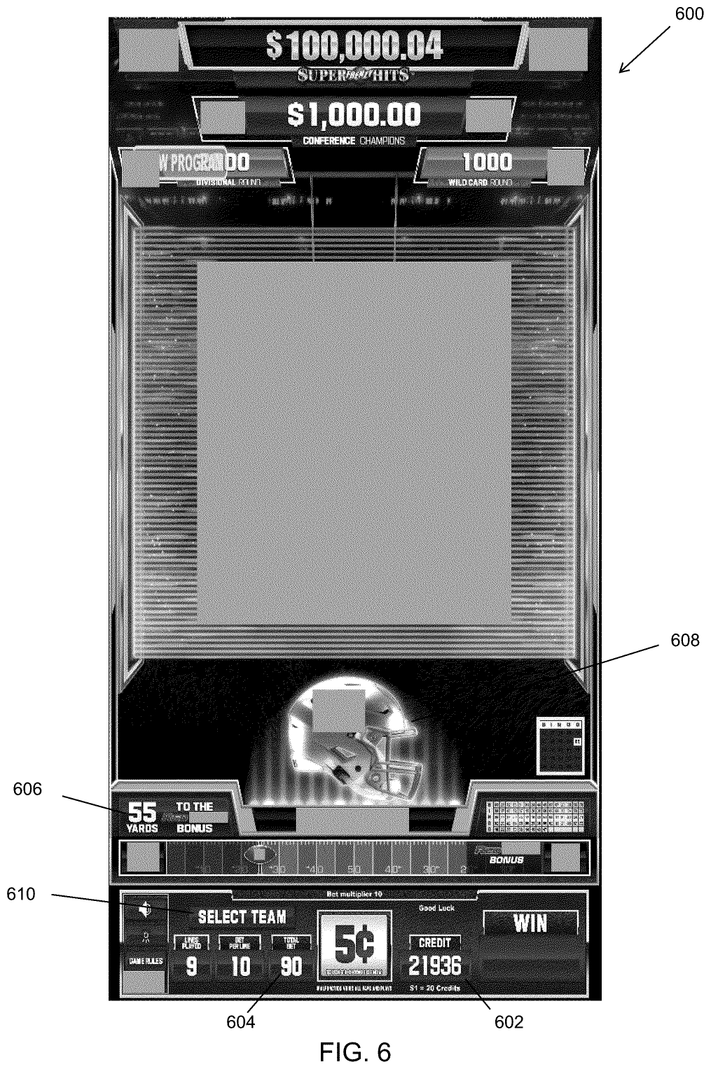

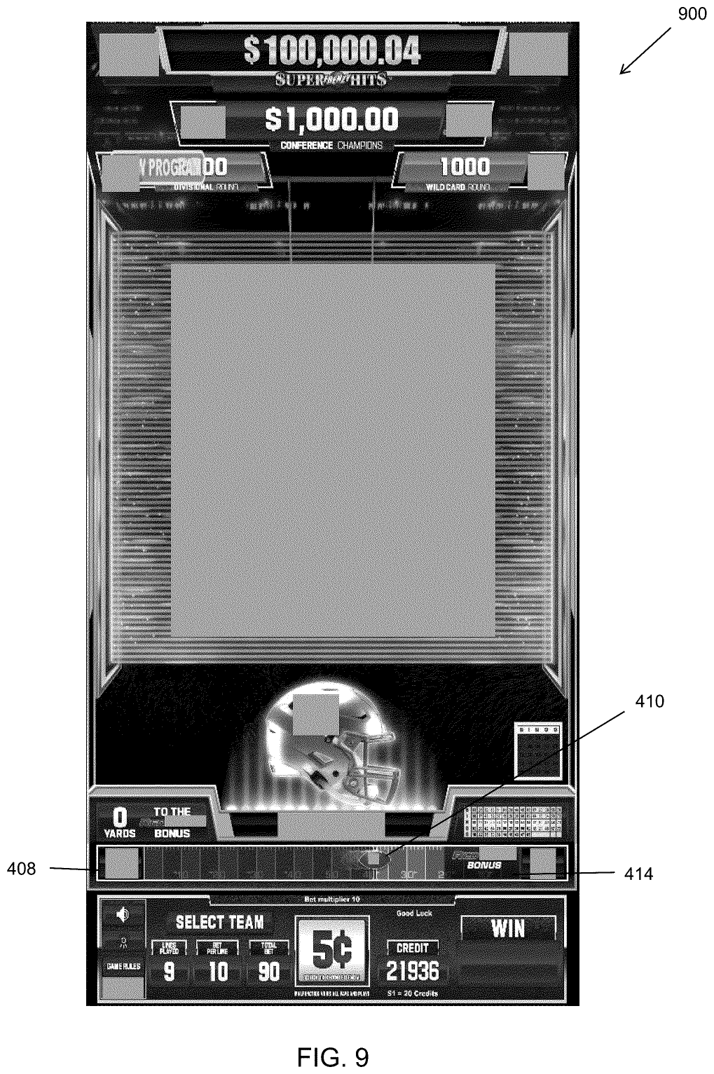

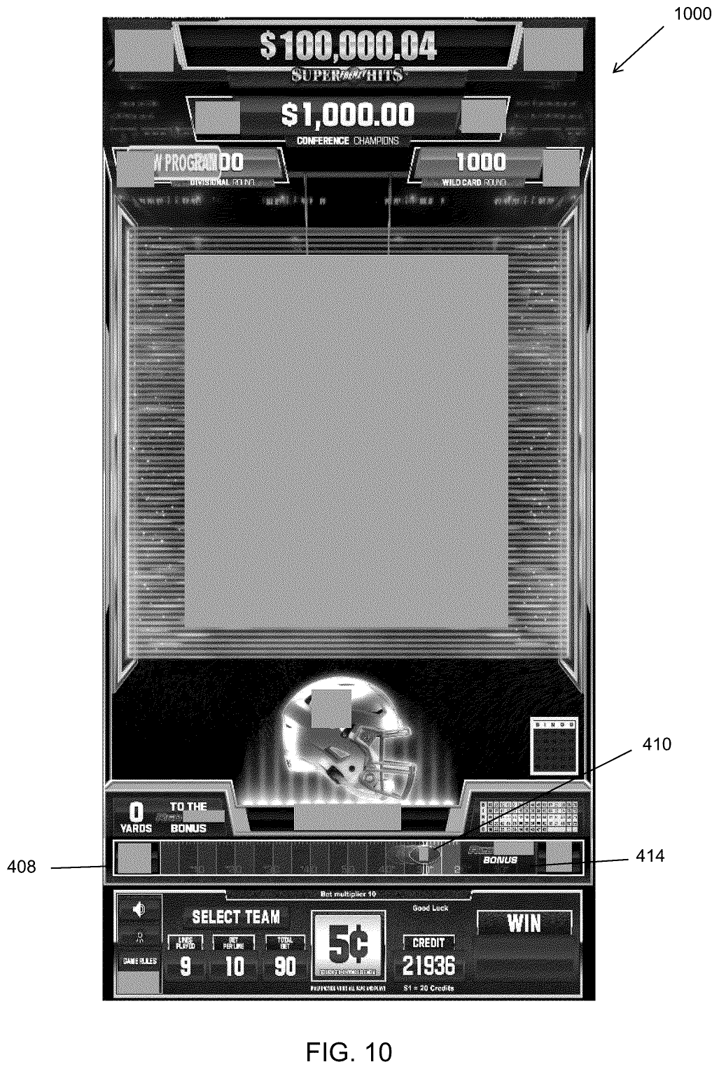

Further, different specific lookups may be utilized during play of the example base game described herein in order to properly provide a transition to the red zone bonus game. For instance, when the red zone bonus game is triggered (e.g., based on one or more bingo pattern pays), a lookup may be performed to identify a current position of the ball on the field and/or an exact number of yards remaining before the red zone is reached. Accordingly, upon the red zone bonus game being triggered and a determination and/or lookup of a number of yards remaining until the red zone is reached, the number of yards remaining until the red zone is reached is provided and the red zone bonus game begins (e.g., see FIGS. 6-12 illustrating an example where 55 yards are needed to reach the red zone and 55 yards are provided).

Additionally, challenges arise when providing an electronic game that includes both a pick feature and a collection mechanic (e.g., the example red zone bonus game described herein). For instance, a number of yards needs to correspond to a number of credits provided such that the red zone bonus game does not terminate earlier or later than required to provide a predetermined number of credits.

In other words, a total number of credits to be provided in the red zone bonus game may be known when the red zone bonus game is triggered (e.g., based on one or more bingo pattern pays). Accordingly, a number of plays provided in the red zone bonus game need to be provided and the number of credits provided for each play of the red zone bonus game need to correspond to the total number of credits. For example, a touchdown (e.g., or other trigger condition to end the red zone bonus game) should not be provided until the total number of credits is provided. Accordingly, in the example embodiment, different numbers of scripts and/or sequences for possible credit amounts to be provided in the red zone bonus game are generated and stored that include a last play of the red zone bonus game corresponding to a number of credits remaining needed to achieve the total number of credits.

For example, if 1000 credits are to be provided in the red zone bonus game, and 300 credits were provided on a previous number of plays in the red zone bonus game, the last play of the red zone bonus game (e.g., based on the selected script and/or sequence) will be 700 credits. Thus, in the example embodiment, the red zone bonus game ends with one of a field goal or touchdown associated with a number of credits remaining, in this case 700 credits, to achieve the total number of credits.

Further, because of the different numbers of scripts and/or sequences for possible credit amounts to be provided in the red zone bonus game, variation is provided in providing game outcomes. For example, a large number of scripts and/or sequences associated with each possible credit amount to be provided are stored such that, even if the same credit amount is provided in two different plays of the red zone bonus game, the way in which those credits are provided may vary. Continuing the 1000 credit example above, a first script and/or sequence that provides 1000 credits may include three plays including a touchdown, a second may include six plays including a field goal, a third may include four plays including a field goal, and so forth.

Computer resources are also saved and computer efficiency is improved at least due to the loading of a script and/or sequence at the beginning of the red zone bonus game such that the various plays of that instance of the red zone bonus game are known before a first play of that instance of the red zone bonus game. Accordingly, different lookups and determinations (e.g., communications with a server to identify outcomes for each play of the red zone bonus game) do not need to occur as the red zone bonus game is provided because the outcomes for each play of that instance of the red zone bonus game are known. Thus, the gaming device providing the red zone bonus game operates more efficiently and computer resources are saved.

In the example embodiment, a collection mechanic is provided where collection (e.g., collecting yards to reach the red zone) triggers a pick feature (e.g., player selection of plays in the red zone), and the pick feature provides awards accumulated in a subsequent in-feature collection mechanic (e.g., advancement between the twenty-yard line and the goal line and a number of credits associated with each play).

For instance, in the example embodiment, an electronic gaming system is provided that causes display of an electronic game including an advanceable path (e.g., a field) wherein the advanceable path includes a plurality of thresholds, and wherein collection of collectibles (e.g., yards) is associated with advancement across the advanceable path and causes advancement across the advanceable path based on collection of the collectibles over one or more plays of the electronic game. The electronic gaming system also determines that a first threshold of advancement across the advanceable path has been achieved and initiates a pick feature in response to the first threshold being achieved.

Further, for at least one play in the pick feature, the electronic gaming system receives a selection of an advancement option of a plurality of advancement options (e.g., a pass option, a run option, and an audible option) wherein each of the plurality of advancement options is associated with a number of collectibles, determines an amount of advancement between the first threshold of advancement (e.g., the twenty-yard line, corresponding to the red zone) and a second threshold of advancement (e.g., the end zone) across the advanceable path associated with the advancement option, causes the amount of advancement to be displayed, and causes the pick feature to end upon an end condition of a plurality of end conditions being satisfied wherein the plurality of end conditions includes at least one of the second threshold of advancement being satisfied or a predetermined amount of advancement not being achieved across a predetermined number of plays of the pick feature.

In some embodiments, the plurality of end conditions further includes a second pick feature wherein the second pick feature includes a field goal feature that allows for selection of a field goal option.

In some embodiments, the electronic gaming system provides a predetermined starting number of plays for the pick feature. In some embodiments, the electronic gaming system tracks a number of plays remaining in the pick feature wherein the number of plays advances between the predetermined starting number of plays and the predetermined number of plays (e.g., four downs) and, when the predetermined amount of advancement is achieved before the predetermined number of plays is reached (e.g., a first down is achieved), causes the number of plays remaining to be reset to the predetermined starting number of plays (e.g., a new first down is provided).

In some embodiments, the plurality of advancement options includes a pass option, a run option, and an audible option.

In some embodiments, a theme of the electronic game is gridiron football wherein the second threshold of advancement being satisfied is associated with a touchdown and wherein the predetermined amount of advancement not being achieved across the predetermined number of plays is associated with a failed fourth down conversion.

In some embodiments, the electronic game is a Class II electronic game. While Class II is described as the example embodiment herein, it should be appreciated that Class III and/or other embodiments are also envisioned in accordance with the spirit of the present disclosure. In some embodiments, the electronic gaming system receives at least one message from a server wherein the at least one message is associated with at least one of a bingo card or a ball call for the electronic game. In some embodiments, the electronic gaming system provides a total output amount at the end of the pick feature wherein the total output amount is determined based at least in part on the at least one message.

At the beginning of the example electronic game described herein, a player is presented with a team-selection lobby (e.g., that may be customized with different teams or themes). Graphics, lighting, and/or audio outputs are adjusted based upon the selection from the lobby (e.g., visuals and sounds associated with the selected team).

For play of a base game, reels spin (e.g., and for Class II embodiments, a bingo card is daubed). After the red zone bonus feature is triggered, as described herein, all wins from an initial spin, feature spins, and any potential wheel bonus rounds are added together and shown in a win meter. A credit meter may also be increased. If a last spin of the red zone bonus feature is a wheel bonus, the award from the wheel bonus will be added to the win meter as well.

During a red zone re-spins (RZRS) feature, a siren sound plays, with sirens playing at the start of reel spins. Reels stop and present wins. If there are additional RZRS plays available, the reels will spin again along with siren sound. A total win for the RZRS feature is added to the win meter. Game play animations and win tunes continue and overlap with multiple RZRS wins. If there are not additional RZRS, the red tint is removed when after a last reel stops spinning and the win is presented.

A wheel bonus can possibly be triggered on the final RZRS play. In some embodiments, only one wheel bonus can be awarded at the end of a RZRS feature.

At the end of the RZRS feature, music plays an outro beginning when the last reel stops on the last RZRS play and is concurrent with a rollup of credits (e.g., unless Wheel Bonus trigger overrides final spin).

In some embodiments, a jackpot may be provided (e.g., upon a certain payline combination being achieved). A banner may be displayed across the top of a screen along with a video shower.

An offensive drive feature may be provided (e.g., as a base game). Reels stop (e.g., in a non-winning position) and a pay table awards an amount of yards to advance (e.g., in random increments of five yards between a current position of the ball on the field and the red zone). Offensive play SFX/music play. For example, a play of fifteen or more yards may result in a random video clip (e.g., highlight) of an actual play (e.g., of the selected team) in a professional football game that also achieved fifteen or more yards. The video clip may correspond to the exact amount of yards achieved. For example, different lookup tables are stored in memory that correspond to different teams, players, play types (e.g., run, pass) and/or yard amounts. Upon the determination of an amount of yards to provide in the electronic game, a lookup is performed in one or more of the tables to determine which highlight(s), if any, to display. For instance, continuing the above example, a lookup would be performed in order to select a video of a fifteen-yard play achieved by the selected team. That video of the fifteen-yard play achieved by the selected team would then be displayed.

As another example, if a play is less than fifteen yards, a video clip may be skipped and a message may appear saying “THAT'S A PLAY OF ‘N’ YARDS! ONLY [new distance to 20-yardline] MORE TO PLAY THE [red zone bonus feature]!” A tracker (e.g., football animation) moves down the field from previous spot and a player perspective on the center of a top-screen will advance along with the tracker.

Upon activation of the red zone bonus feature, music/SFX play while reels are still spinning, video clips play, and the tracker advances to the 20-yard line (e.g., edge of the red zone). All visually adjustable aspects of a device providing the game turn red, display of a top screen is taken over as jackpots are no longer available and collection is complete (e.g., a first collection of yards to the red zone). An intro to the red zone video clip shows w/track playing and a message is displayed “YOU'VE NOW ENTERED THE RED ZONE!”

The transition to the red zone bonus feature completes & player will play the red zone bonus feature with their initially chosen team as the thematic representation. The screen transitions to main bonus intro screen, a bonus win meter with “0” is on screen, trackers (e.g., football, yard markers) are at the twenty-yard line and a message and/or voice-over on the top screen says “FIRST DOWN AT THE 20! LET'S GET DOWN THE FIELD”.

A playbook is displayed with a message of “PICK YOUR PLAY” showing and a grid of three play options is displayed (e.g., run, pass, audible). The player makes a selection (e.g., at a touchscreen where the options are displayed) and credits are revealed and rolled to the win meter. For example, a play reveals a number of yards gained (e.g., with an accompanying video clip). One possible outcome is a touchdown where a player wins a bonus prize and touchdown celebration of lighting, crowd noise, etc. are provided. Another possible outcome is a first down where first down celebration of lighting, crowd noise, etc. along with video/presentation of yards gained are provided. A further possible outcome is a completed play (e.g., zero-nine yards gained (with accompanying video)).

Similar to the above lookup table example, example scoring plays may also be stored in memory. In other words, in addition to video clips of plays where specific yard amounts are achieved, video clips may also be stored as being associated with different scoring plays (e.g., touchdown, field goal, etc.). Accordingly, when a touchdown is achieved, a lookup may be performed to select a video of a touchdown being achieved by the selected team (e.g., and play type). That video of the touchdown being achieved by the selected team would then be displayed.

Picks repeat until a first down or touchdown is made, or a fourth down is reached (e.g., after first down, second down, and third down—associated with three previous picks) and a “FIELD GOAL” option replaces the “AUDIBLE” where the player can elect to “kick” for a score. Selection of the field goal option may result in field goal celebration of lighting, crowd noise, etc.

The red zone bonus feature ends when one of the following conditions happens: i) touchdown score; ii) field goal score; or iii) the player fails to convert fourth down (e.g., maximum of 8 picks—in other words, four plays to get a first down then four more plays maximum).

An outro once the red zone bonus feature ends is provided that includes a video clip of a touchback plays with a transition wipe behind, the main game screen is behind the transition and the tracker is placed at the 25-yard line (e.g., on the opposite end of the field from the red zone), an accompanying message is provided, and a total bonus win message including the amount of credits won in the red zone bonus feature is provided. At the end of the bonus outro the word bubble with the number of credits won disappears and rollup begins.

In some embodiments, a wheel bonus is provided. A player presses play from base game and the game lands on a winning screen showing one or more wheel symbols (e.g., from a standard/base spin or last spin of a red zone bonus). Lighting and music are provided and a bonus logo appears on a top screen. The player initiates a spin (e.g., presses “spin”, with physical lever, the play button, or touching the banner). Lighting changes, dimming of the top screen occurs, the wheel spins, one wheel wedge is won, and a value associated with that wedge is provided. The value may be a jackpot associated with a theme of the game (e.g., playoff wins such as wild card round, divisional round, conference round, or championship round). The value on the wedge is rolled up (e.g., provided). Associated lighting and music are provided along with a video celebration on the top screen.

In some embodiments, a defensive stand feature is provided (e.g., if a defense, or “D-FENCE”, wedge is won during the wheel bonus). Video plays using the selected team's video clips. Different video clips are associated with different wins. For example, a low win is associated with a blocked field goal or stop at the goal-line, a medium win is associated with a strip-sack, fumble recovery, or interception, and a big win is associated with a defensive touchdown (e.g., any of the above for a defensive touchdown, such as a pick-six or strip and score). Credits are provided (e.g., in increments to the final total as the video completes), and the game transitions back to the base game.

In some embodiments, special lighting effects are used during the RZRS feature, big wins, or big “plays” or collection yards for the collection mechanic. Lighting/Music/Presentation may be provided during the wheel bonus trigger, a red zone bonus play with of five or more re-spins, a big win of 10× bet or higher, a big play to trigger the red zone bonus feature, or a jackpot trigger.

In some embodiments, a default home team may be selected (e.g., by a casino operator) and, after a predetermined period of time with no plays of the game (e.g., thirty seconds after cash-out), the game may revert to a theme of the default home team. In some embodiments, the selected team is randomly selected.

In some embodiments, audio will play upon cash in, along with denomination selection and team selection occurring. The game may utilize multiple audio assets (e.g., as described herein) including audio effects that accompany graphic and lighting effects to make the gameplay experience more fun and immersive (e.g., voice overs from broadcasts of actual football games).

An attract mode is also provided that includes an animation within the comic in the top screen, a 3D Logo rotating on top video screen, random video clips shown in rotation, and/or jackpots shown in rotation.

The description provided herein includes certain examples and exemplary use cases. It should be understood that these examples and use cases are included herein for illustrative purposes, and these examples and use cases should not be taken to limit the present disclosure. The systems and methods described herein may be used in many other use cases.

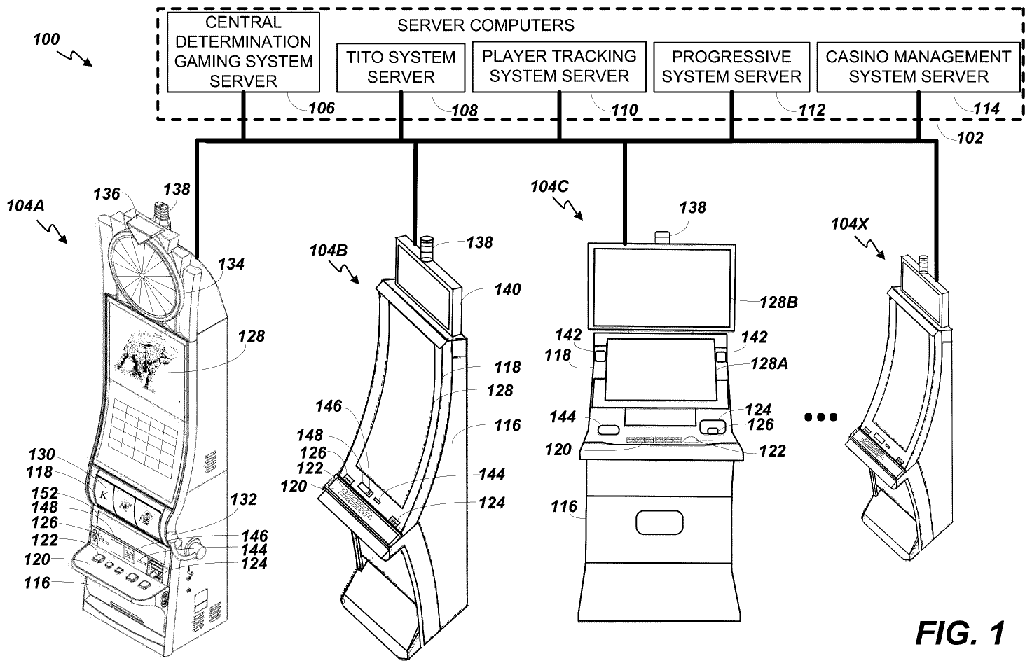

FIG. 1 illustrates several different models of EGMs which may be networked to various gaming related servers. Shown is a system 100 in a gaming environment including one or more server computers 102 (e.g., slot servers of a casino) that are in communication, via a communications network, with one or more gaming devices 104A-104X (EGMs, slots, video poker, bingo machines, etc.) that can implement one or more aspects of the present disclosure. The gaming devices 104A-104X may alternatively be portable and/or remote gaming devices such as, but not limited to, a smart phone, a tablet, a laptop, or a game console. Gaming devices 104A-104X utilize specialized software and/or hardware to form non-generic, particular machines or apparatuses that comply with regulatory requirements regarding devices used for wagering or games of chance that provide monetary awards.

Communication between the gaming devices 104A-104X and the server computers 102, and among the gaming devices 104A-104X, may be direct or indirect using one or more communication protocols. As an example, gaming devices 104A-104X and the server computers 102 can communicate over one or more communication networks, such as over the Internet through a website maintained by a computer on a remote server or over an online data network including commercial online service providers, Internet service providers, private networks (e.g., local area networks and enterprise networks), and the like (e.g., wide area networks). The communication networks could allow gaming devices 104A-104X to communicate with one another and/or the server computers 102 using a variety of communication-based technologies, such as radio frequency (RF) (e.g., wireless fidelity (WiFi®) and Bluetooth®), cable TV, satellite links and the like.

In some implementation, server computers 102 may not be necessary and/or preferred. For example, in one or more implementations, a stand-alone gaming device such as gaming device 104A, gaming device 104B or any of the other gaming devices 104C-104X can implement one or more aspects of the present disclosure. However, it is typical to find multiple EGMs connected to networks implemented with one or more of the different server computers 102 described herein.

The server computers 102 may include a central determination gaming system server 106, a ticket-in-ticket-out (TITO) system server 108, a player tracking system server 110, a progressive system server 112, and/or a casino management system server 114. Gaming devices 104A-104X may include features to enable operation of any or all servers for use by the player and/or operator (e.g., the casino, resort, gaming establishment, tavern, pub, etc.). For example, game outcomes may be generated on a central determination gaming system server 106 and then transmitted over the network to any of a group of remote terminals or remote gaming devices 104A-104X that utilize the game outcomes and display the results to the players.

Gaming device 104A is often of a cabinet construction which may be aligned in rows or banks of similar devices for placement and operation on a casino floor. The gaming device 104A often includes a main door which provides access to the interior of the cabinet. Gaming device 104A typically includes a button area or button deck 120 accessible by a player that is configured with input switches or buttons 122, an access channel for a bill validator 124, and/or an access channel for a ticket-out printer 126.

In FIG. 1, gaming device 104A is shown as a Relm XL™ model gaming device manufactured by Aristocrat® Technologies, Inc. As shown, gaming device 104A is a reel machine having a gaming display area 118 comprising a number (typically 3 or 5) of mechanical reels 130 with various symbols displayed on them. The mechanical reels 130 are independently spun and stopped to show a set of symbols within the gaming display area 118 which may be used to determine an outcome to the game.

In many configurations, the gaming device 104A may have a main display 128 (e.g., video display monitor) mounted to, or above, the gaming display area 118. The main display 128 can be a high-resolution liquid crystal display (LCD), plasma, light emitting diode (LED), or organic light emitting diode (OLED) panel which may be flat or curved as shown, a cathode ray tube, or other conventional electronically controlled video monitor.

In some implementations, the bill validator 124 may also function as a “ticket-in” reader that allows the player to use a casino issued credit ticket to load credits onto the gaming device 104A (e.g., in a cashless ticket (“TITO”) system). In such cashless implementations, the gaming device 104A may also include a “ticket-out” printer 126 for outputting a credit ticket when a “cash out” button is pressed. Cashless TITO systems are used to generate and track unique bar-codes or other indicators printed on tickets to allow players to avoid the use of bills and coins by loading credits using a ticket reader and cashing out credits using a ticket-out printer 126 on the gaming device 104A. The gaming device 104A can have hardware meters for purposes including ensuring regulatory compliance and monitoring the player credit balance. In addition, there can be additional meters that record the total amount of money wagered on the gaming device, total amount of money deposited, total amount of money withdrawn, total amount of winnings on gaming device 104A.

In some implementations, a player tracking card reader 144, a transceiver for wireless communication with a mobile device (e.g., a player's smartphone), a keypad 146, and/or an illuminated display 148 for reading, receiving, entering, and/or displaying player tracking information is provided in gaming device 104A. In such implementations, a game controller within the gaming device 104A can communicate with the player tracking system server 110 to send and receive player tracking information.

Gaming device 104A may also include a bonus topper wheel 134. When bonus play is triggered (e.g., by a player achieving a particular outcome or set of outcomes in the primary game), bonus topper wheel 134 is operative to spin and stop with indicator arrow 136 indicating the outcome of the bonus game. Bonus topper wheel 134 is typically used to play a bonus game, but it could also be incorporated into play of the base or primary game.

A candle 138 may be mounted on the top of gaming device 104A and may be activated by a player (e.g., using a switch or one of buttons 122) to indicate to operations staff that gaming device 104A has experienced a malfunction or the player requires service. The candle 138 is also often used to indicate a jackpot has been won and to alert staff that a hand payout of an award may be needed.

There may also be one or more information panels 152 which may be a back-lit, silkscreened glass panel with lettering to indicate general game information including, for example, a game denomination (e.g., $0.25 or $1), pay lines, pay tables, and/or various game related graphics. In some implementations, the information panel(s) 152 may be implemented as an additional video display.

Gaming devices 104A have traditionally also included a handle 132 typically mounted to the side of main cabinet 116 which may be used to initiate game play.

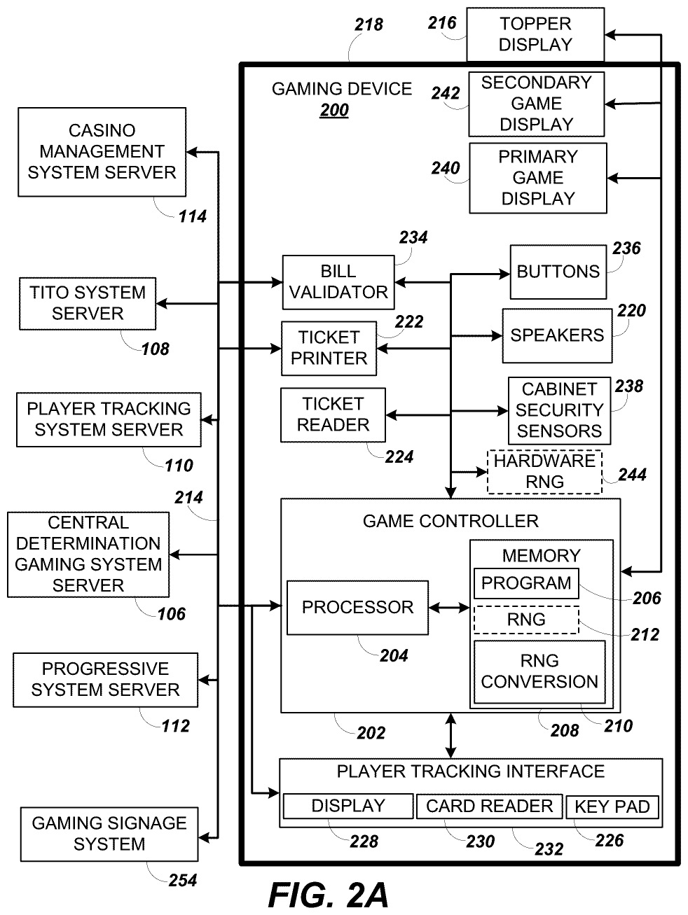

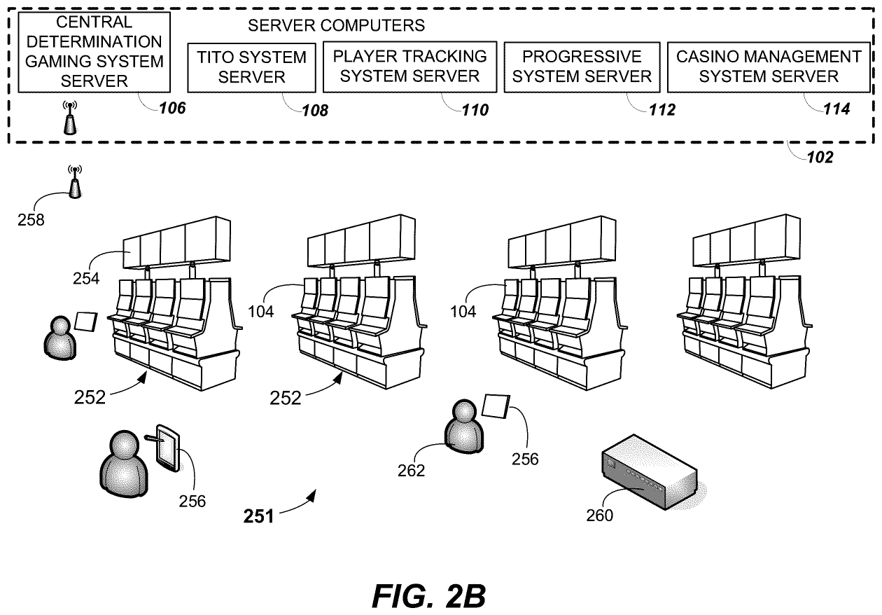

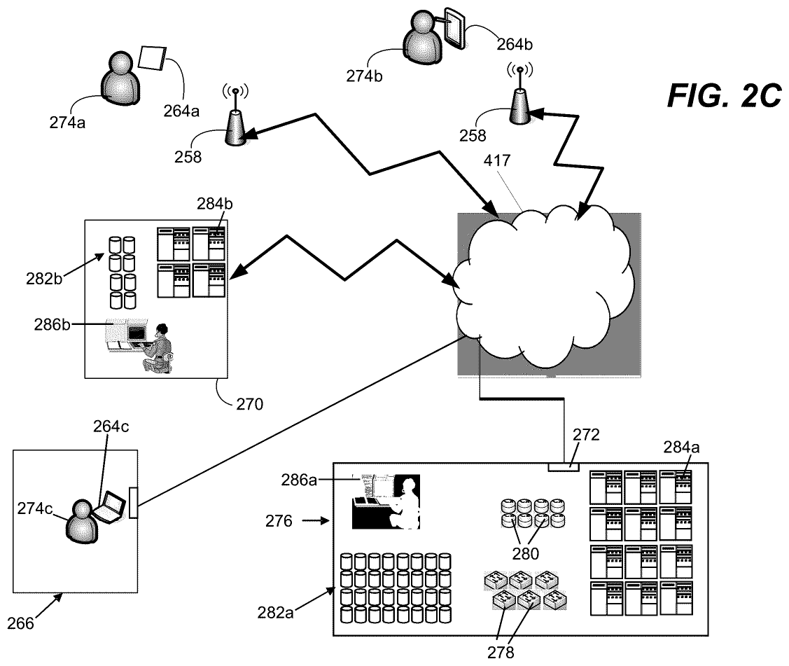

Many or all the above described components can be controlled by circuitry (e.g., a game controller) housed inside the main cabinet 116 of the gaming device 104A, the details of which are shown in FIG. 2A.

An alternative example gaming device 104B illustrated in FIG. 1 is the Arc™ model gaming device manufactured by Aristocrat® Technologies, Inc. Note that where possible, reference numerals identifying similar features of the gaming device 104A implementation are also identified in the gaming device 104B implementation using the same reference numbers. Gaming device 104B does not include physical reels and instead shows game play functions on main display 128. An optional topper screen 140 may be used as a secondary game display for bonus play, to show game features or attraction activities while a game is not in play, or any other information or media desired by the game designer or operator. In some implementations, the optional topper screen 140 may also or alternatively be used to display progressive jackpot prizes available to a player during play of gaming device 104B.

Example gaming device 104B includes a main cabinet 116 including a main door which opens to provide access to the interior of the gaming device 104B. The main or service door is typically used by service personnel to refill the ticket-out printer 126 and collect bills and tickets inserted into the bill validator 124. The main or service door may also be accessed to reset the machine, verify and/or upgrade the software, and for general maintenance operations.

Another example gaming device 104C shown is the Helix™ model gaming device manufactured by Aristocrat© Technologies, Inc. Gaming device 104C includes a main display 128A that is in a landscape orientation. Although not illustrated by the front view provided, the main display 128A may have a curvature radius from top to bottom, or alternatively from side to side. In some implementations, main display 128A is a flat panel display. Main display 128A is typically used for primary game play while secondary display 128B is typically used for bonus game play, to show game features or attraction activities while the game is not in play or any other information or media desired by the game designer or operator. In some implementations, example gaming device 104C may also include speakers 142 to output various audio such as game sound, background music, etc.

Many different types of games, including mechanical slot games, video slot games, video poker, video blackjack, video pachinko, keno, bingo, and lottery, may be provided with or implemented within the depicted gaming devices 104A-104C and other similar gaming devices. Each gaming device may also be operable to provide many different games. Games may be differentiated according to themes, sounds, graphics, type of game (e.g., slot game vs. card game vs. game with aspects of skill), denomination, number of paylines, maximum jackpot, progressive or non-progressive, bonus games, and may be deployed for operation in Class 2 or Class 3, etc.

FIG. 2A is a block diagram depicting exemplary internal electronic components of a gaming device 200 connected to various external systems. All or parts of the gaming device 200 shown could be used to implement any one of the example gaming devices 104A-X depicted in FIG. 1. As shown in FIG. 2A, gaming device 200 includes a topper display 216 or another form of a top box (e.g., a topper wheel, a topper screen, etc.) that sits above cabinet 218. Cabinet 218 or topper display 216 may also house a number of other components which may be used to add features to a game being played on gaming device 200, including speakers 220, a ticket printer 222 which prints bar-coded tickets or other media or mechanisms for storing or indicating a player's credit value, a ticket reader 224 which reads bar-coded tickets or other media or mechanisms for storing or indicating a player's credit value, and a player tracking interface 232. Player tracking interface 232 may include a keypad 226 for entering information, a player tracking display 228 for displaying information (e.g., an illuminated or video display), a card reader 230 for receiving data and/or communicating information to and from media or a device such as a smart phone enabling player tracking. FIG. 2 also depicts utilizing a ticket printer 222 to print tickets for a TITO system server 108. Gaming device 200 may further include a bill validator 234, player-input buttons 236 for player input, cabinet security sensors 238 to detect unauthorized opening of the cabinet 218, a primary game display 240, and a secondary game display 242, each coupled to and operable under the control of game controller 202.

The games available for play on the gaming device 200 are controlled by a game controller 202 that includes one or more processors 204. Processor 204 represents a general-purpose processor, a specialized processor intended to perform certain functional tasks, or a combination thereof. As an example, processor 204 can be a central processing unit (CPU) that has one or more multi-core processing units and memory mediums (e.g., cache memory) that function as buffers and/or temporary storage for data. Alternatively, processor 204 can be a specialized processor, such as an application specific integrated circuit (ASIC), graphics processing unit (GPU), field-programmable gate array (FPGA), digital signal processor (DSP), or another type of hardware accelerator. In another example, processor 204 is a system on chip (SoC) that combines and integrates one or more general-purpose processors and/or one or more specialized processors. Although FIG. 2A illustrates that game controller 202 includes a single processor 204, game controller 202 is not limited to this representation and instead can include multiple processors 204 (e.g., two or more processors).

FIG. 2A illustrates that processor 204 is operatively coupled to memory 208. Memory 208 is defined herein as including volatile and nonvolatile memory and other types of non-transitory data storage components. Volatile memory is memory that do not retain data values upon loss of power. Nonvolatile memory is memory that do retain data upon a loss of power. Examples of memory 208 include random access memory (RAM), read-only memory (ROM), hard disk drives, solid-state drives, universal serial bus (USB) flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, examples of RAM include static random access memory (SRAM), dynamic random access memory (DRAM), magnetic random access memory (MRAM), and other such devices. Examples of ROM include a programmable read-only memory (PROM), an erasable programmable read-only memory (EPROM), an electrically erasable programmable read-only memory (EEPROM), or other like memory device. Even though FIG. 2A illustrates that game controller 202 includes a single memory 208, game controller 202 could include multiple memories 208 for storing program instructions and/or data.

Memory 208 can store one or more game programs 206 that provide program instructions and/or data for carrying out various implementations (e.g., game mechanics) described herein. Stated another way, game program 206 represents an executable program stored in any portion or component of memory 208. In one or more implementations, game program 206 is embodied in the form of source code that includes human-readable statements written in a programming language or machine code that contains numerical instructions recognizable by a suitable execution system, such as a processor 204 in a game controller or other system. Examples of executable programs include: (1) a compiled program that can be translated into machine code in a format that can be loaded into a random access portion of memory 208 and run by processor 204; (2) source code that may be expressed in proper format such as object code that is capable of being loaded into a random access portion of memory 208 and executed by processor 204; and (3) source code that may be interpreted by another executable program to generate instructions in a random access portion of memory 208 to be executed by processor 204.

Alternatively, game programs 206 can be set up to generate one or more game instances based on instructions and/or data that gaming device 200 exchanges with one or more remote gaming devices, such as a central determination gaming system server 106 (not shown in FIG. 2A but shown in FIG. 1). For purpose of this disclosure, the term “game instance” refers to a play or a round of a game that gaming device 200 presents (e.g., via a user interface (UI)) to a player. The game instance is communicated to gaming device 200 via the network 214 and then displayed on gaming device 200. For example, gaming device 200 may execute game program 206 as video streaming software that allows the game to be displayed on gaming device 200. When a game is stored on gaming device 200, it may be loaded from memory 208 (e.g., from a read only memory (ROM)) or from the central determination gaming system server 106 to memory 208.

Gaming devices, such as gaming device 200, are highly regulated to ensure fairness and, in many cases, gaming device 200 is operable to award monetary awards (e.g., typically dispensed in the form of a redeemable voucher). Therefore, to satisfy security and regulatory requirements in a gaming environment, hardware and software architectures are implemented in gaming devices 200 that differ significantly from those of general-purpose computers. Adapting general purpose computers to function as gaming devices 200 is not simple or straightforward because of: (1) the regulatory requirements for gaming devices 200, (2) the harsh environment in which gaming devices 200 operate, (3) security requirements, (4) fault tolerance requirements, and (5) the requirement for additional special purpose componentry enabling functionality of an EGM. These differences require substantial engineering effort with respect to game design implementation, game mechanics, hardware components, and software.

One regulatory requirement for games running on gaming device 200 generally involves complying with a certain level of randomness. Typically, gaming jurisdictions mandate that gaming devices 200 satisfy a minimum level of randomness without specifying how a gaming device 200 should achieve this level of randomness. To comply, FIG. 2A illustrates that gaming device 200 could include an RNG 212 that utilizes hardware and/or software to generate RNG outcomes that lack any pattern. The RNG operations are often specialized and non-generic in order to comply with regulatory and gaming requirements. For example, in a slot game, game program 206 can initiate multiple RNG calls to RNG 212 to generate RNG outcomes, where each RNG call and RNG outcome corresponds to an outcome for a reel. In another example, gaming device 200 can be a Class II gaming device where RNG 212 generates RNG outcomes for creating Bingo cards. In one or more implementations, RNG 212 could be one of a set of RNGs operating on gaming device 200. More generally, an output of the RNG 212 can be the basis on which game outcomes are determined by the game controller 202. Game developers could vary the degree of true randomness for each RNG (e.g., pseudorandom) and utilize specific RNGs depending on game requirements. The output of the RNG 212 can include a random number or pseudorandom number (either is generally referred to as a “random number”).

In FIG. 2A, RNG 212 and hardware RNG 244 are shown in dashed lines to illustrate that RNG 212, hardware RNG 244, or both can be included in gaming device 200. In one implementation, instead of including RNG 212, gaming device 200 could include a hardware RNG 244 that generates RNG outcomes. Analogous to RNG 212, hardware RNG 244 performs specialized and non-generic operations in order to comply with regulatory and gaming requirements. For example, because of regulation requirements, hardware RNG 244 could be a random number generator that securely produces random numbers for cryptography use. The gaming device 200 then uses the secure random numbers to generate game outcomes for one or more game features. In another implementation, the gaming device 200 could include both hardware RNG 244 and RNG 212. RNG 212 may utilize the RNG outcomes from hardware RNG 244 as one of many sources of entropy for generating secure random numbers for the game features.

Another regulatory requirement for running games on gaming device 200 includes ensuring a certain level of RTP. Similar to the randomness requirement discussed above, numerous gaming jurisdictions also mandate that gaming device 200 provides a minimum level of RTP (e.g., RTP of at least 75%). A game can use one or more lookup tables (also called weighted tables) as part of a technical solution that satisfies regulatory requirements for randomness and RTP. In particular, a lookup table can integrate game features (e.g., trigger events for special modes or bonus games; newly introduced game elements such as extra reels, new symbols, or new cards; stop positions for dynamic game elements such as spinning reels, spinning wheels, or shifting reels; or card selections from a deck) with random numbers generated by one or more RNGs, so as to achieve a given level of volatility for a target level of RTP. (In general, volatility refers to the frequency or probability of an event such as a special mode, payout, etc. For example, for a target level of RTP, a higher-volatility game may have a lower payout most of the time with an occasional bonus having a very high payout, while a lower-volatility game has a steadier payout with more frequent bonuses of smaller amounts.) Configuring a lookup table can involve engineering decisions with respect to how RNG outcomes are mapped to game outcomes for a given game feature, while still satisfying regulatory requirements for RTP. Configuring a lookup table can also involve engineering decisions about whether different game features are combined in a given entry of the lookup table or split between different entries (for the respective game features), while still satisfying regulatory requirements for RTP and allowing for varying levels of game volatility.

FIG. 2A illustrates that gaming device 200 includes an RNG conversion engine 210 that translates the RNG outcome from RNG 212 to a game outcome presented to a player. To meet a designated RTP, a game developer can set up the RNG conversion engine 210 to utilize one or more lookup tables to translate the RNG outcome to a symbol element, stop position on a reel strip layout, and/or randomly chosen aspect of a game feature. As an example, the lookup tables can regulate a prize payout amount for each RNG outcome and how often the gaming device 200 pays out the prize payout amounts. The RNG conversion engine 210 could utilize one lookup table to map the RNG outcome to a game outcome displayed to a player and a second lookup table as a pay table for determining the prize payout amount for each game outcome. The mapping between the RNG outcome to the game outcome controls the frequency in hitting certain prize payout amounts.

FIG. 2A also depicts that gaming device 200 is connected over network 214 to player tracking system server 110. Player tracking system server 110 may be, for example, an OASIS® system manufactured by Aristocrat® Technologies, Inc. Player tracking system server 110 is used to track play (e.g. amount wagered, games played, time of play and/or other quantitative or qualitative measures) for individual players so that an operator may reward players in a loyalty program. The player may use the player tracking interface 232 to access his/her account information, activate free play, and/or request various information. Player tracking or loyalty programs seek to reward players for their play and help build brand loyalty to the gaming establishment. The rewards typically correspond to the player's level of patronage (e.g., to the player's playing frequency and/or total amount of game plays at a given casino). Player tracking rewards may be complimentary and/or discounted meals, lodging, entertainment and/or additional play. Player tracking information may be combined with other information that is now readily obtainable by a casino management system.

When a player wishes to play the gaming device 200, he/she can insert cash or a ticket voucher through a coin acceptor (not shown) or bill validator 234 to establish a credit balance on the gaming device. The credit balance is used by the player to place wagers on instances of the game and to receive credit awards based on the outcome of winning instances. The credit balance is decreased by the amount of each wager and increased upon a win. The player can add additional credits to the balance at any time. The player may also optionally insert a loyalty club card into the card reader 230. During the game, the player views with one or more UIs, the game outcome on one or more of the primary game display 240 and secondary game display 242. Other game and prize information may also be displayed.

For each game instance, a player may make selections, which may affect play of the game. For example, the player may vary the total amount wagered by selecting the amount bet per line and the number of lines played. In many games, the player is asked to initiate or select options during course of game play (such as spinning a wheel to begin a bonus round or select various items during a feature game). The player may make these selections using the player-input buttons 236, the primary game display 240 which may be a touch screen, or using some other device which enables a player to input information into the gaming device 200.

During certain game events, the gaming device 200 may display visual and auditory effects that can be perceived by the player. These effects add to the excitement of a game, which makes a player more likely to enjoy the playing experience. Auditory effects include various sounds that are projected by the speakers 220. Visual effects include flashing lights, strobing lights or other patterns displayed from lights on the gaming device 200 or from lights behind the information panel 152 (FIG. 1).

When the player is done, he/she cashes out the credit balance (typically by pressing a cash out button to receive a ticket from the ticket printer 222). The ticket may be “cashed-in” for money or inserted into another machine to establish a credit balance for play.

Additionally, or alternatively, gaming devices 104A-104X and 200 can include or be coupled to one or more wireless transmitters, receivers, and/or transceivers (not shown in FIGS. 1 and 2A) that communicate (e.g., Bluetooth® or other near-field communication technology) with one or more mobile devices to perform a variety of wireless operations in a casino environment. Examples of wireless operations in a casino environment include detecting the presence of mobile devices, performing credit, points, comps, or other marketing or hard currency transfers, establishing wagering sessions, and/or providing a personalized casino-based experience using a mobile application. In one implementation, to perform these wireless operations, a wireless transmitter or transceiver initiates a secure wireless connection between a gaming device 104A-104X and 200 and a mobile device. After establishing a secure wireless connection between the gaming device 104A-104X and 200 and the mobile device, the wireless transmitter or transceiver does not send and/or receive application data to and/or from the mobile device. Rather, the mobile device communicates with gaming devices 104A-104X and 200 using another wireless connection (e.g., WiFi® or cellular network). In another implementation, a wireless transceiver establishes a secure connection to directly communicate with the mobile device. The mobile device and gaming device 104A-104X and 200 sends and receives data utilizing the wireless transceiver instead of utilizing an external network. For example, the mobile device would perform digital wallet transactions by directly communicating with the wireless transceiver. In one or more implementations, a wireless transmitter could broadcast data received by one or more mobile devices without establishing a pairing connection with the mobile devices.

Although FIGS. 1 and 2A illustrate specific implementations of a gaming device (e.g., gaming devices 104A-104X and 200), the disclosure is not limited to those implementations shown in FIGS. 1 and 2. For example, not all gaming devices suitable for implementing implementations of the present disclosure necessarily include top wheels, top boxes, information panels, cashless ticket systems, and/or player tracking systems. Further, some suitable gaming devices have only a single game display that includes only a mechanical set of reels and/or a video display, while others are designed for bar counters or tabletops and have displays that face upwards. Gaming devices 104A-104X and 200 may also include other processors that are not separately shown. Using FIG. 2A as an example, gaming device 200 could include display controllers (not shown in FIG. 2A) configured to receive video input signals or instructions to display images on game displays 240 and 242. Alternatively, such display controllers may be integrated into the game controller 202. The use and discussion of FIGS. 1 and 2 are examples to facilitate ease of description and explanation.

FIG. 2B depicts a casino gaming environment according to one example. In this example, the casino 251 includes banks 252 of EGMs 104. In this example, each bank 252 of EGMs 104 includes a corresponding gaming signage system 254 (also shown in FIG. 2A). According to this implementation, the casino 251 also includes mobile gaming devices 256, which are also configured to present wagering games in this example. The mobile gaming devices 256 may, for example, include tablet devices, cellular phones, smart phones and/or other handheld devices. In this example, the mobile gaming devices 256 are configured for communication with one or more other devices in the casino 251, including but not limited to one or more of the server computers 102, via wireless access points 258.

According to some examples, the mobile gaming devices 256 may be configured for stand-alone determination of game outcomes. However, in some alternative implementations the mobile gaming devices 256 may be configured to receive game outcomes from another device, such as the central determination gaming system server 106, one of the EGMs 104, etc.

Some mobile gaming devices 256 may be configured to accept monetary credits from a credit or debit card, via a wireless interface (e.g., via a wireless payment app), via tickets, via a patron casino account, etc. However, some mobile gaming devices 256 may not be configured to accept monetary credits via a credit or debit card. Some mobile gaming devices 256 may include a ticket reader and/or a ticket printer whereas some mobile gaming devices 256 may not, depending on the particular implementation.

In some implementations, the casino 251 may include one or more kiosks 260 that are configured to facilitate monetary transactions involving the mobile gaming devices 256, which may include cash out and/or cash in transactions. The kiosks 260 may be configured for wired and/or wireless communication with the mobile gaming devices 256. The kiosks 260 may be configured to accept monetary credits from casino patrons 262 and/or to dispense monetary credits to casino patrons 262 via cash, a credit or debit card, via a wireless interface (e.g., via a wireless payment app), via tickets, etc. According to some examples, the kiosks 260 may be configured to accept monetary credits from a casino patron and to provide a corresponding amount of monetary credits to a mobile gaming device 256 for wagering purposes, e.g., via a wireless link such as a near-field communications link. In some such examples, when a casino patron 262 is ready to cash out, the casino patron 262 may select a cash out option provided by a mobile gaming device 256, which may include a real button or a virtual button (e.g., a button provided via a graphical user interface) in some instances. In some such examples, the mobile gaming device 256 may send a “cash out” signal to a kiosk 260 via a wireless link in response to receiving a “cash out” indication from a casino patron. The kiosk 260 may provide monetary credits to the casino patron 262 corresponding to the “cash out” signal, which may be in the form of cash, a credit ticket, a credit transmitted to a financial account corresponding to the casino patron, etc.

In some implementations, a cash-in process and/or a cash-out process may be facilitated by the TITO system server 108. For example, the TITO system server 108 may control, or at least authorize, ticket-in and ticket-out transactions that involve a mobile gaming device 256 and/or a kiosk 260.

Some mobile gaming devices 256 may be configured for receiving and/or transmitting player loyalty information. For example, some mobile gaming devices 256 may be configured for wireless communication with the player tracking system server 110. Some mobile gaming devices 256 may be configured for receiving and/or transmitting player loyalty information via wireless communication with a patron's player loyalty card, a patron's smartphone, etc.

According to some implementations, a mobile gaming device 256 may be configured to provide safeguards that prevent the mobile gaming device 256 from being used by an unauthorized person. For example, some mobile gaming devices 256 may include one or more biometric sensors and may be configured to receive input via the biometric sensor(s) to verify the identity of an authorized patron. Some mobile gaming devices 256 may be configured to function only within a predetermined or configurable area, such as a casino gaming area.

FIG. 2C is a diagram that shows examples of components of a system for providing online gaming according to some aspects of the present disclosure. As with other figures presented in this disclosure, the numbers, types and arrangements of gaming devices shown in FIG. 2C are merely shown by way of example. In this example, various gaming devices, including but not limited to end user devices (EUDs) 264a, 264b and 264c are capable of communication via one or more networks 417. The networks 417 may, for example, include one or more cellular telephone networks, the Internet, etc. In this example, the EUDs 264a and 264b are mobile devices: according to this example the EUD 264a is a tablet device and the EUD 264b is a smart phone. In this implementation, the EUD 264c is a laptop computer that is located within a residence 266 at the time depicted in FIG. 2C. Accordingly, in this example the hardware of EUDs is not specifically configured for online gaming, although each EUD is configured with software for online gaming. For example, each EUD may be configured with a web browser. Other implementations may include other types of EUD, some of which may be specifically configured for online gaming.

In this example, a gaming data center 276 includes various devices that are configured to provide online wagering games via the networks 417. The gaming data center 276 is capable of communication with the networks 417 via the gateway 272. In this example, switches 278 and routers 280 are configured to provide network connectivity for devices of the gaming data center 276, including storage devices 282a, servers 284a and one or more workstations 286a. The servers 284a may, for example, be configured to provide access to a library of games for online game play. In some examples, code for executing at least some of the games may initially be stored on one or more of the storage devices 282a. The code may be subsequently loaded onto a server 284a after selection by a player via an EUD and communication of that selection from the EUD via the networks 417. The server 284a onto which code for the selected game has been loaded may provide the game according to selections made by a player and indicated via the player's EUD. In other examples, code for executing at least some of the games may initially be stored on one or more of the servers 284a. Although only one gaming data center 276 is shown in FIG. 2C, some implementations may include multiple gaming data centers 276.

In this example, a financial institution data center 270 is also configured for communication via the networks 417. Here, the financial institution data center 270 includes servers 284b, storage devices 282b, and one or more workstations 286b. According to this example, the financial institution data center 270 is configured to maintain financial accounts, such as checking accounts, savings accounts, loan accounts, etc. In some implementations one or more of the authorized users 274a-274c may maintain at least one financial account with the financial institution that is serviced via the financial institution data center 270.

According to some implementations, the gaming data center 276 may be configured to provide online wagering games in which money may be won or lost. According to some such implementations, one or more of the servers 284a may be configured to monitor player credit balances, which may be expressed in game credits, in currency units, or in any other appropriate manner. In some implementations, the server(s) 284a may be configured to obtain financial credits from and/or provide financial credits to one or more financial institutions, according to a player's “cash in” selections, wagering game results and a player's “cash out” instructions. According to some such implementations, the server(s) 284a may be configured to electronically credit or debit the account of a player that is maintained by a financial institution, e.g., an account that is maintained via the financial institution data center 270. The server(s) 284a may, in some examples, be configured to maintain an audit record of such transactions.

In some alternative implementations, the gaming data center 276 may be configured to provide online wagering games for which credits may not be exchanged for cash or the equivalent. In some such examples, players may purchase game credits for online game play, but may not “cash out” for monetary credit after a gaming session. Moreover, although the financial institution data center 270 and the gaming data center 276 include their own servers and storage devices in this example, in some examples the financial institution data center 270 and/or the gaming data center 276 may use offsite “cloud-based” servers and/or storage devices. In some alternative examples, the financial institution data center 270 and/or the gaming data center 276 may rely entirely on cloud-based servers.

One or more types of devices in the gaming data center 276 (or elsewhere) may be capable of executing middleware, e.g., for data management and/or device communication. Authentication information, player tracking information, etc., including but not limited to information obtained by EUDs 264 and/or other information regarding authorized users of EUDs 264 (including but not limited to the authorized users 274a-274c), may be stored on storage devices 282 and/or servers 284. Other game-related information and/or software, such as information and/or software relating to leaderboards, players currently playing a game, game themes, game-related promotions, game competitions, etc., also may be stored on storage devices 282 and/or servers 284. In some implementations, some such game-related software may be available as “apps” and may be downloadable (e.g., from the gaming data center 276) by authorized users.

In some examples, authorized users and/or entities (such as representatives of gaming regulatory authorities) may obtain gaming-related information via the gaming data center 276. One or more other devices (such EUDs 264 or devices of the gaming data center 276) may act as intermediaries for such data feeds. Such devices may, for example, be capable of applying data filtering algorithms, executing data summary and/or analysis software, etc. In some implementations, data filtering, summary and/or analysis software may be available as “apps” and downloadable by authorized users.

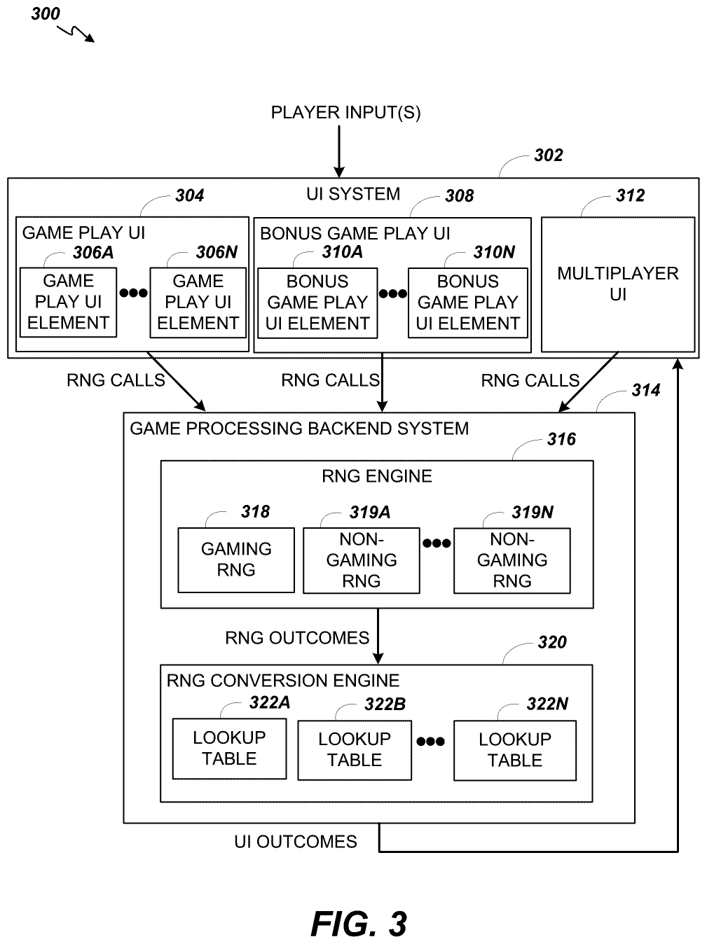

FIG. 3 illustrates, in block diagram form, an implementation of a game processing architecture 300 that implements a game processing pipeline for the play of a game in accordance with various implementations described herein. As shown in FIG. 3, the gaming processing pipeline starts with having a UI system 302 receive one or more player inputs for the game instance. Based on the player input(s), the UI system 302 generates and sends one or more RNG calls to a game processing backend system 314. Game processing backend system 314 then processes the RNG calls with RNG engine 316 to generate one or more RNG outcomes. The RNG outcomes are then sent to the RNG conversion engine 320 to generate one or more game outcomes for the UI system 302 to display to a player. The game processing architecture 300 can implement the game processing pipeline using a gaming device, such as gaming devices 104A-104X and 200 shown in FIGS. 1 and 2, respectively. Alternatively, portions of the gaming processing architecture 300 can implement the game processing pipeline using a gaming device and one or more remote gaming devices, such as central determination gaming system server 106 shown in FIG. 1.

The UI system 302 includes one or more UIs that a player can interact with. The UI system 302 could include one or more game play UIs 304, one or more bonus game play UIs 308, and one or more multiplayer UIs 312, where each UI type includes one or more mechanical UIs and/or graphical UIs (GUIs). In other words, game play UI 304, bonus game play UI 308, and the multiplayer UI 312 may utilize a variety of UI elements, such as mechanical UI elements (e.g., physical “spin” button or mechanical reels) and/or GUI elements (e.g., virtual reels shown on a video display or a virtual button deck) to receive player inputs and/or present game play to a player. Using FIG. 3 as an example, the different UI elements are shown as game play UI elements 306A-306N and bonus game play UI elements 310A-310N.

The game play UI 304 represents a UI that a player typically interfaces with for a base game. During a game instance of a base game, the game play UI elements 306A-306N (e.g., GUI elements depicting one or more virtual reels) are shown and/or made available to a user. In a subsequent game instance, the UI system 302 could transition out of the base game to one or more bonus games. The bonus game play UI 308 represents a UI that utilizes bonus game play UI elements 310A-310N for a player to interact with and/or view during a bonus game. In one or more implementations, at least some of the game play UI element 306A-306N are similar to the bonus game play UI elements 310A-310N. In other implementations, the game play UI element 306A-306N can differ from the bonus game play UI elements 310A-310N.

FIG. 3 also illustrates that UI system 302 could include a multiplayer UI 312 purposed for game play that differs or is separate from the typical base game. For example, multiplayer UI 312 could be set up to receive player inputs and/or presents game play information relating to a tournament mode. When a gaming device transitions from a primary game mode that presents the base game to a tournament mode, a single gaming device is linked and synchronized to other gaming devices to generate a tournament outcome. For example, multiple RNG engines 316 corresponding to each gaming device could be collectively linked to determine a tournament outcome. To enhance a player's gaming experience, tournament mode can modify and synchronize sound, music, reel spin speed, and/or other operations of the gaming devices according to the tournament game play. After tournament game play ends, operators can switch back the gaming device from tournament mode to a primary game mode to present the base game. Although FIG. 3 does not explicitly depict that multiplayer UI 312 includes UI elements, multiplayer UI 312 could also include one or more multiplayer UI elements.

Based on the player inputs, the UI system 302 could generate RNG calls to a game processing backend system 314. As an example, the UI system 302 could use one or more application programming interfaces (APIs) to generate the RNG calls. To process the RNG calls, the RNG engine 316 could utilize gaming RNG 318 and/or non-gaming RNGs 319A-319N. Gaming RNG 318 could corresponds to RNG 212 or hardware RNG 244 shown in FIG. 2A. As previously discussed with reference to FIG. 2A, gaming RNG 318 often performs specialized and non-generic operations that comply with regulatory and/or game requirements. For example, because of regulation requirements, gaming RNG 318 could correspond to RNG 212 by being a cryptographic RNG or pseudorandom number generator (PRNG) (e.g., Fortuna PRNG) that securely produces random numbers for one or more game features. To securely generate random numbers, gaming RNG 318 could collect random data from various sources of entropy, such as from an operating system (OS) and/or a hardware RNG (e.g., hardware RNG 244 shown in FIG. 2A). Alternatively, non-gaming RNGs 319A-319N may not be cryptographically secure and/or be computationally less expensive. Non-gaming RNGs 319A-319N can, thus, be used to generate outcomes for non-gaming purposes. As an example, non-gaming RNGs 319A-319N can generate random numbers for generating random messages that appear on the gaming device.

The RNG conversion engine 320 processes each RNG outcome from RNG engine 316 and converts the RNG outcome to a UI outcome that is feedback to the UI system 302. With reference to FIG. 2A, RNG conversion engine 320 corresponds to RNG conversion engine 210 used for game play. As previously described, RNG conversion engine 320 translates the RNG outcome from the RNG 212 to a game outcome presented to a player. RNG conversion engine 320 utilizes one or more lookup tables 322A-322N to regulate a prize payout amount for each RNG outcome and how often the gaming device pays out the derived prize payout amounts. In one example, the RNG conversion engine 320 could utilize one lookup table to map the RNG outcome to a game outcome displayed to a player and a second lookup table as a pay table for determining the prize payout amount for each game outcome. In this example, the mapping between the RNG outcome and the game outcome controls the frequency in hitting certain prize payout amounts. Different lookup tables could be utilized depending on the different game modes, for example, a base game versus a bonus game.

After generating the UI outcome, the game processing backend system 314 sends the UI outcome to the UI system 302. Examples of UI outcomes are symbols to display on a video reel or reel stops for a mechanical reel. In one example, if the UI outcome is for a base game, the UI system 302 updates one or more game play UI elements 306A-306N, such as symbols, for the game play UI 304. In another example, if the UI outcome is for a bonus game, the UI system could update one or more bonus game play UI elements 310A-310N (e.g., symbols) for the bonus game play UI 308. In response to updating the appropriate UI, the player may subsequently provide additional player inputs to initiate a subsequent game instance that progresses through the game processing pipeline.

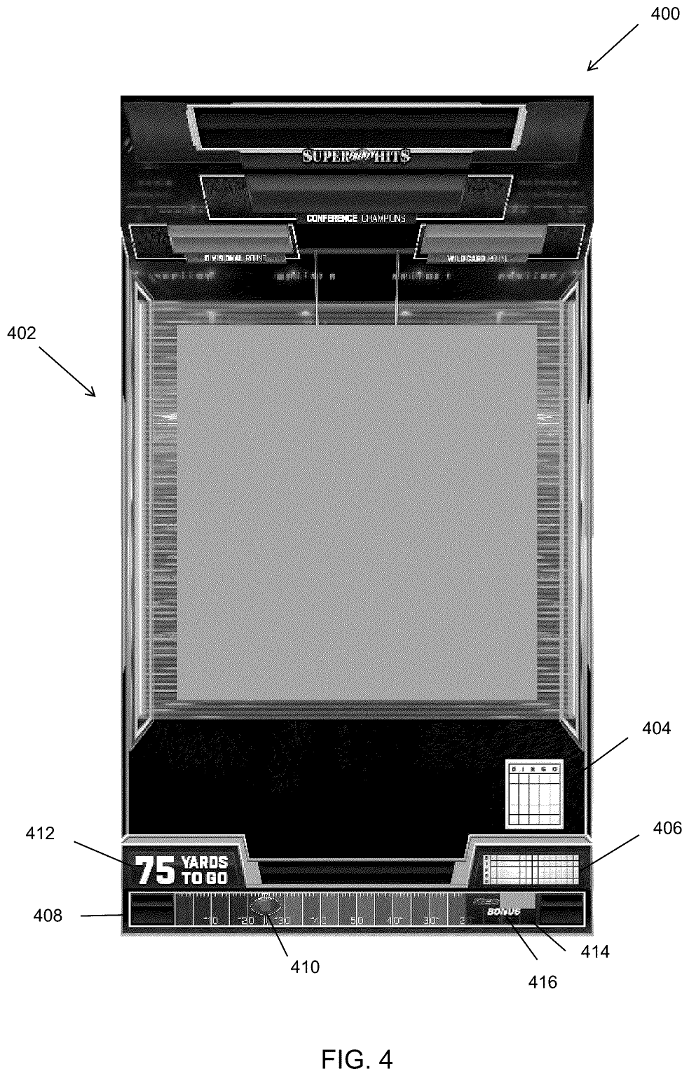

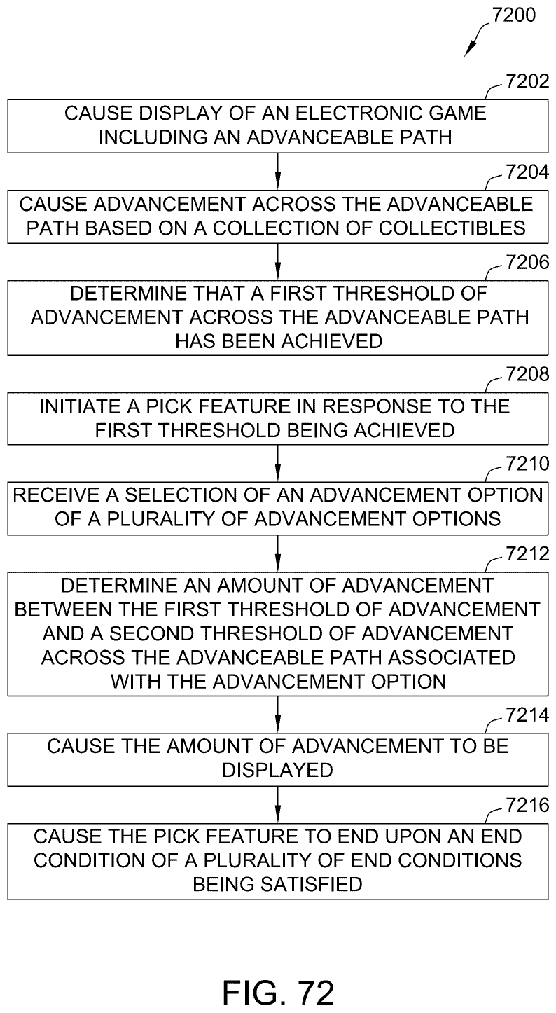

FIGS. 4-72 illustrate example embodiments of the collection mechanic and pick feature systems and methods described herein.

FIG. 4 illustrates an example screenshot and/or interface 400 of an electronic game, in accordance with the present disclosure.

In the example embodiment, the electronic game is a Class II bingo game presented on a gaming device (e.g., gaming devices 104A-104X). A primary game display area (not shown) includes a plurality of reels. In some examples, the reels may be implemented as mechanical reels or may include virtual reels that are computer generated and displayed on a computer display screen/display device. Each reel has a plurality of symbol display positions for presenting symbols (and/or symbol combinations) which may be associated with winning and/or losing reel game outcomes and/or awards.

A secondary game display area 402 includes a bingo card 404 and a bingo number listing 406. As shown, bingo card 404 includes a matrix of bingo cells (e.g., squares). In some examples, the matrix may be a 5×5 matrix of 25 total cells. In some examples, bingo card 404 may have a matrix of a different size (e.g., 3×3, 4×4, 4×5, 4×6, 6×6, 7×7, 3×8, 10×10, etc.). In some examples, the matrix may be larger or smaller. Each cell in the matrix of bingo card 404 includes a number that is not repeated in any other cell of the bingo card.

Secondary game display area 402 further includes a credit meter 602 (e.g., see FIG. 6) showing an amount of money and/or credits (e.g., credit balance associated with a player account) at a gaming device. Secondary display area 402 additionally includes a wager meter 604 near credit meter 602 indicating an amount wagered (e.g., based on a denomination and/or number of pay lines selected).

In some examples, the bingo game may be a networked game that involves two or more networked devices, such as gaming devices 104A-104X. For example, many electronic bingo games may be required, by state gaming regulations, to include at least two players. As a result, in these circumstances, a bingo game can only occur if two or more players have placed wagers and received a bingo card to be used to determine a game outcome against a common ball call. A ball call may be initiated once at least two players have joined an electronic bingo game (e.g., a networked electronic bingo game), and each player's bingo card (or cards) are compared to the same ball call, even where the players are physically separated, such as in different parts of a casino or even in different casinos/external locations.

Central determination gaming system server 106 may manage (and/or host) the bingo game, such as by generating bingo card 404 (or cards, as above) and/or bingo number listing 406. In some examples, bingo card 404 (and/or information on which bingo card 404 is based), and/or bingo number listing 406 may be generated using an RNG (e.g., RNG 318). In some examples, bingo card 404 may be randomly selected from a set of bingo cards or a player may select their own bingo card 404 (e.g., via a user interface), such as from a set of randomly generated bingo cards, for example.

In operation, a player and/or gaming device may be provided with a respective bingo card, such as by central determination gaming system server 106. For example, a player may be provided a new bingo card each time a “Spin” or “Play” button is pressed by the player (e.g., via a user interface), provided the player has made a wager/input. In some examples, more than one bingo card may be generated in response to a wager. Bingo number listing 406 (e.g., “ball call”) may be randomly generated, such as by central determination gaming system server 106. Bingo card 404 may be compared to bingo number listing 406, and the numbered cells on bingo card 404 that match numbers in bingo number listing 406 may be marked or “daubed” on bingo card 404. Finally, the marked or daubed bingo card may be evaluated against a paytable of winning bingo patterns.

Bingo number listing 406 may be continually generated until a maximum amount of numbers are listed (e.g., seventy-five numbers listed) or until a game-ending pattern is awarded to a player participating in the bingo game. A typical game-ending pattern may be a bingo card blackout pattern, in which each of the numbers of a bingo card match a number displayed in the bingo number listing. Other game-ending patterns are also possible. When the game-ending pattern is awarded, bingo number listing 406 is reset for all players participating in the bingo game and the process repeats. In some examples, a single play of the bingo game includes a wager, a bingo card, a bingo number listing, a matching of the numbers called with those on a bingo card, a determination of a bingo game outcome, and a presentation of an associated award, if any.

A bingo game outcome may be determined by comparing one or more patterns of marked (and/or “daubed) cells of bingo card 404 with a paytable of winning bingo patterns. If bingo card 404 does not include a pattern that matches a pattern in the paytable of winning patterns, then a losing bingo outcome is determined, and no award may be provided to the player (e.g., and in the example embodiment described herein, a number (e.g., a random number) of yards may be advanced (e.g., toward the red zone) after each losing outcome). If bingo card 404 does include a pattern that matches a pattern in the paytable of winning patterns, then a winning bingo outcome is determined, and an award may be provided to the player.

Different winning patterns may be associated with different awards. The award for a winning main bingo game outcome may be based on an amount wagered, an associated main bingo game paytable, an associated set of rules for the main bingo game, a probability (and/or likelihood) of achieving a particular bingo pattern/combination, an amount of bingo numbers needed to achieve the particular bingo pattern/combination, and/or other considerations. In some examples, the player/player account may be awarded for multiple patterns (e.g., all winning patterns) that are matched when bingo card 404 is evaluated against the paytable of winning patterns. In some examples, the player may be awarded for only the highest priority pattern (e.g., the highest paying winning pattern) that is matched. In some examples, during play of a Class II game, a player is provided or selects a single bingo card for multiple plays of the bingo game, with a new bingo number listing generated for each play of the bingo game. Other methods of play of a Class II bingo game, Class III games, and/or other games are also envisioned and are within the scope of this disclosure.

The bingo game outcome may be presented to the player via a spinning reel game simulation. The spinning reel game is simulated via plurality of reels in a primary game display area. For each play of the bingo game, the bingo game outcome is presented at least in part as a reel spin outcome in the reel game. In some examples, the spinning reel game simulation may operate by spinning each reel and then stopping each reel in a particular position to obtain a matrix of symbols.

One or more combinations of symbols in the matrix of symbols may be associated with a reel game outcome that is equal to at least a portion of the main bingo game outcome. For example, a winning bingo game outcome may be displayed as a winning combination of the reels. Similarly, a losing bingo game outcome may be displayed as a losing combination of the reels. Different outcomes of the bingo game may be displayed as different outcomes in the spinning reel game. Thus, the bingo game outcome is presented to the player at least in part as a particular reel spin outcome of the reels.

In the example embodiment, winning outcomes may be displayed as a combination of game outcomes in the primary game display area and secondary game display area 402 (e.g., the display area showing football field 408). For example, a total bingo game outcome may be determined (e.g., for the red zone bonus feature), followed by determination of a script of base game display patterns/sequences, bonus game display patterns/sequences, and/or feature game display patterns/sequences (e.g., corresponding to game outcomes in the primary game display area and/or secondary game display area 402) that, in total, correspond to the determined game outcome (e.g., sequential display of the patterns/sequences of the script results in the desired game outcome being displayed/provided—in some embodiments, patterns/sequences of the script may be arranged/organized in an order from a lowest value to a highest value). In some embodiments, separate bingo game outcome determinations may be made for spins of the electronic game when advancing to the red zone and spins of the electronic game in the red zone bonus feature.

In some examples, progressively increasing outputs may be applied to a Class II game as described herein. Game outputs (e.g., credit outputs) may be presented/paid from lowest to highest across a plurality of spins. A number of spins may be determined based upon an amount of a bingo game win or a number of bingo pattern wins, as examples. Sequential display of display patterns/sequences may be controlled until display/communication of a determined number of bingo pattern amounts has been achieved.

In the example embodiment, a game outcome is randomly determined (e.g., by comparing a ball call to a bingo card, by use of an RNG, etc.). A lookup is then performed (e.g., by a game controller and/or based upon an RNG output) in a lookup table (e.g., 322A-N) to determine how to present the total game outcome (e.g., which script/sequence of outcomes to display).

In some embodiments, a random determination may be made to determine which fractions of the total game outcome should be presented by each possible game (e.g., base game, bonus game, etc.). For example, an RNG (e.g., RNG 318 and/or 319A-N) and a data structure and/or lookup table (e.g., 322A-N) may be utilized in order to make the determination of how the total game outcome should be split up amongst different game outcomes. In the example of a 100-credit outcome, the lookup table may include any number of fractions/portions/splits between a base game and/or a bonus game (e.g., red zone bonus feature) that sum up to 100 credits. In this example, upon the random determination of how the total game outcome will be split amongst different games (e.g., 30-70, 40-60, etc.), another random determination may be made (e.g., based upon the same or a different lookup table) to determine how to display the respective fractions/portions.

In the example embodiment, a determination of a number of credits to award during the red zone bonus feature is determined. For example, an award of 1000 total credits may be determined (e.g., based on bingo card 404 and ball number listing 406). A lookup is then performed to determine how to present the 1000 total credits. For instance, a first spin of the red zone bonus feature may award 100 credits and a first number of yards to advance in the red zone, a second spin may award 200 credits and a second number of yards to advance in the red zone, and a third spin may award 700 credits (e.g., totaling 1000 credits across the spins) and a third number of yards to advance in the red zone (e.g., that results in a touchdown). Amounts of credits and/or yards to advance in the base game and/or other games described herein may also be presented according to a selected script from a plurality of scripts in memory.

As explained herein, different lookups may also be performed to determine one or more video clips to display in response to different events in the electronic game (e.g., advancement of yards, scoring a touchdown, etc.). Continuing the example above, after the first number of yards, say five yards, to advance in the red zone is determined, a lookup may be performed in memory. For example, a play of five yards may result in a random video clip (e.g., highlight) of an actual play (e.g., of the selected team) in a professional football game that also achieved five yards (e.g., or a similar amount of yards) being displayed. The video clip may correspond to the exact amount of yards achieved.

For instance, different lookup tables are stored in memory that correspond to different teams, players, types of plays (e.g., run, pass) and/or yard amounts. Upon the determination of an amount of yards to provide in the electronic game, a lookup is performed in one or more of the tables to determine which highlight(s), if any, to display. Continuing the above example, a lookup would be performed in order to select a video of a five-yard play achieved by the selected team. That video of the five-yard play achieved by the selected team would then be displayed.

As another example, if a play is less than fifteen yards, a video clip may be skipped and a message may appear saying “THAT'S A PLAY OF ‘N’ YARDS! ONLY [new distance to 20-yard line] MORE TO PLAY THE [red zone bonus feature]!”

Similar to the above lookup table example, example scoring plays may also be stored in memory. In other words, in addition to video clips of plays where specific yard amounts are achieved, video clips may also be stored as being associated with different scoring plays (e.g., touchdown, field goal, etc.). Accordingly, when a touchdown is achieved, a lookup may be performed to select a video of a touchdown being achieved by the selected team. That video of the touchdown being achieved by the selected team would then be displayed in secondary display area 402.

As another example, if the determined split is a 30-70 split between a base game and a bonus game (e.g., the red zone bonus game), there are a plurality of ways to display/communicate a 30-credit base outcome and a 70-credit bonus outcome. Accordingly, one or more next random determinations may be made, based upon the same or a different lookup table, to determine which base display sequence (e.g., sequence of spins, displayed symbol outcomes, and/or yard advancements) to use to communicate a 30-credit base outcome and which bonus display sequence (e.g., sequence of spins, displayed symbol outcomes, and/or yard advancements) to use to communicate a 70-credit feature outcome.

For example, the lookup table may be configured as a data structure and/or model such that, based upon an inputted/determined total game outcome amount, a script of which display sequence(s) to use to communicate the game outcome amount (e.g., to a player) may be determined. In some embodiments, an RNG output may be utilized to determine which script to use to communicate a particular game outcome amount.

In other words, a total game outcome amount may be determined. Based upon the total game outcome amount, the lookup table can be searched for a set of scripts that correspond to that particular game outcome amount (e.g., the set of scripts may include spins/rounds of a base game, feature game, and/or bonus game, etc.). Then, an RNG output may be utilized to randomly determine which script of the set of scripts associated with the particular game outcome amount to utilize to communicate/convey the game outcome amount. Various examples of different scripted sequences (e.g., plays of the electronic game, including the various described features) are provided herein.

As shown in FIG. 4, a virtual football field 408 is also provided with a football 410 thereon. A number of remaining yards 412 before reaching the end zone is also displayed for convenience. In this case, 75 yards to the end zone remain because football 410 is at the 25-yard line. In the example embodiment, football 410 starts at the 25-yard line at the beginning of the electronic game as well as after a touchdown is scored (e.g., so that a new drive down field 408 may begin).

To communicate a location of red zone 414 on field 408 (e.g., where football 410 needs to reach in order to trigger the red zone bonus game), red zone 414 is shown with a tint (e.g., a red tint or overlay) as well as a message 416.

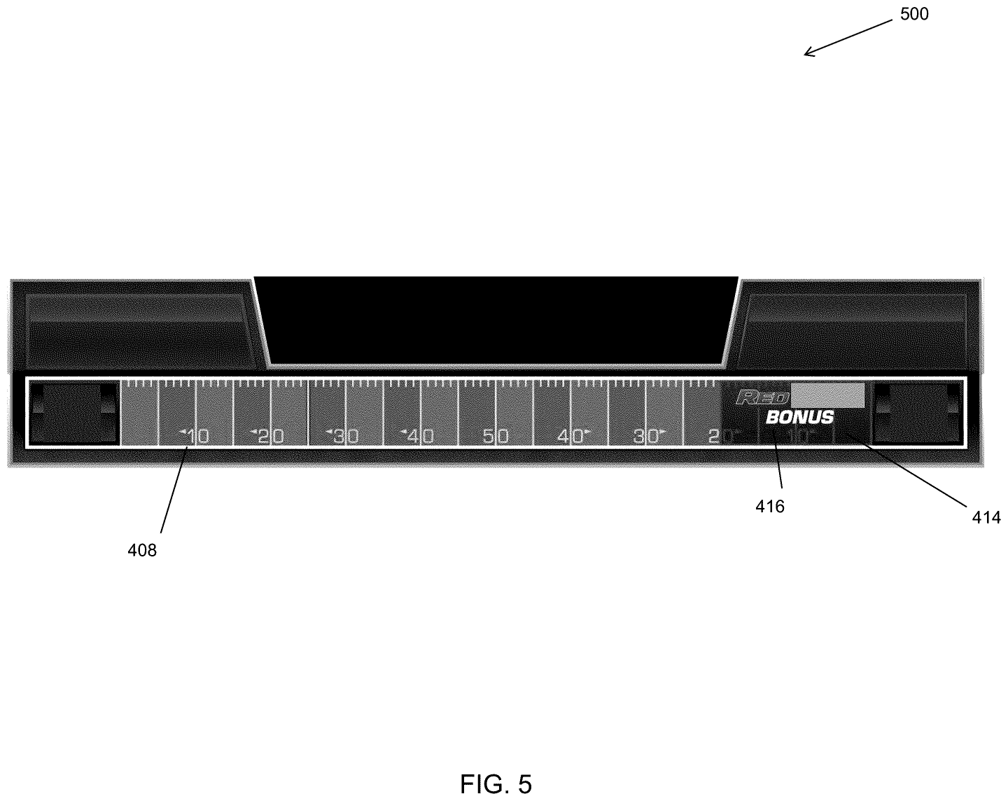

FIG. 5 illustrates another example screenshot and/or interface 500 of the electronic game shown in FIG. 4 (e.g., a magnified version of a portion of secondary display area 402). In other words, screenshot and/or interface 500 illustrates an exploded view of field 408 with red zone 414 and message 416 displayed thereon.

FIG. 6 illustrates another example screenshot and/or interface 600 of the electronic game shown in FIG. 4. As shown in FIG. 6, a number of yards remaining 606 before reaching red zone 414 (e.g., as opposed to number of yards remaining 412 before reaching the end zone, as shown in FIG. 4) is provided. In this case, 55 yards remain until red zone 414 is reached.

Further, an icon 608 (e.g., a helmet) associated with a selected team is provided. For example, as explained elsewhere herein, a team selection lobby may be provided at the beginning of the electronic game and the player may select a team as a theme of the electronic game. In the example embodiment, the selected team may be changed at any time via selection of select team button 610 (e.g., followed by display of available teams for selection). In some embodiments, the team may be randomly selected and/or predetermined (e.g., based on a location of a gaming device where the electronic game is being provided).

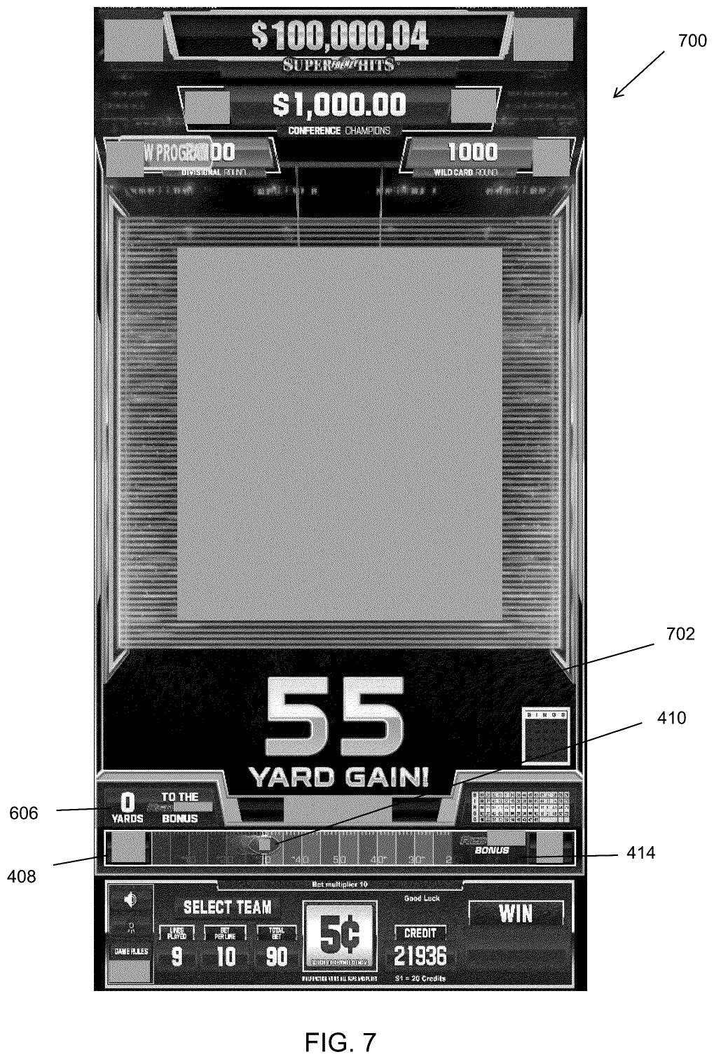

FIGS. 7-12 illustrate an example sequence of triggering the red zone bonus feature (e.g., football 410 advances down field to the red zone).

FIG. 7 illustrates another example screenshot and/or interface 700 of the electronic game shown in FIG. 4. As shown in FIG. 7, a message 702 is displayed to indicate that a 55-yard gain has been achieved in the electronic game (e.g., based on a bingo outcome and/or a losing outcome being displayed on reels).

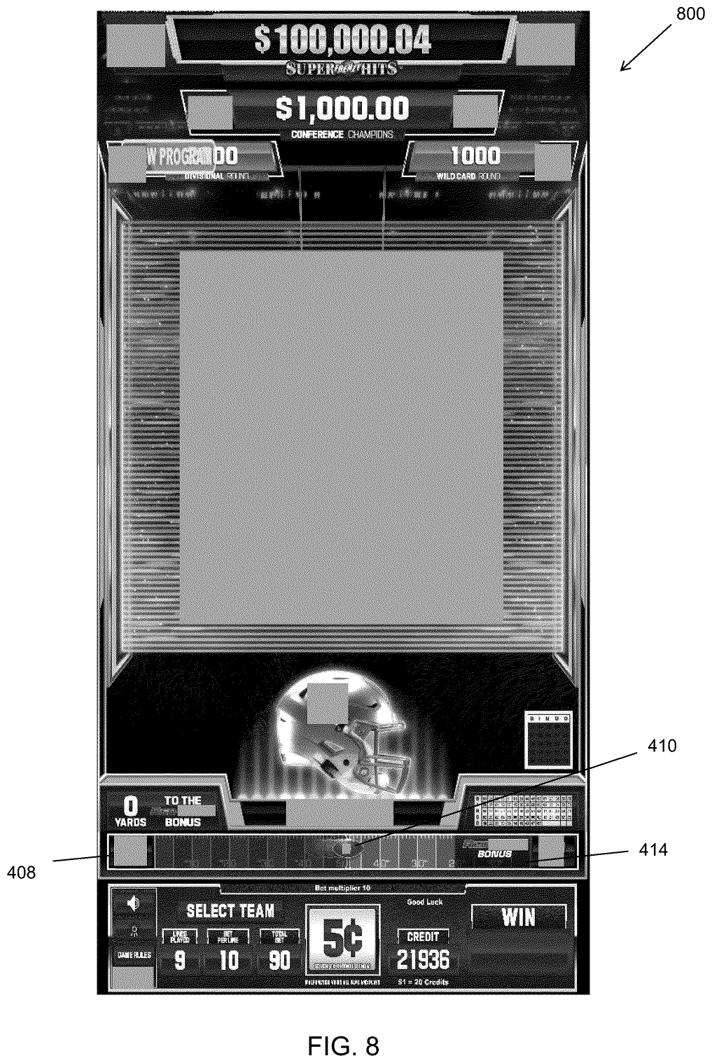

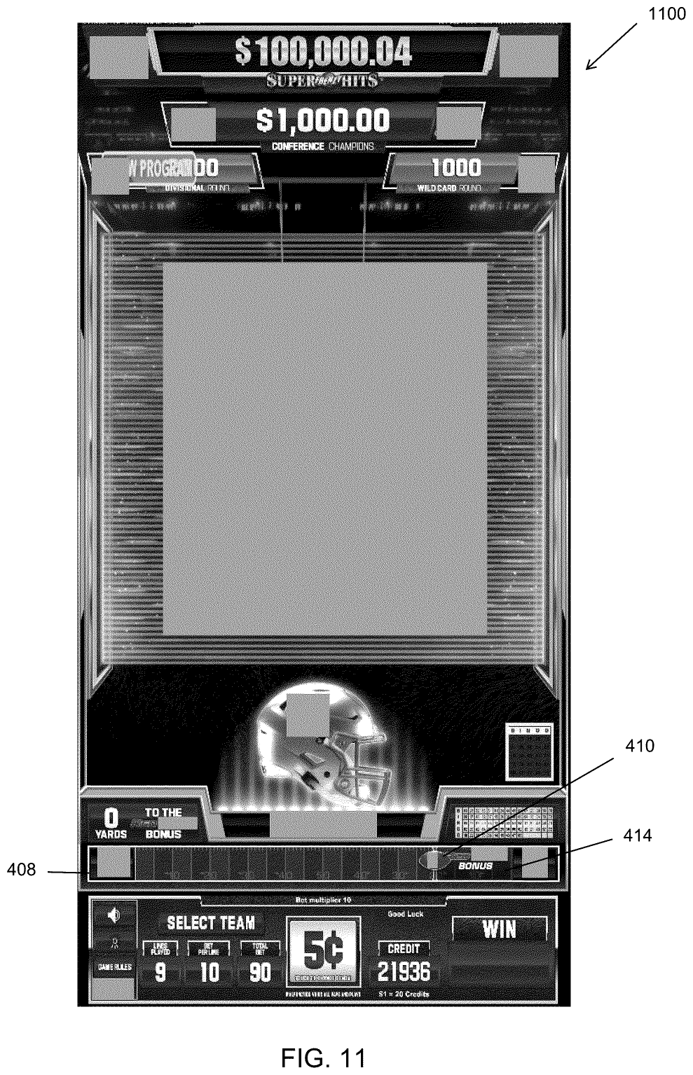

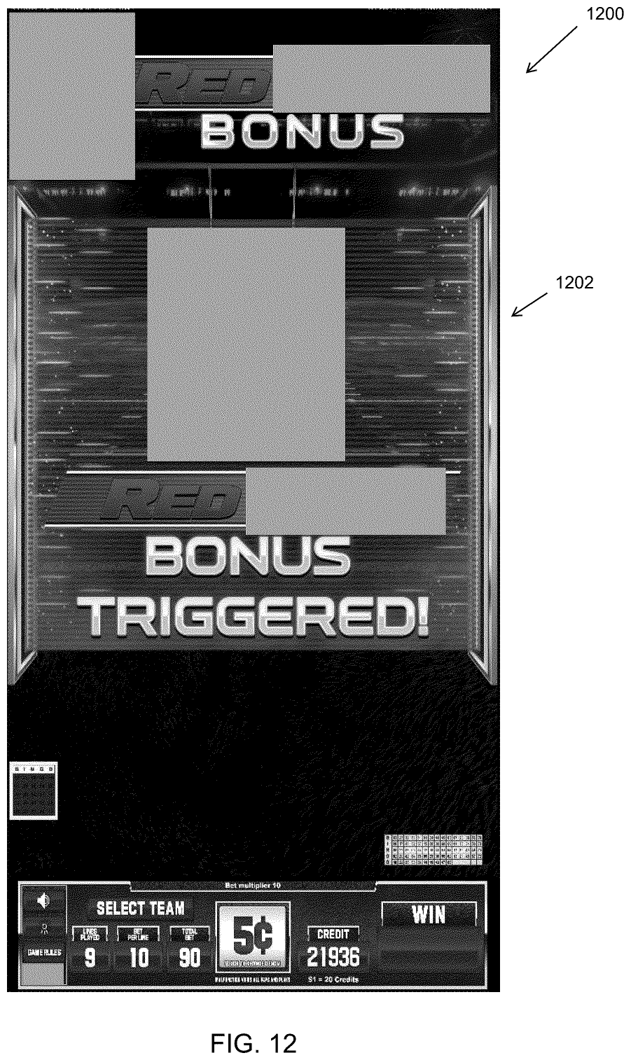

Accordingly, football 410 is displayed as being animated to move across field 408 toward red zone 414. FIGS. 8, 9, and 10 illustrate example screenshots and/or interfaces 800, 900, 1000 of football 410 continuing to be displayed as being animated to move across field 408 toward red zone 414 until football 410 reaches red zone 414, as shown in screenshot and/or interface 1100 of FIG. 11. Accordingly, a message 1202 is displayed at screenshot and/or interface 1200 of FIG. 12 to communicate that the red zone bonus game has been triggered.

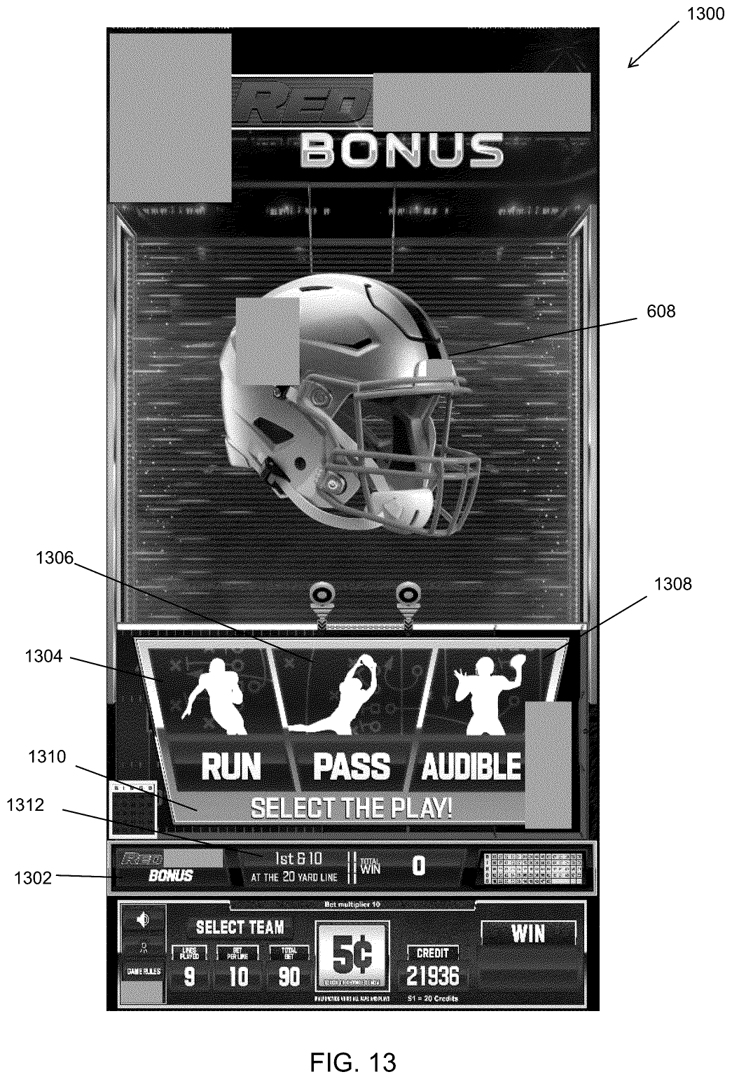

FIGS. 13-16 illustrate an example one yard gain resulting from a run play selection in the red zone bonus feature.

For example, FIG. 13 illustrates an example screenshot and/or interface 1300 of the red zone bonus feature (e.g., a “pick” feature, where a player make picks/selections) described herein. As shown in FIG. 13, a message 1302 indicates that the red zone bonus feature has been triggered and a run option 1304, a pass option 1306, and an audible option 1308 are provided for selection. A message 1310 communicates that a player may select one of options 1304-1308. Further, a message 1312 is displayed to communicate a status of the red zone bonus feature. In this example, the down is first down and a distance to a new first down is 10 yards, and the football (e.g., football 410) is at the 20-yard line. Icon 608 is also again displayed.

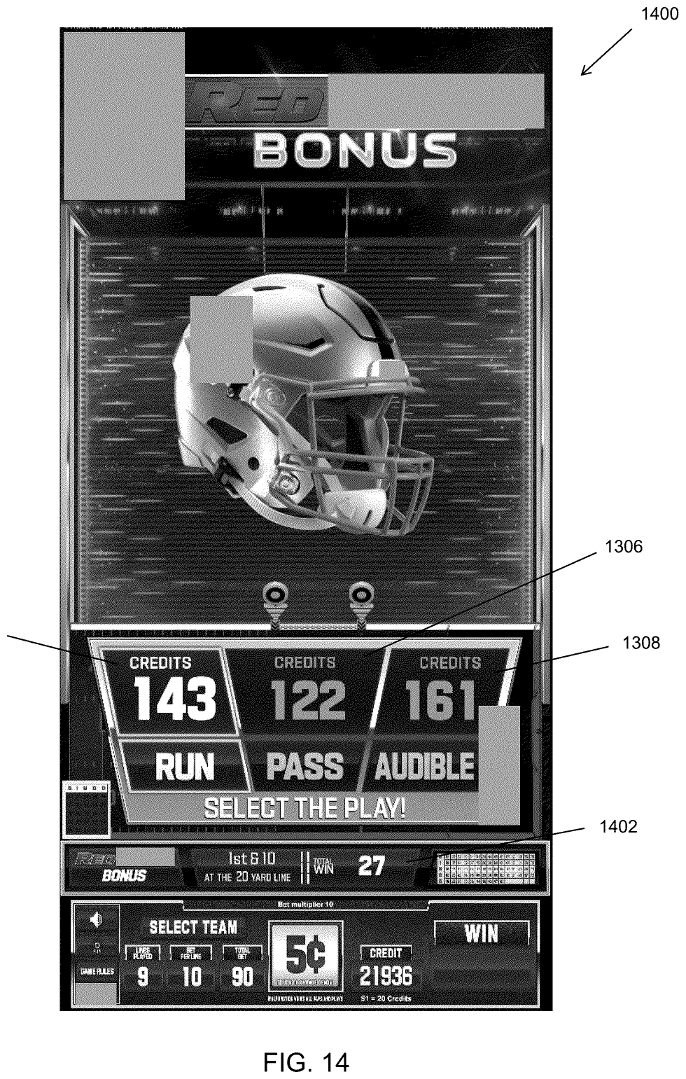

FIG. 14 illustrates an example screenshot and/or interface 1400 where run option 1304 has been selected. Accordingly, run option 1304 is displayed as being highlighted (e.g., activated, illuminated), while pass option 1306 and audible option 1308 are displayed as not being highlighted (e.g., inactivated, dull). A credit meter 1402 is also displayed as being updated from 0 credits to 143 credits (e.g., corresponding to run option 1304).

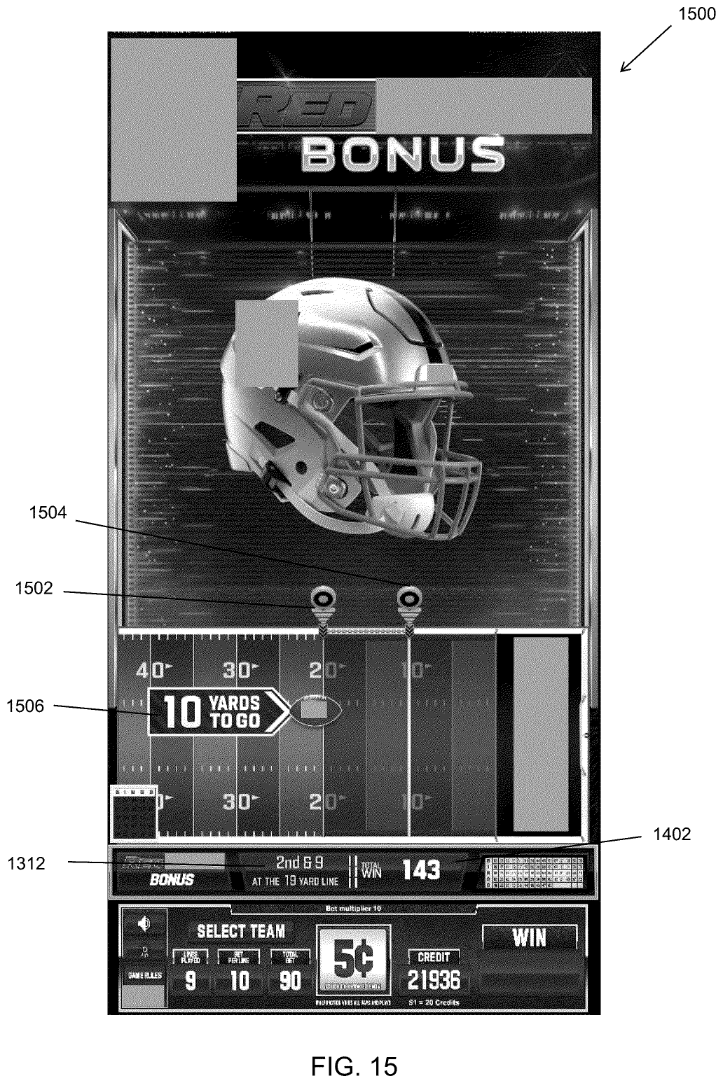

Thus, as shown in example screenshot and/or interface 1500 of FIG. 15, credit meter 1402 is updated to 143 credits. Marker 1502 indicates a current position of football 410 on field 408 while marker 1504 indicates a first down location (e.g., a position that football 410 needs to reach for a first down to be achieved). Message 1312 shows a current down, distance to a first down, and distance to the end zone.

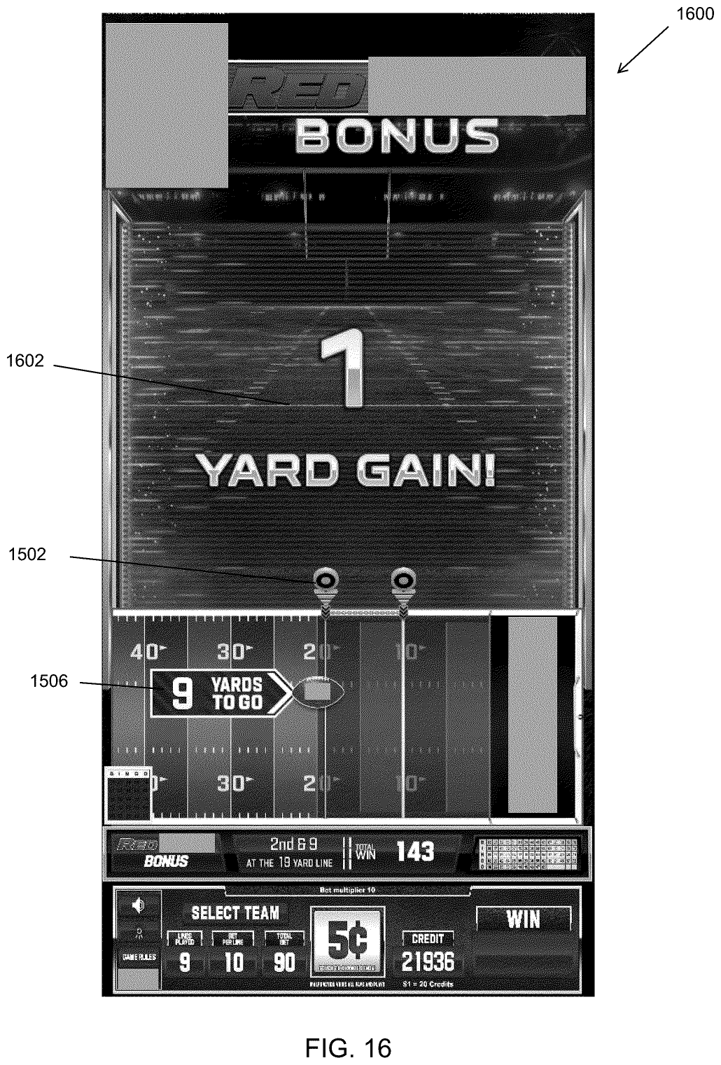

FIG. 16 illustrates an example screenshot and/or interface 1600 where a 1-yard gain, corresponding to run option 1304, is provided. Accordingly, marker 1502 is updated (e.g., moved by 1 yard) and a 1-yard gain message 1602 is displayed. Message 1506 also indicates that now 9 yards are needed for a first down to be achieved.

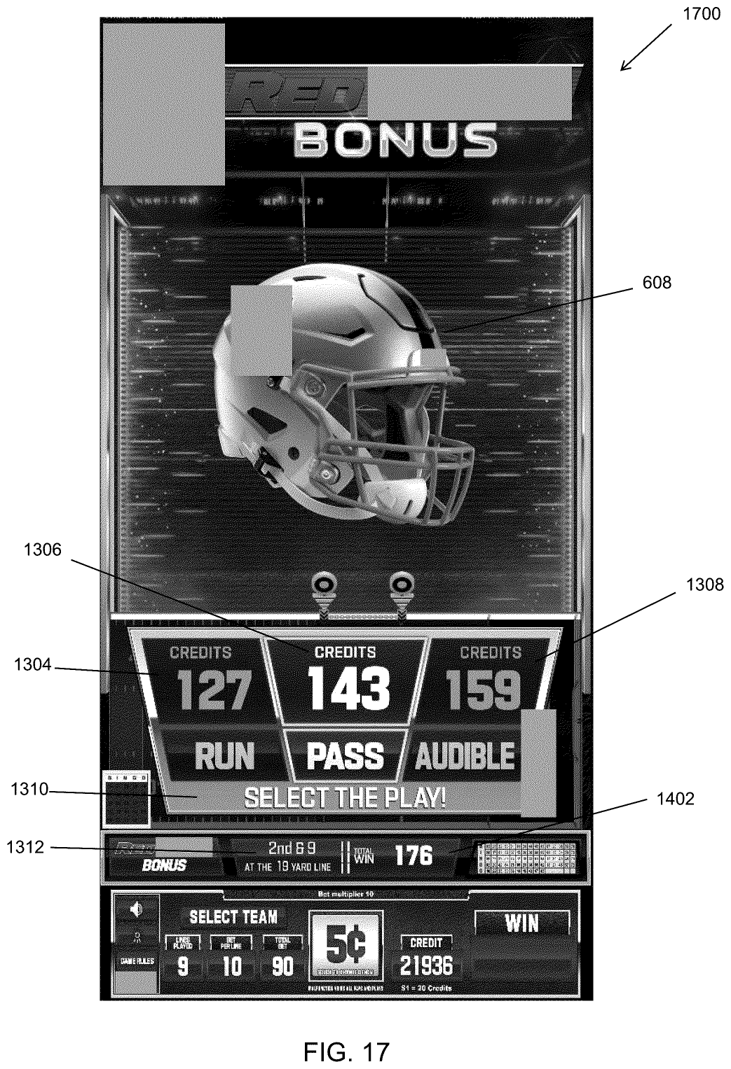

FIGS. 17-19 illustrate an example 1-yard gain resulting from a pass play selection in the red zone bonus feature.

For example, FIG. 17 illustrates another example screenshot and/or interface 1700 of the red zone bonus feature following the above example. As shown in FIG. 17, run option 1304, pass option 1306, and audible option 1308 are provided for selection. Message 1310 communicates that a player may select one of options 1304-1308. Further, message 1312 is displayed to communicate a status of the red zone bonus feature. In this example, the down is second down and a distance to a new first down is 9 yards, and the football (e.g., football 410) is at the 19-yard line. Icon 608 is also again displayed.

In the example of FIG. 17, pass option 1306 has been selected. Accordingly, pass option 1306 is displayed as being highlighted (e.g., activated, illuminated), while run option 1304 and audible option 1308 are displayed as not being highlighted (e.g., inactivated, dull). Credit meter 1402 is also displayed as being updated from 143 credits to 286 credits (e.g., corresponding to pass option 1306).

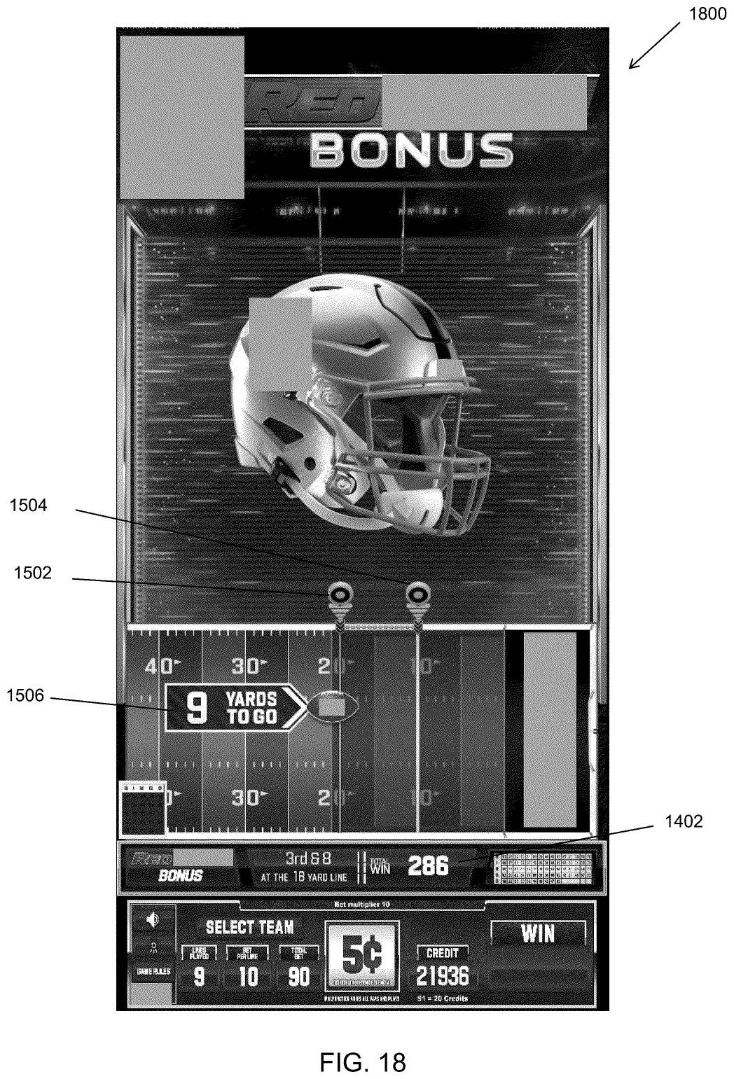

Thus, as shown in example screenshot and/or interface 1800 of FIG. 18, credit meter 1402 is updated to 286 credits. Marker 1502 indicates a current position of football 410 on field 408 while marker 1504 indicates a first down location (e.g., a position that football 410 needs to reach for a first down to be achieved). Message 1506 also indicates that 9 yards are needed for a first down to be achieved.

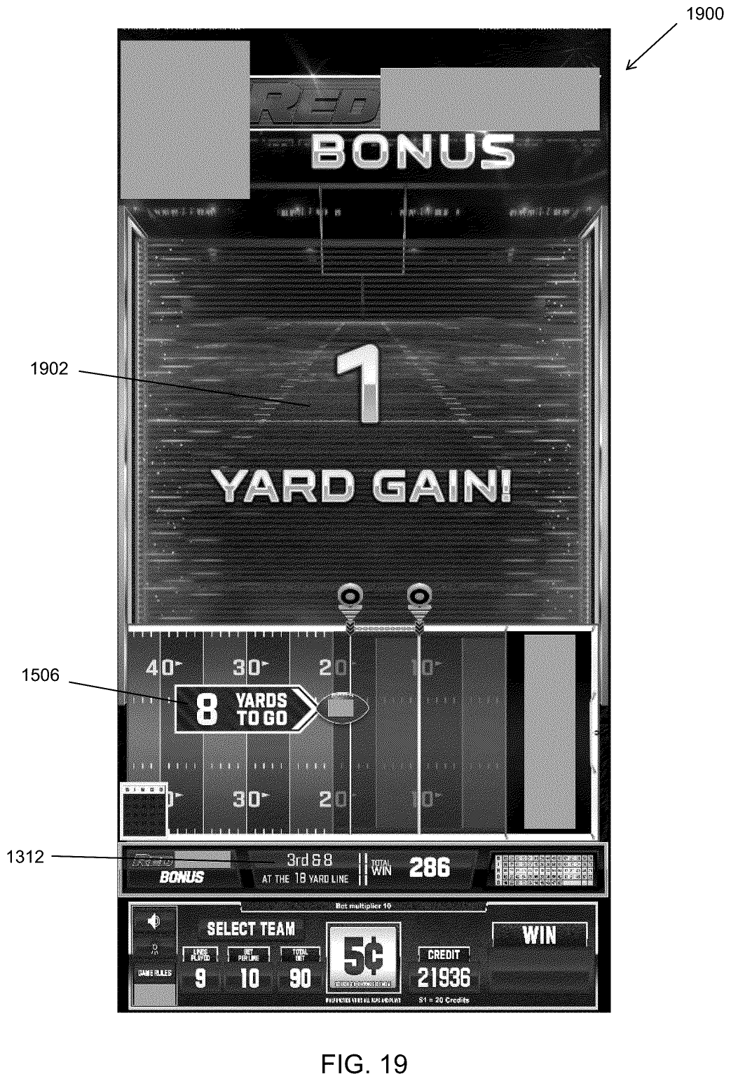

FIG. 19 illustrates an example screenshot and/or interface 1900 where a 1-yard gain, corresponding to pass option 1306, is provided. Accordingly, marker 1502 is updated (e.g., moved by 1 yard) and a 1-yard gain message 1902 is displayed. Message 1506 also indicates that now 8 yards are needed for a first down to be achieved and message 1312 is updated to show a current down, distance to a first down, and distance to the end zone.

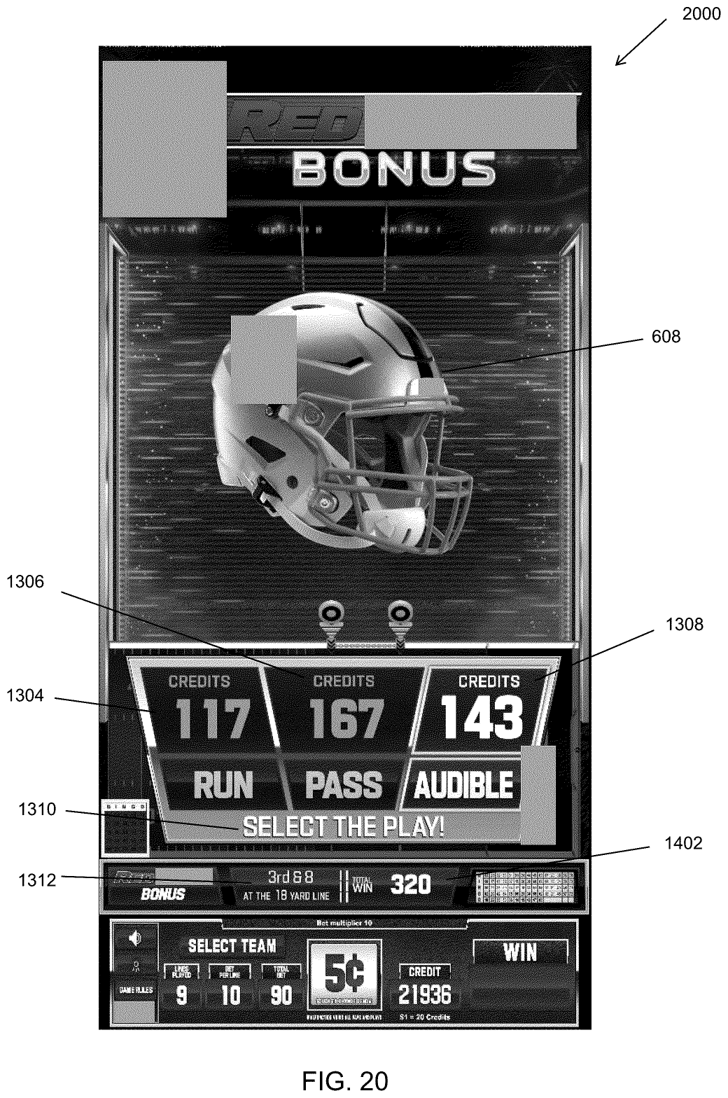

FIGS. 20-22 illustrate an example 1-yard gain resulting from an audible selection in the red zone bonus feature.

For example, FIG. 20 illustrates another example screenshot and/or interface 2000 of the red zone bonus feature following the above example. As shown in FIG. 20, run option 1304, pass option 1306, and audible option 1308 are provided for selection. Message 1310 communicates that a player may select one of options 1304-1308. Further, message 1312 is displayed to communicate a status of the red zone bonus feature. In this example, the down is third down and a distance to a new first down is 7 yards, and the football (e.g., football 410) is at the 18-yard line. Icon 608 is also again displayed.

In the example of FIG. 20, audible option 1308 has been selected. Accordingly, audible option 1308 is displayed as being highlighted (e.g., activated, illuminated), while run option 1304 and pass option 1306 are displayed as not being highlighted (e.g., inactivated, dull). Credit meter 1402 is also displayed as being updated from 286 credits to 429 credits (e.g., corresponding to audible option 1308 being associated with 143 credits).

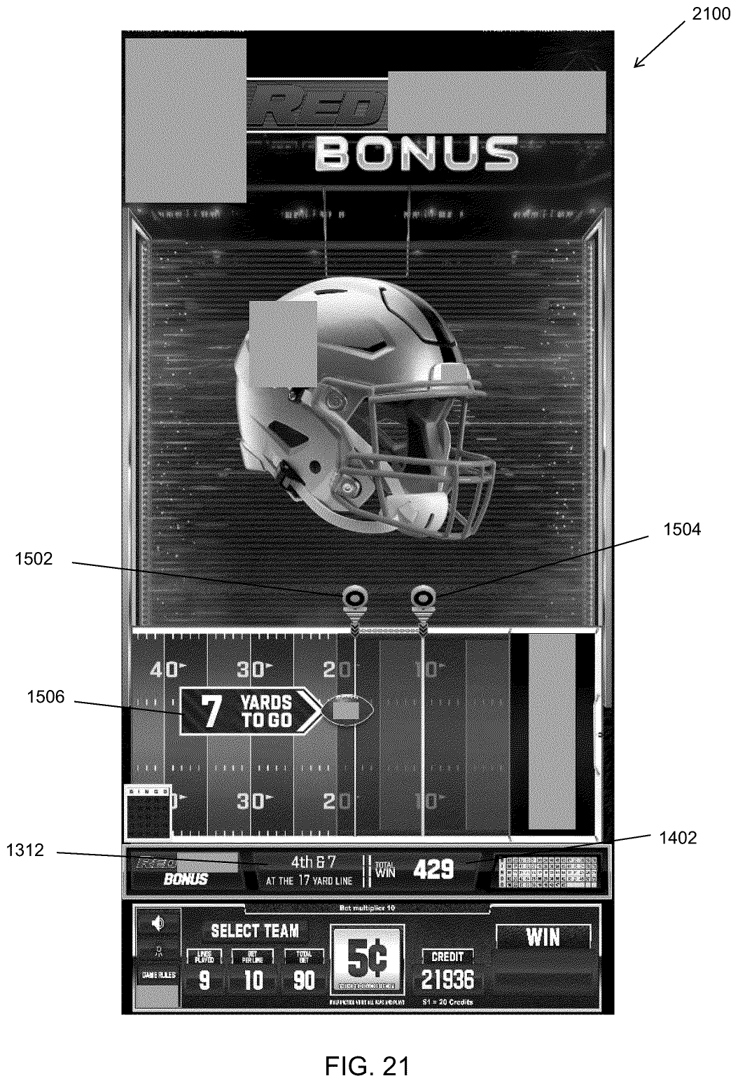

Thus, as shown in example screenshot and/or interface 2100 of FIG. 21, credit meter 1402 is updated to 429 credits. Marker 1502 indicates a current position of football 410 on field 408 while marker 1504 indicates a first down location (e.g., a position that football 410 needs to reach for a first down to be achieved). Message 1506 also indicates that now 7 yards are needed for a first down to be achieved and message 1312 is updated to show a current down, distance to a first down, and distance to the end zone.

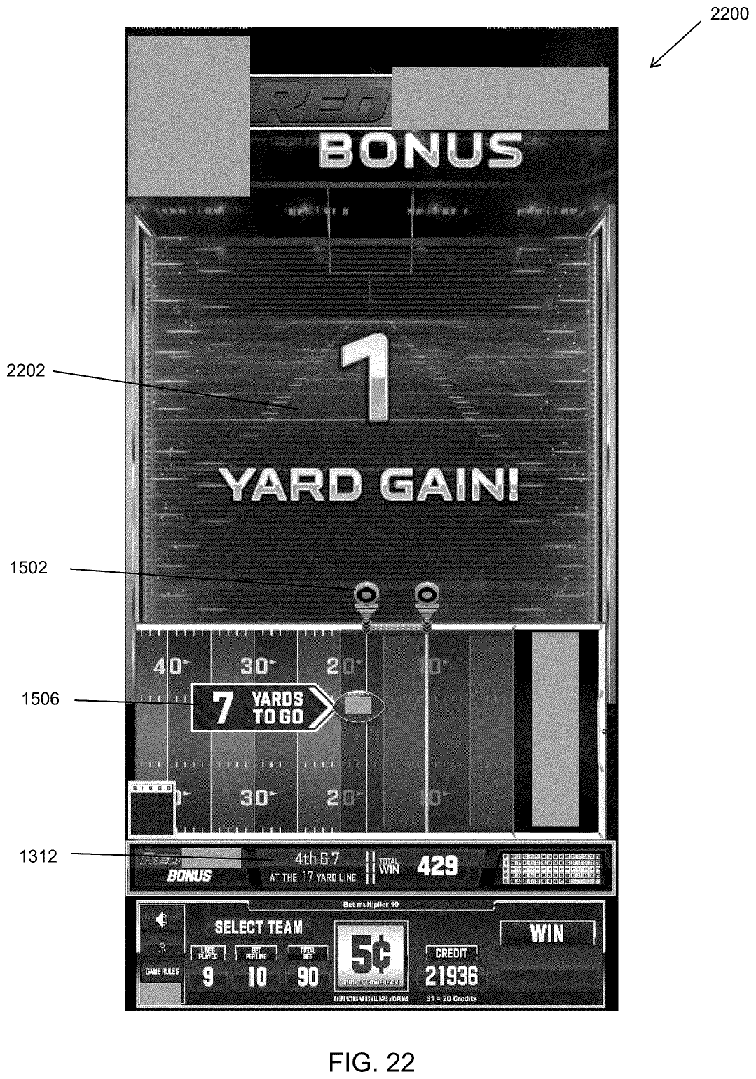

FIG. 22 illustrates an example screenshot and/or interface 2200 where a 1-yard gain, corresponding to audible option 1308, is provided. Accordingly, marker 1502 is updated (e.g., moved by 1 yard) and a 1-yard gain message 2202 is displayed.

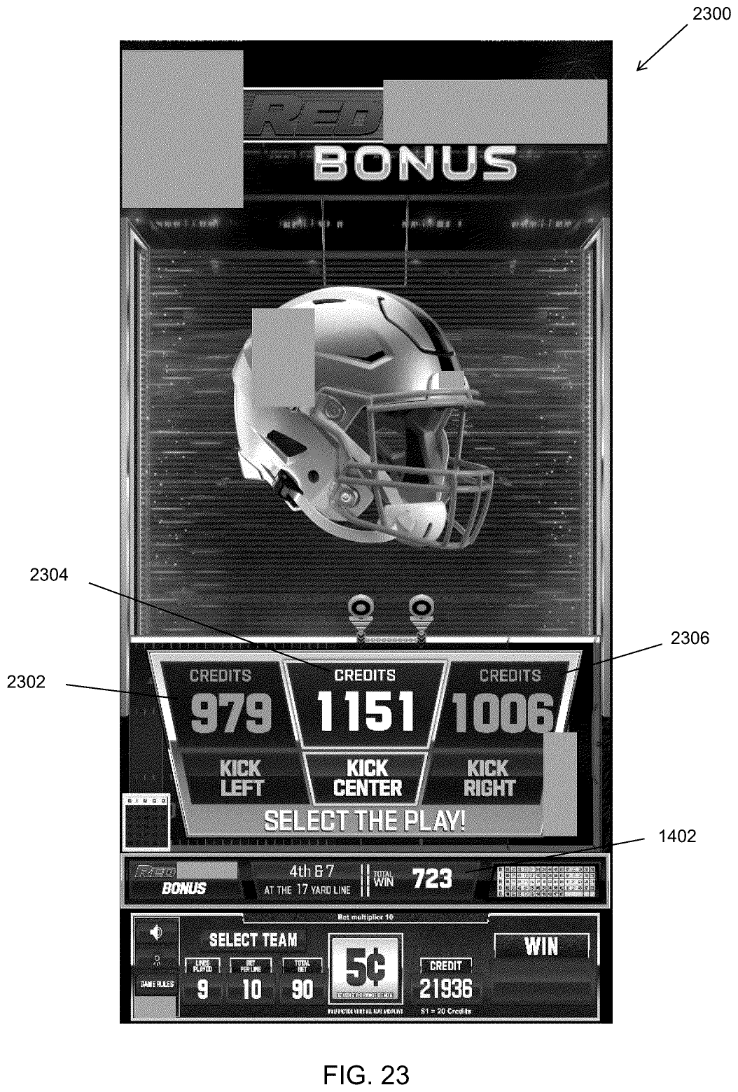

FIGS. 23-30 illustrate example field goal embodiments in the red zone bonus feature. For example, field goal options may automatically be provided on fourth down. In some embodiments, a field goal option may replace audible option 1308, while run option 1304 and pass option 1306 are still available. In examples where a field goal option is provided with run option 1304 and pass option 1306, if the field goal option is selected, play of the red zone bonus feature may advance to example screenshot and/or interface 2300 as shown in FIG. 23.

If run option 1304 or pass option 1306 are selected and a first down is achieved, play of the red zone bonus feature may continue and the number of downs reset (e.g., to first down). If a first down is not achieved after selection of run option 1304 or pass option 1306 on fourth down, the red zone bonus feature may end (e.g., and any accumulated credits at credit meter 1402 may be provided).

Example screenshot and/or interface 2300 allows for selection of kick left 2302, kick center 2304, or kick right 2306 (e.g., after manual or automatic selection of the field goal option). FIG. 23 illustrates an example where kick center 2304 has been selected. Accordingly, kick center 2304 is displayed as being highlighted (e.g., activated, illuminated), while kick left 2302 and kick right 2306 are displayed as not being highlighted (e.g., inactivated, dull). Credit meter 1402 is also displayed as being updated from 429 credits to 1580 credits (e.g., corresponding to kick center 2304 being associated with 1151 credits).

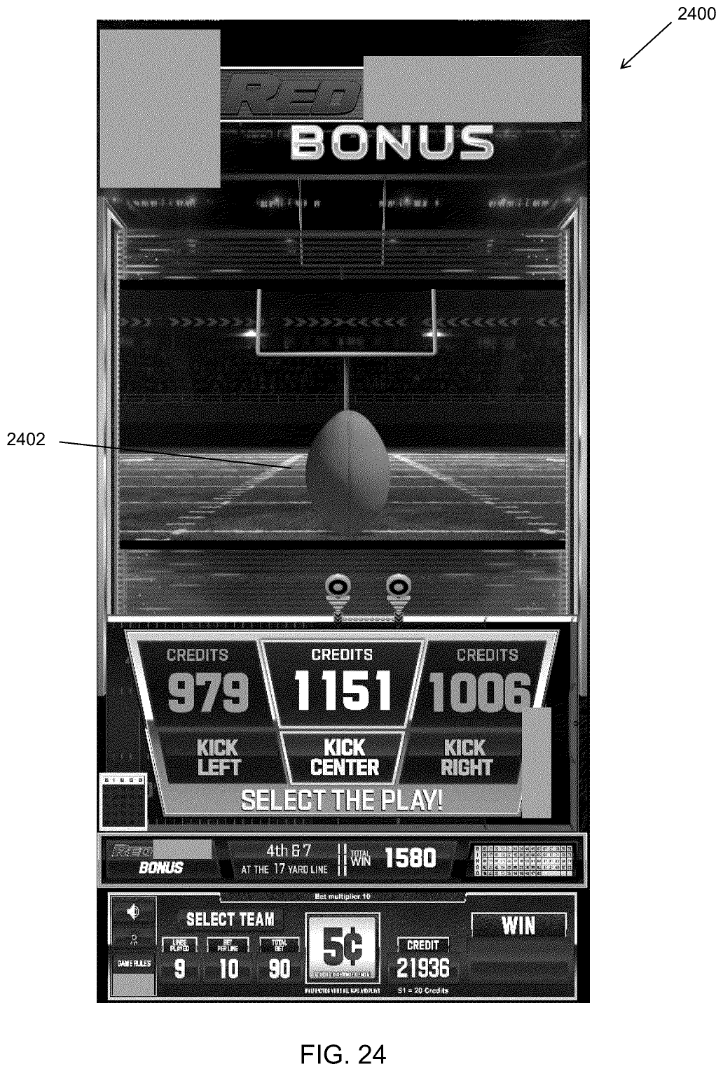

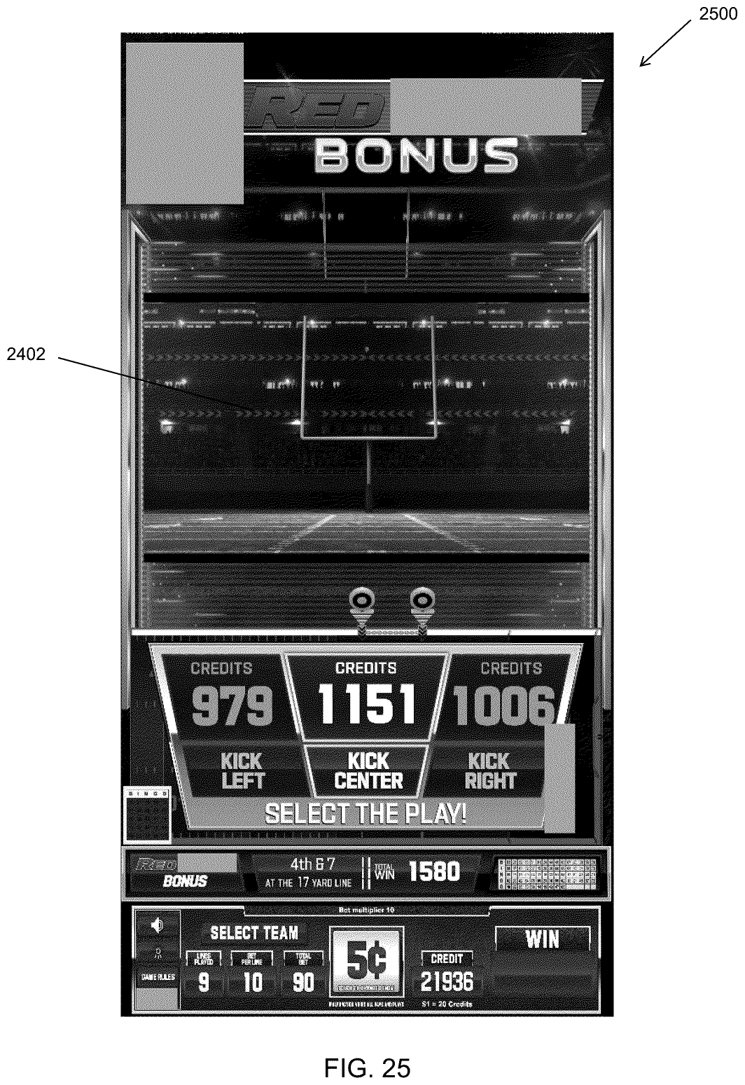

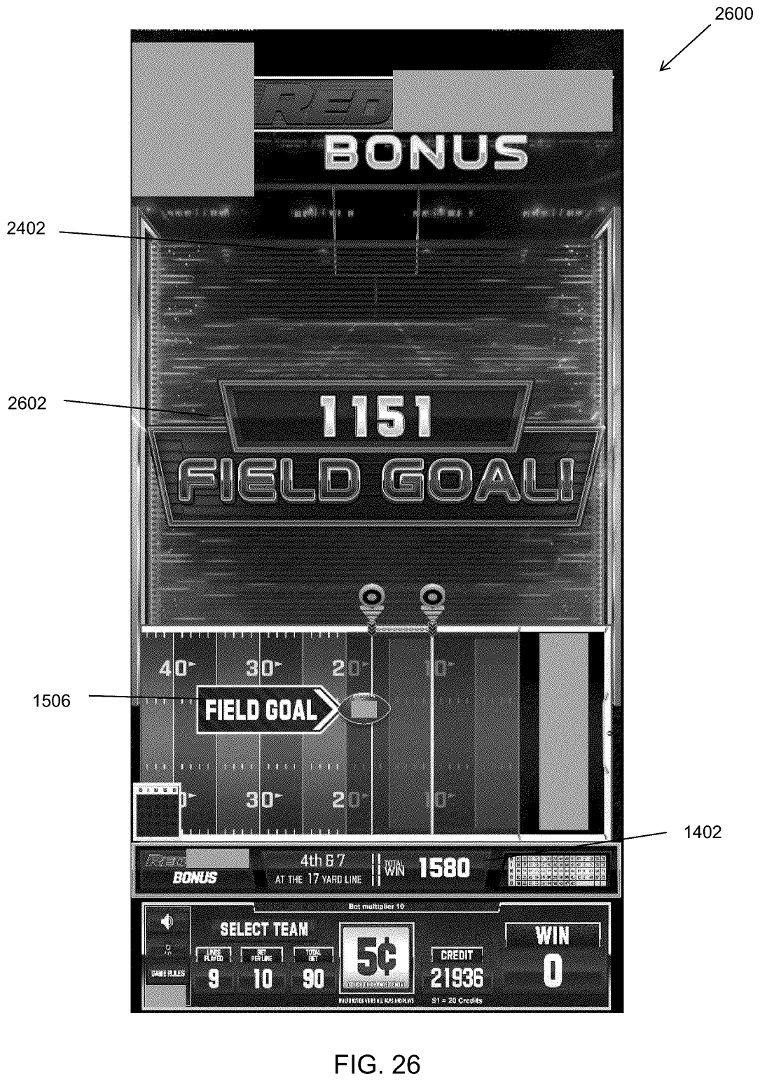

FIG. 24 illustrates an example screenshot and/or interface 2400 where a field goal animation 2402 begins (e.g., in response to selection of kick center 2304). FIG. 25 illustrates a next example screenshot and/or interface 2500 of field goal animation 2402. FIG. 26 illustrates a next example screenshot and/or interface 2600 of field goal animation 2402 where the field goal has been made and, accordingly, a message 2602 is displayed communicating that the field goal has been made and 1151 credits have been provided. For example, credit meter 1402 now shows 1580 credits. Message 1506 is also updated to indicate that a field goal has been achieved.

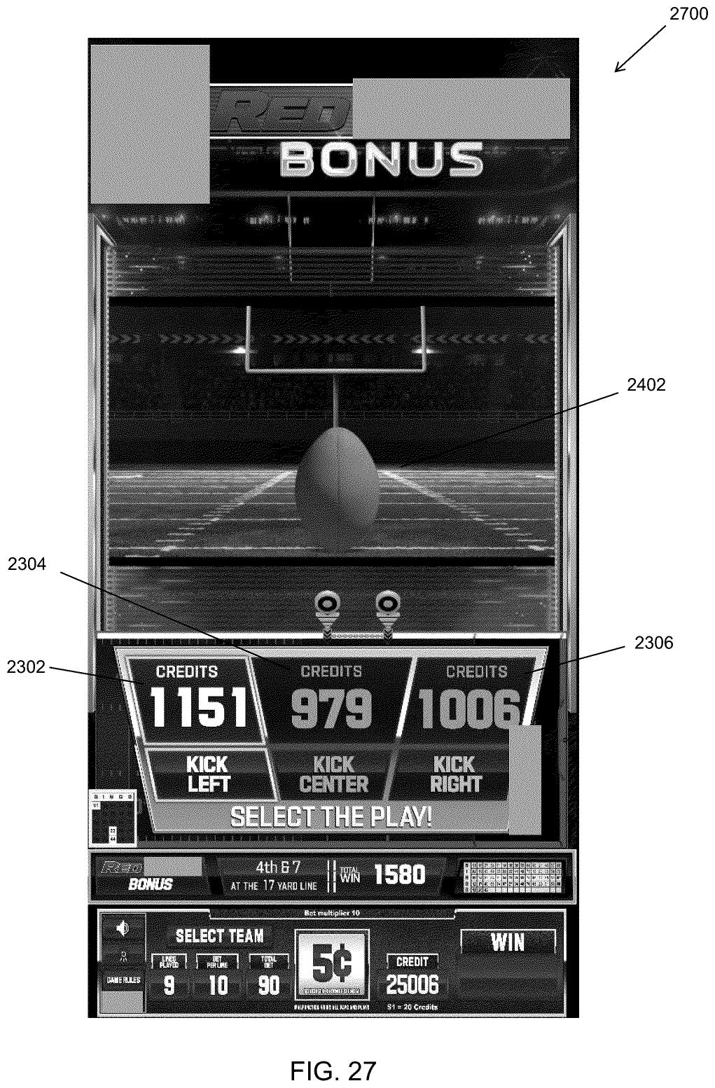

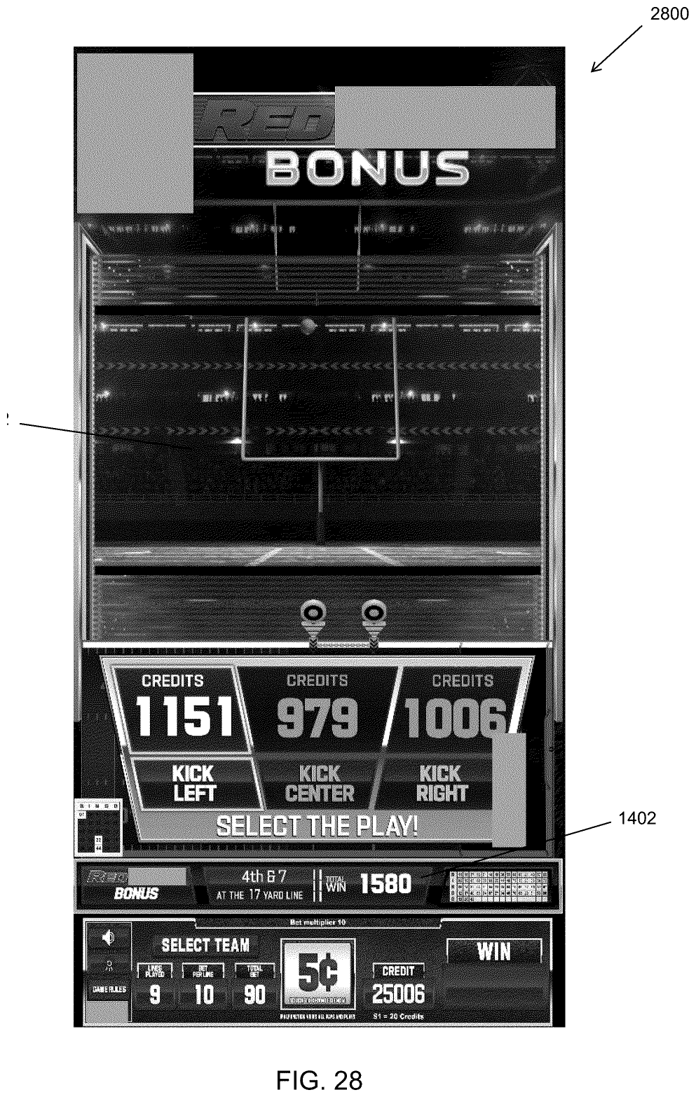

FIG. 27 illustrates an example screenshot and/or interface 2700 where field goal animation 2402 begins in response to selection of kick left 2302 (e.g., instead of the example shown at example screenshot and/or interface 2300 where kick center 2304 is selected). In other words, the example beginning at FIG. 27 is provided as if the selection of kick center 2304 and the examples shown at FIGS. 23-26 did not occur. FIG. 28 illustrates a next example screenshot and/or interface 2800 of field goal animation 2402. Credit meter 1402 now shows 1580 credits, corresponding to the 1151 credits associated with kick left 2302.

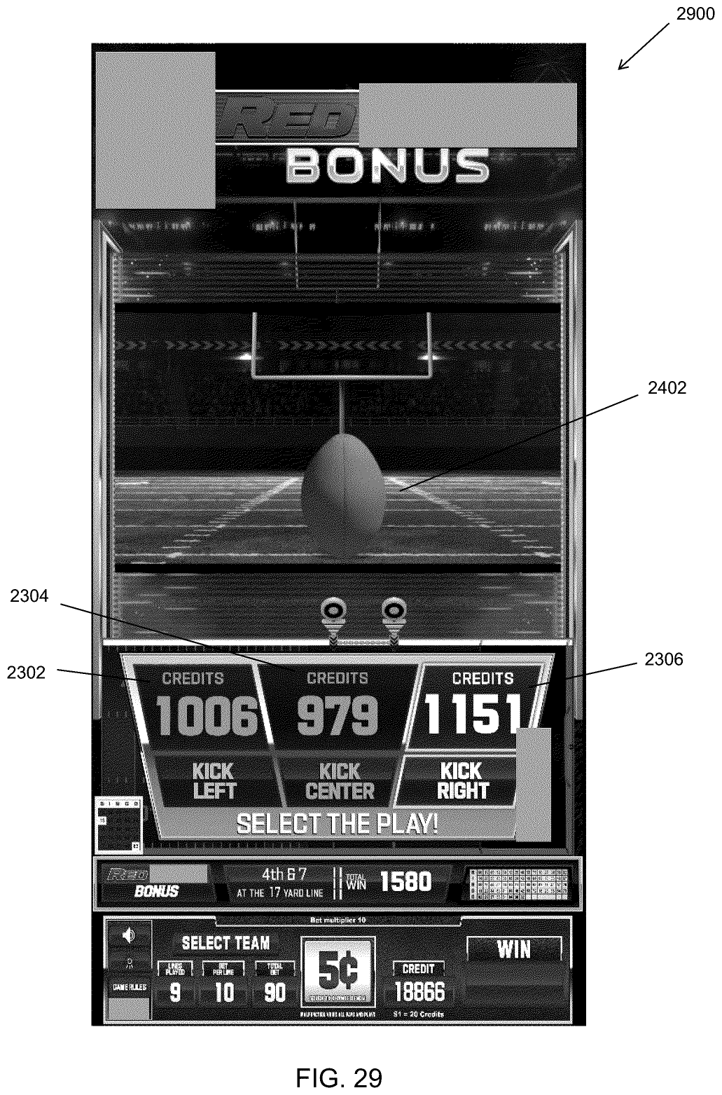

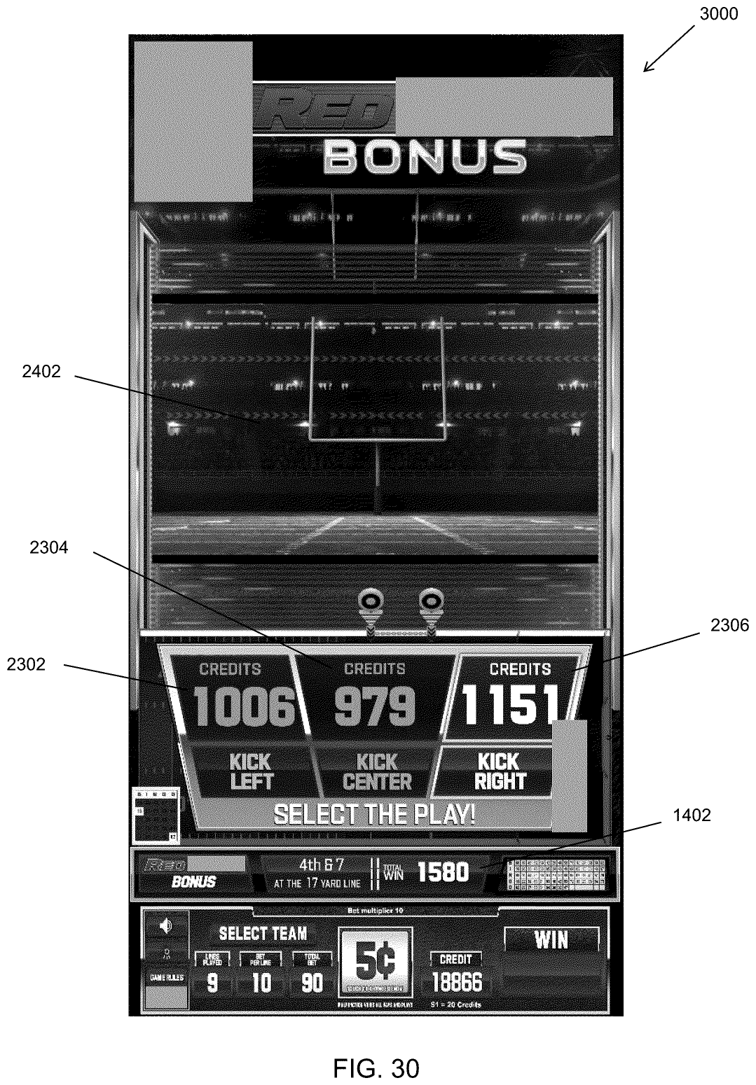

FIG. 29 illustrates an example screenshot and/or interface 2900 where field goal animation 2402 begins in response to selection of kick right 2306 (e.g., instead of the example shown at example screenshot and/or interface 2300 where kick center 2304 is selected). In other words, the example beginning at FIG. 29 is provided as if the selection of kick center 2304 and the examples shown at FIGS. 23-26, as well as the selection of kick left 2302 and the examples shown in FIGS. 27 and 28, did not occur. FIG. 30 illustrates a next example screenshot and/or interface 3000 of field goal animation 2402. Credit meter 1402 now shows 1580 credits, corresponding to the 1151 credits associated with kick right 2306.

As explained herein, in the example embodiment the electronic game provided is a Class II game. Accordingly, outcomes may be scripted (e.g., predetermined) based on a bingo card and a bingo ball call (e.g., and one or more bingo pattern pays achieved therefrom). The examples from herein illustrate example implementations of the red zone bonus feature corresponding to Class II. For example, it may be predetermined that a 1580 credit outcome should be provided for the red zone bonus feature. Accordingly, a script (e.g., one or more facades) may be selected that corresponds to a 1580 credit outcome. The examples shown at FIGS. 12-30 illustrate examples.

For instance, a 1580 credit outcome may be determined based on a bingo card and a bingo ball call (e.g., corresponding to one or more bingo pattern pays totaling 1580 credits). Then, a script, from a plurality of scripts associated with a 1580 credit outcome, may be selected. In the illustrated example, the selected script corresponds to a 143 credit play (e.g., see FIG. 14), another 143 credit play (e.g., see FIG. 17), another 143 credit play (e.g., see FIG. 20), and a 1151 credit field goal. Accordingly, regardless of which of run option 1304, pass option 1306, or audible option 1308 are selected on first down, second down, and third down respectively, 143 credits will be provided for each play based on the script. Alternate credit amounts that are not provided may also be included in the script and displayed at options that are not selected. Notably, this is why, as shown at FIGS. 14, 17, and 20, the amount of credits associated with each available option is displayed after selection of an option 1304-1308—because the selected option needs to correspond to 143 credits in accordance with the selected script.

In some embodiments, different credit amounts may be provided depending on which option (e.g., of options 1304-1308) is selected and/or in accordance with a total output amount to be provided. For example, if a total bingo game outcome is determined to be 2500 credits, depending on which of options 1304-1308 is selected, the game may award a first portion of the total amount (e.g., 125 credits) for selection of run option 1304, a second portion of the total amount (e.g., 175 credits) for selection of pass option 1306, or a third portion of the total amount (e.g., 200 credits) for selection of audible option 1308. Different combinations of credit amounts are provided based on player selection paths (e.g., different sequences of selections) as long as the end total is equal to 2500 credits, in this example.

Furthering the above example, after 143 credits are provided at each of the first down play, the second down play, and the third down play, 1151 credits need to be provided during the field goal in order for the total of 1580 credits to be provided. Thus, an amount of credits associated with the selected field goal needs to be 1151 credits, and 1151 credits are displayed as being associated with the selected option after selection of the selected option (e.g., see FIGS. 23, 27, and 29, as examples). In other words, 1151 credits will be provided for the field goal play regardless of which of kick left 2302, kick center 2304, or kick right 2306 are selected.

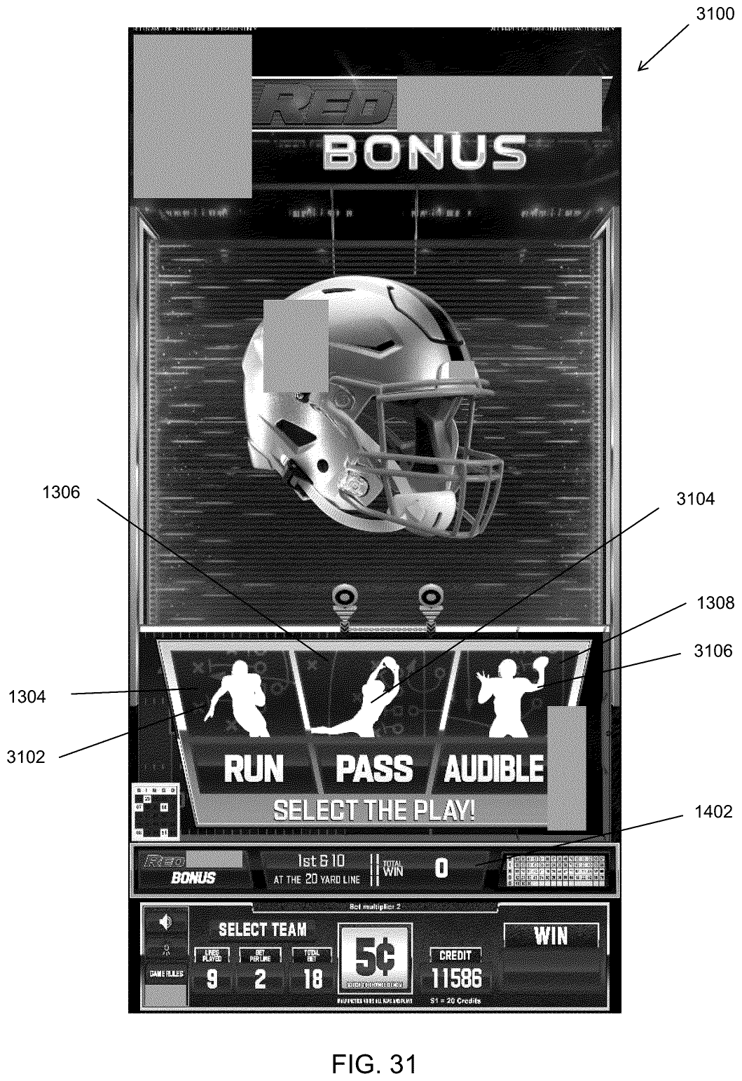

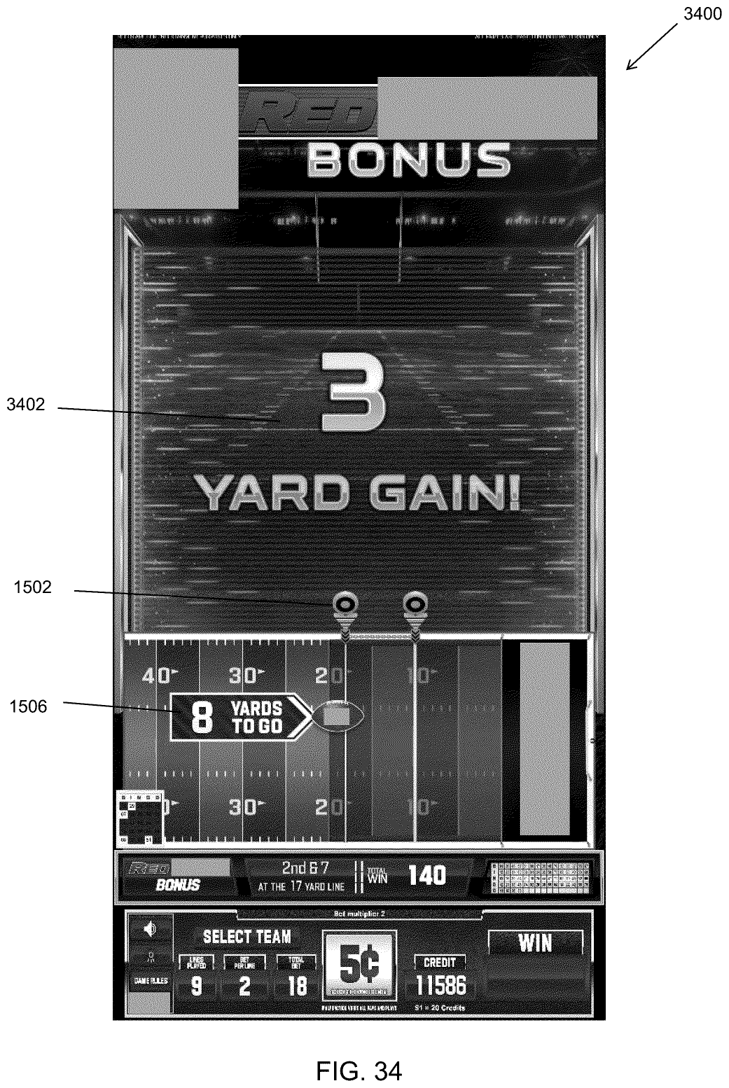

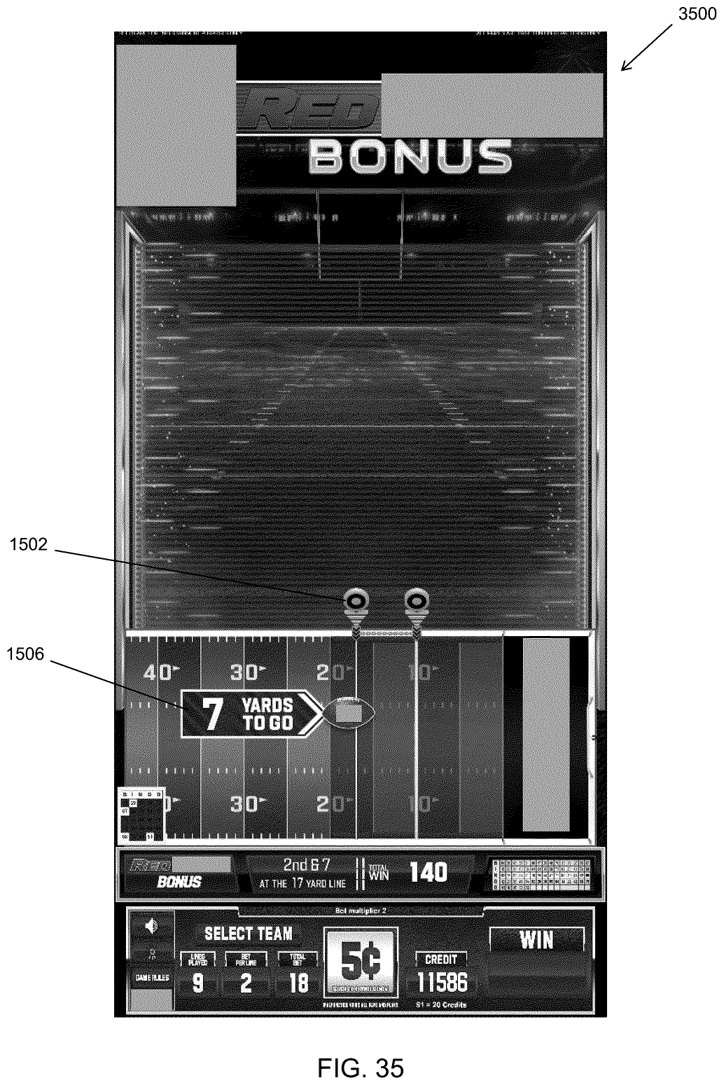

FIGS. 31-35 illustrate an example three-yard gain resulting from a run play selection in another example of the red zone bonus feature.

Continuing the above Class II explanation, at screenshot and/or interface 3100 of FIG. 31, icons 3102, 3104, and 3106 are shown as being associated with each of respective options 1304-1308. Credit meter 1402 shows 0 credits as this is the start of another example play of the red zone bonus feature.

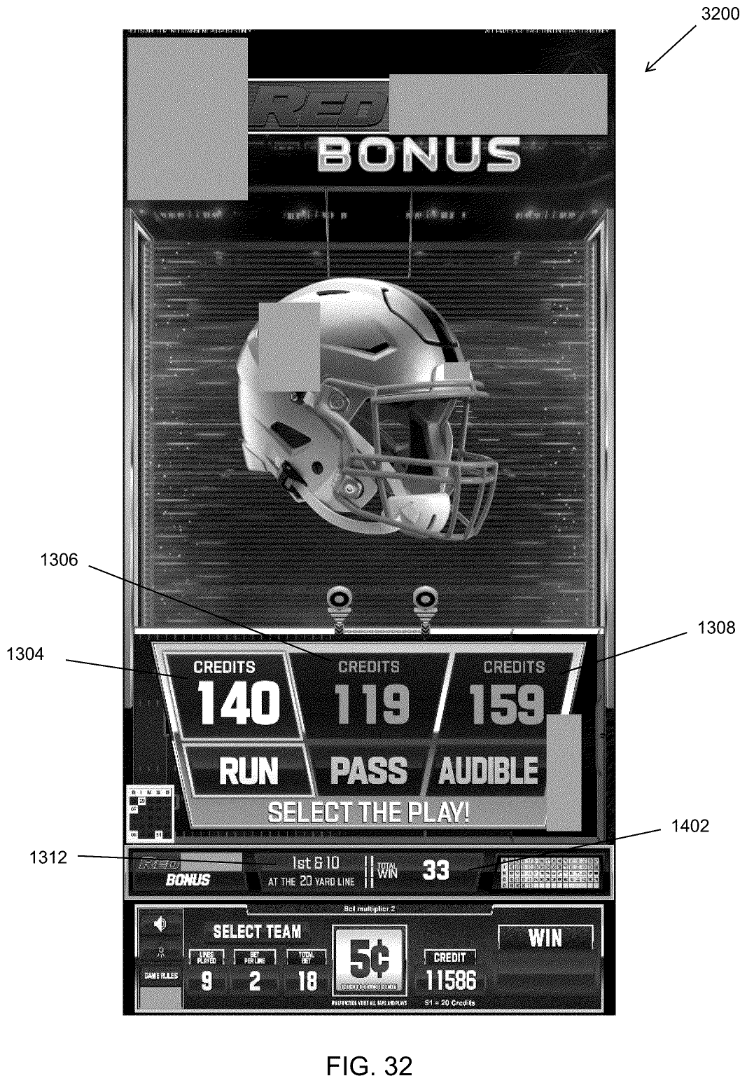

In this example, the selected script indicates that a first play in the red zone bonus feature should provide 140 credits. Accordingly, a 140-credit amount is shown as being associated with run option 1304 after run option 1304 is selected as shown in example screenshot and/or interface 3200 of FIG. 32 (e.g., and would have been shown as being associated with pass option 1306 if pass option 1306 was selected, or audible option 1308 if audible option 1308 was selected).

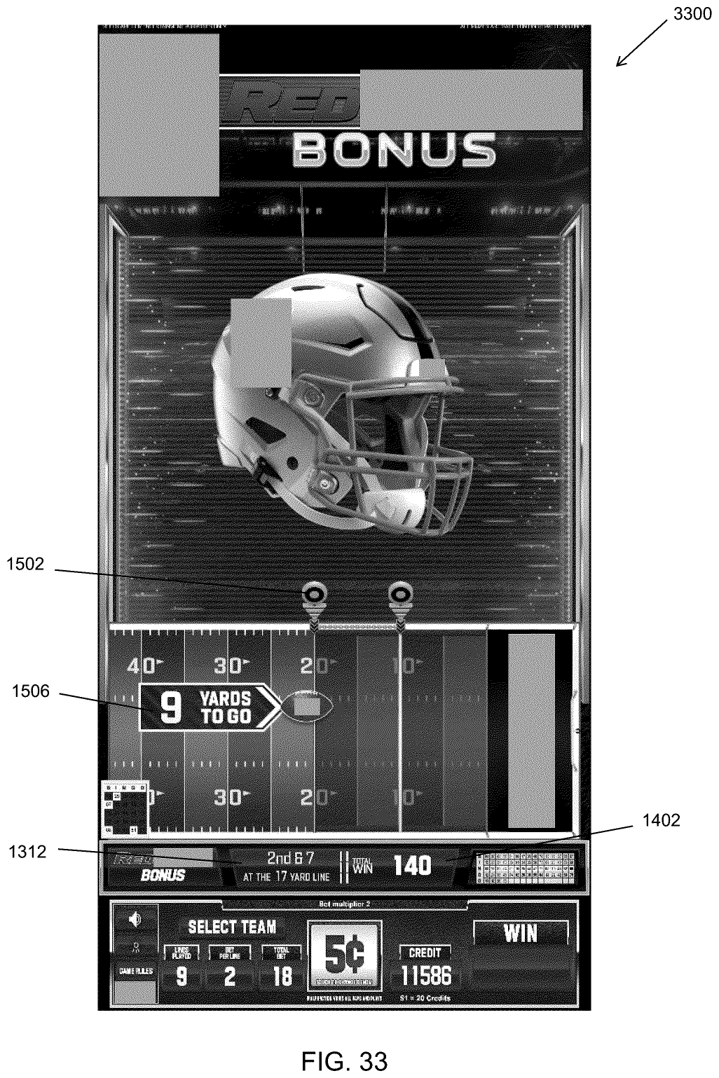

Accordingly, example screenshots and/or interfaces 3300, 3400, and 3500 of FIGS. 33-35 respectively illustrate a transition of marker 1502, message 1506, and message 1312 being updated to correspond to the three-yard gain associated with the selection of run option 1304. Credit meter 1402 is also updated to 140 credits based on the 140-credit amount associated with selection of run option 1304. A message 3402 associated with the three-yard gain is also provided for efficient communication.

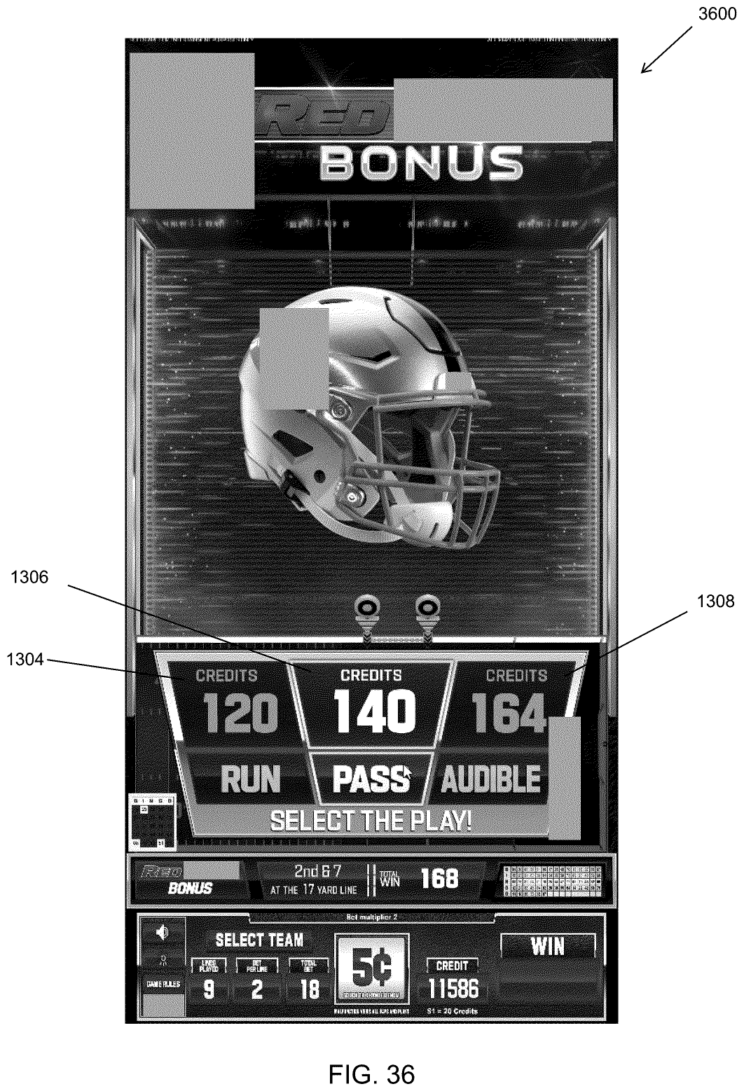

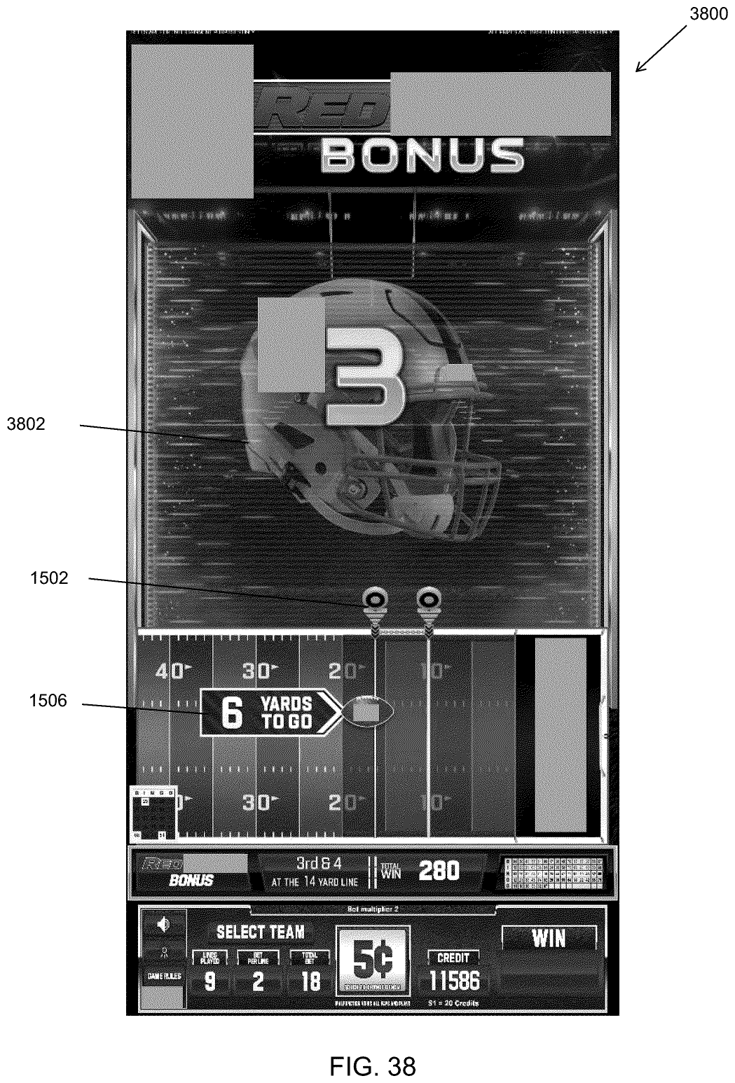

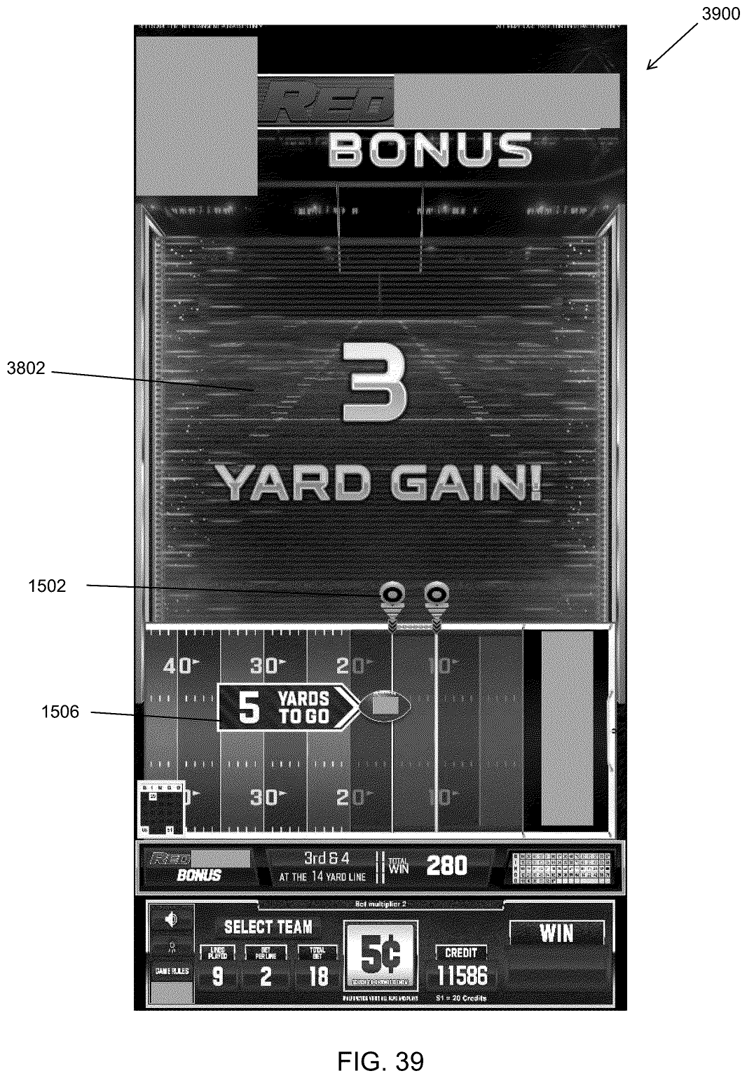

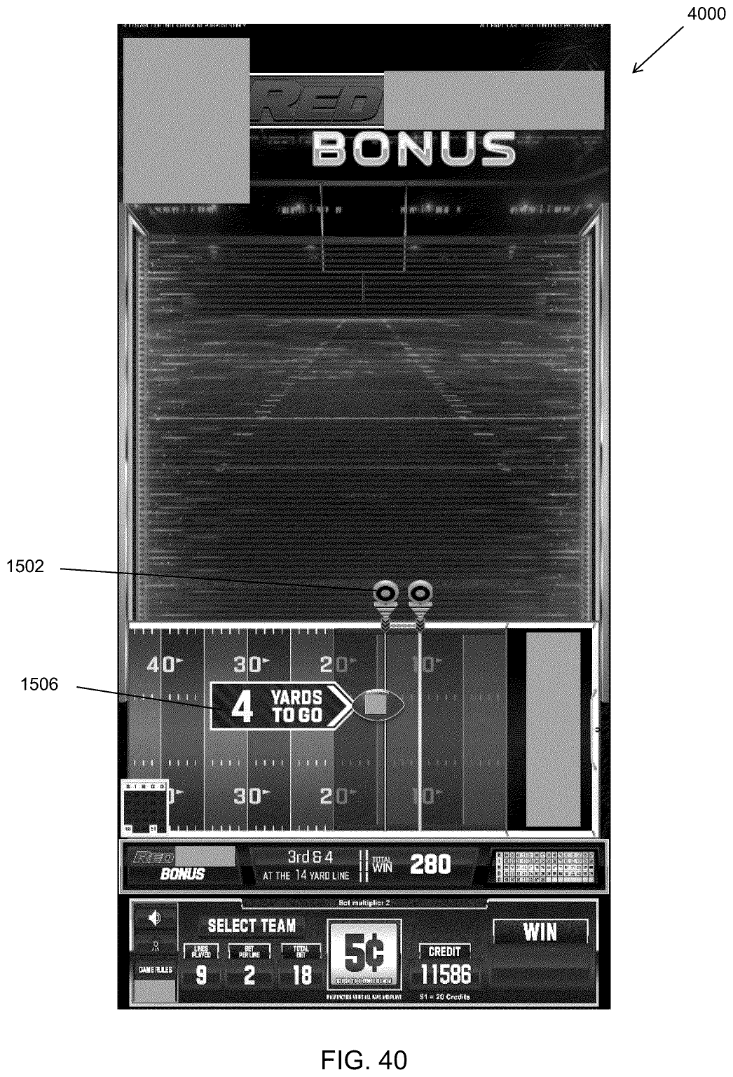

FIGS. 36-40 illustrate an example three-yard gain resulting from selection of pass option 1306 in the red zone bonus feature.

Continuing the above Class II example, at screenshot and/or interface 3600 of FIG. 36, the selected script indicates that a second play in the red zone bonus feature should also provide 140 credits. Accordingly, a 140-credit amount is shown as being associated with pass option 1306 after pass option 1306 is selected (e.g., and would have been shown as being associated with run option 1304 if run option 1304 was selected, or audible option 1308 if audible option 1308 was selected).

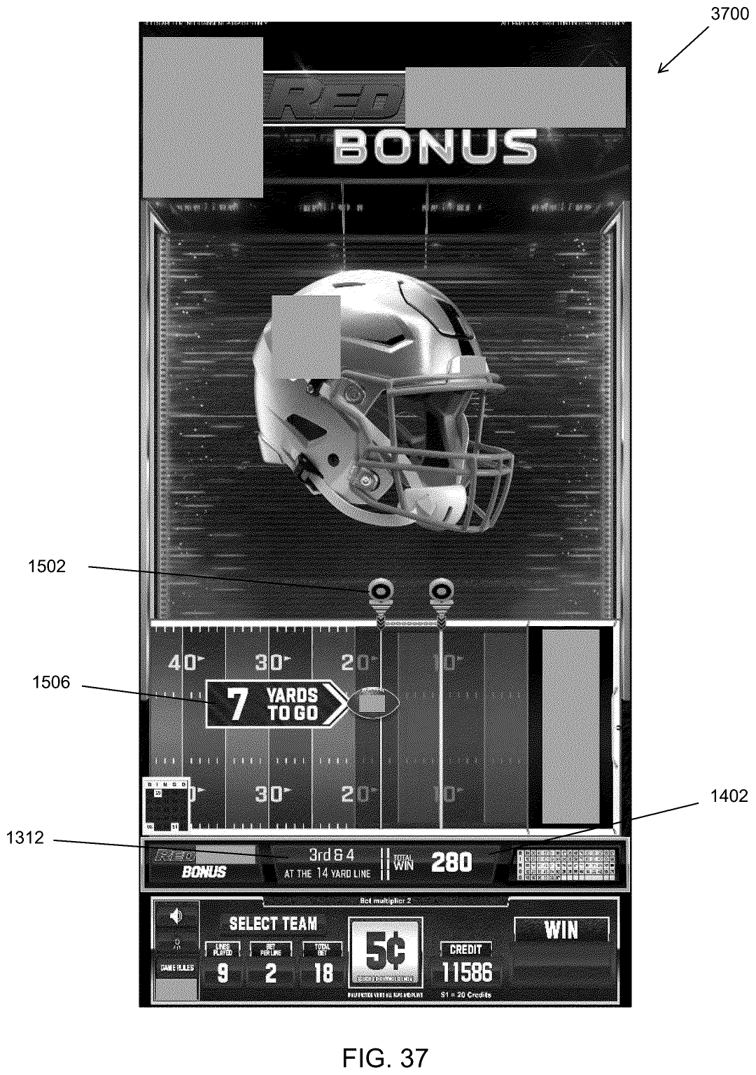

Accordingly, example screenshots and/or interfaces 3700, 3800, 3900, and 4000 of FIGS. 37-40 respectively illustrate a transition of marker 1502, message 1506, and message 1312 being updated to correspond to the three-yard gain associated with the selection of pass option 1306. Credit meter 1402 is also updated to 280 credits based on the 140-credit amount associated with selection of pass option 1306. A message 3802 associated with the three-yard gain is also provided for efficient communication.

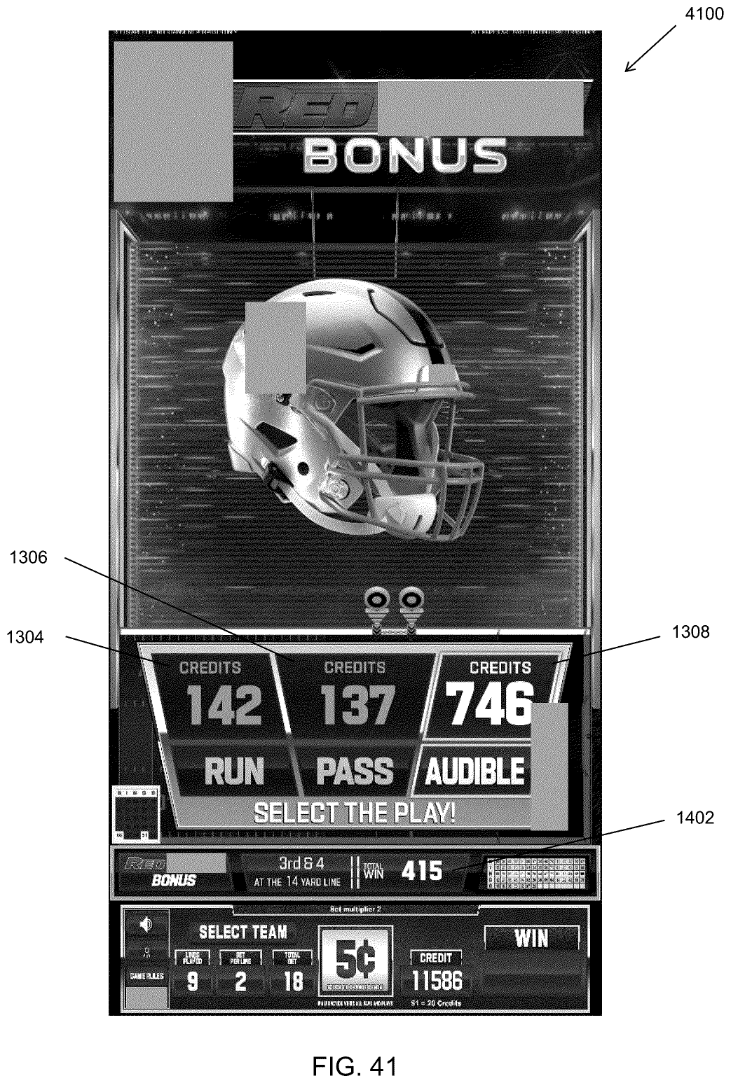

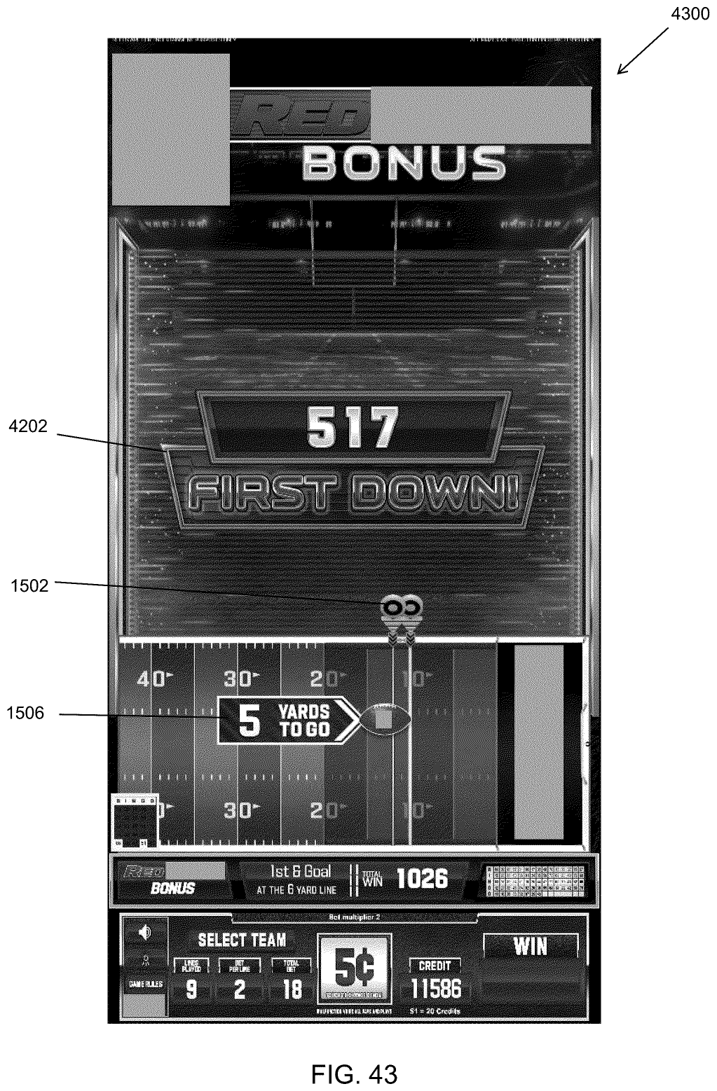

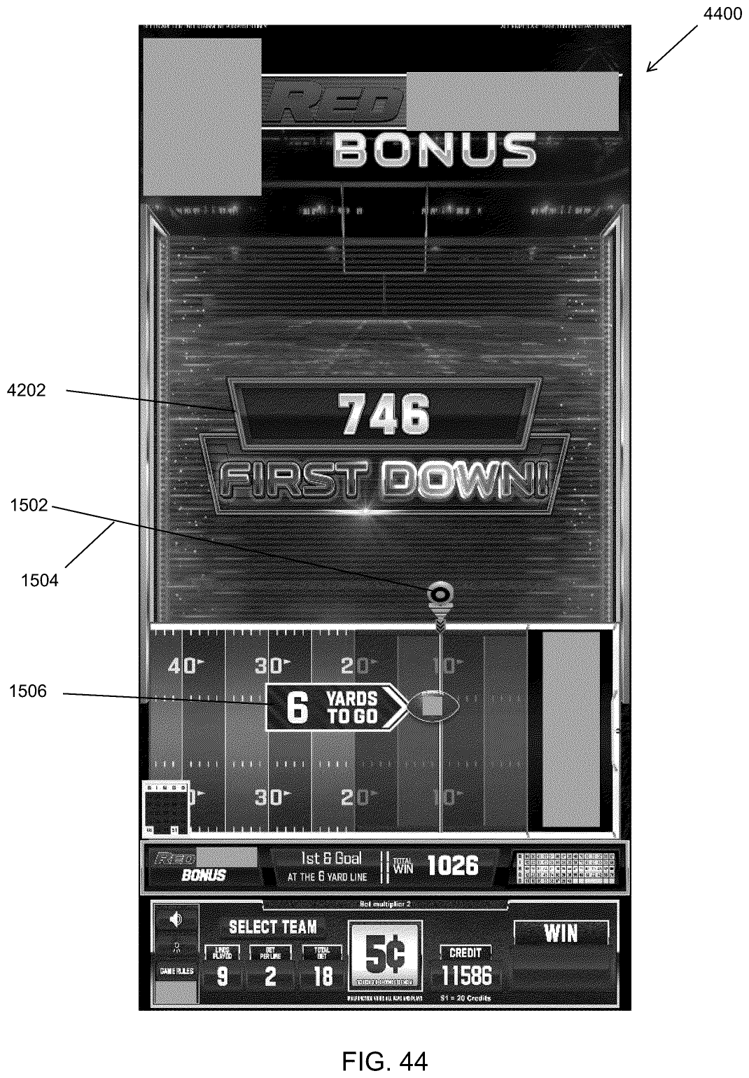

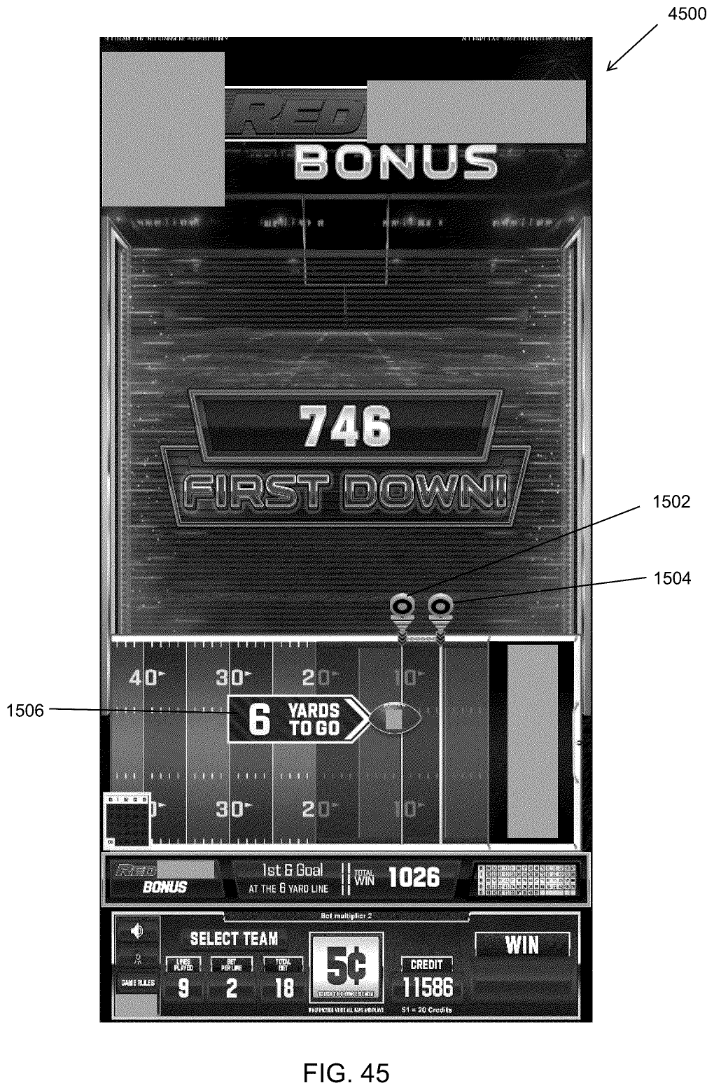

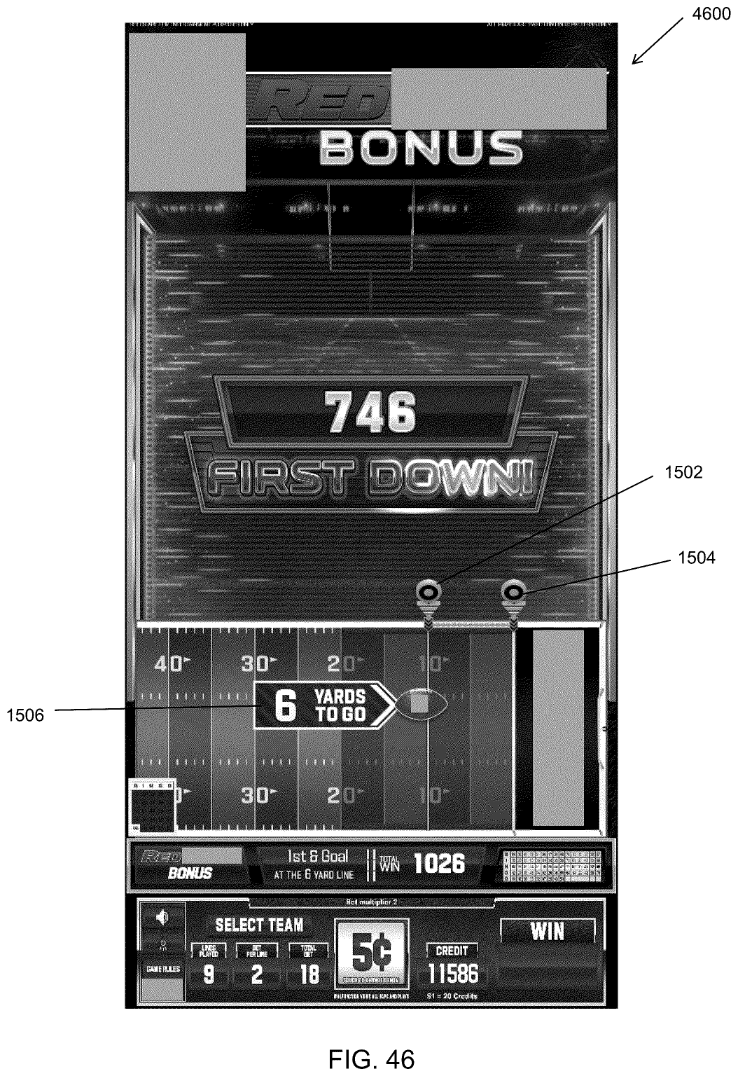

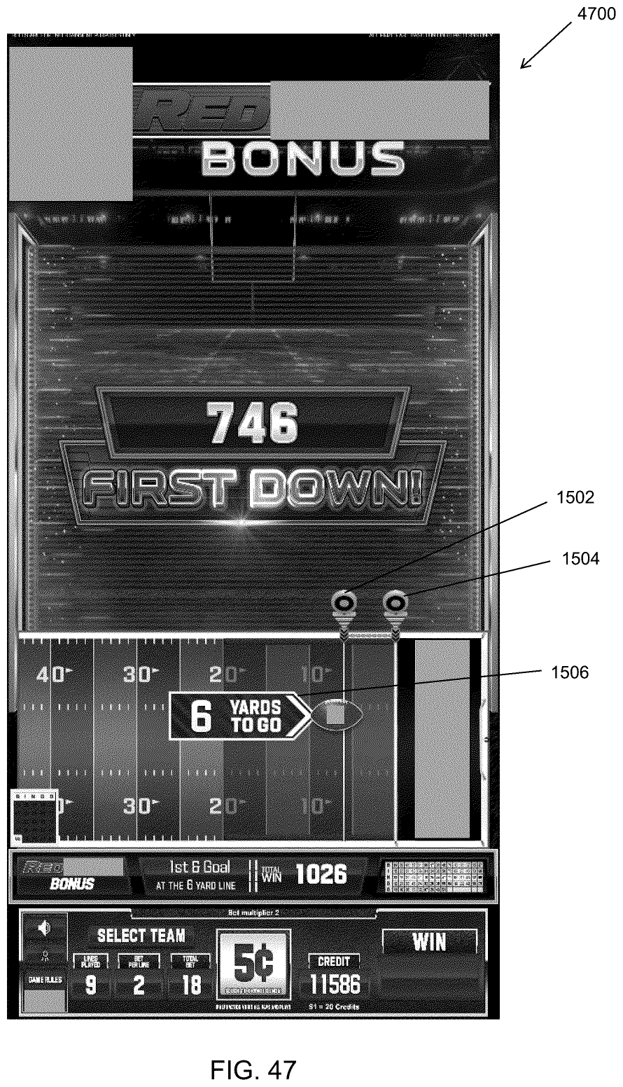

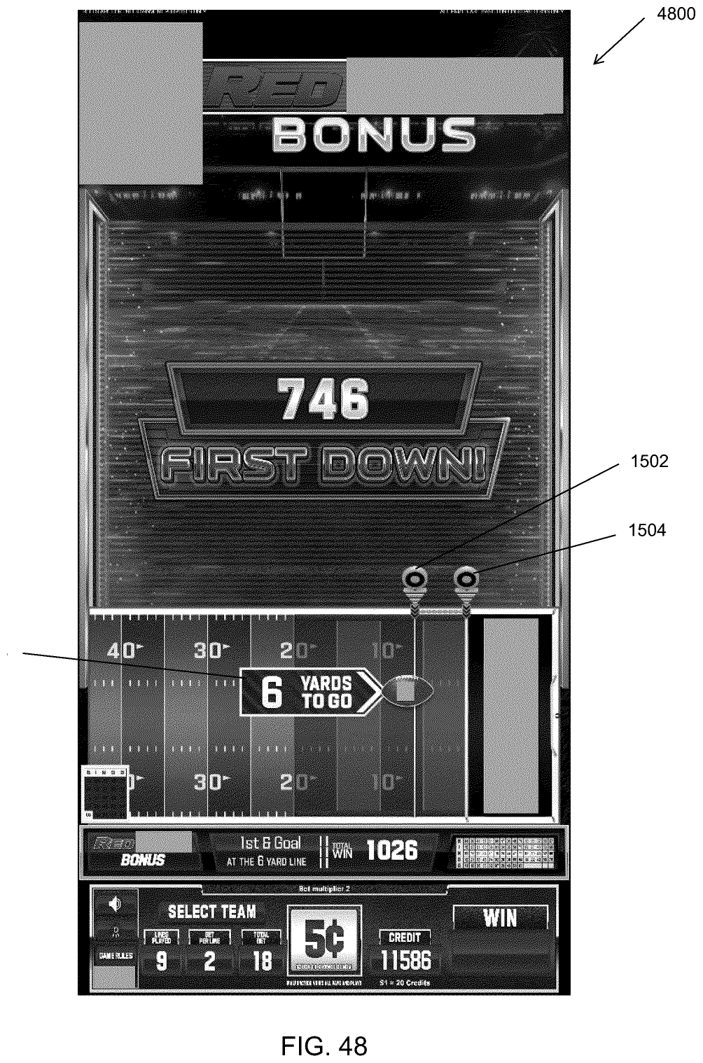

FIGS. 41-49 illustrate an example first down being achieved resulting from selection of audible option 1308 in the red zone bonus feature (e.g., including yard markers 1502, 1504 being updated to new display positions corresponding to the current position of the football and a yard line to achieve a next first down or touchdown).

Continuing the above Class II example, at screenshot and/or interface 4100 of FIG. 41, the selected script indicates that a third play in the red zone bonus feature should provide 746 credits. Accordingly, a 746-credit amount is shown as being associated with audible option 1308 after audible option 1308 is selected (e.g., and would have been shown as being associated with run option 1304 if run option 1304 was selected, or pass option 1306 if pass option 1306 was selected).

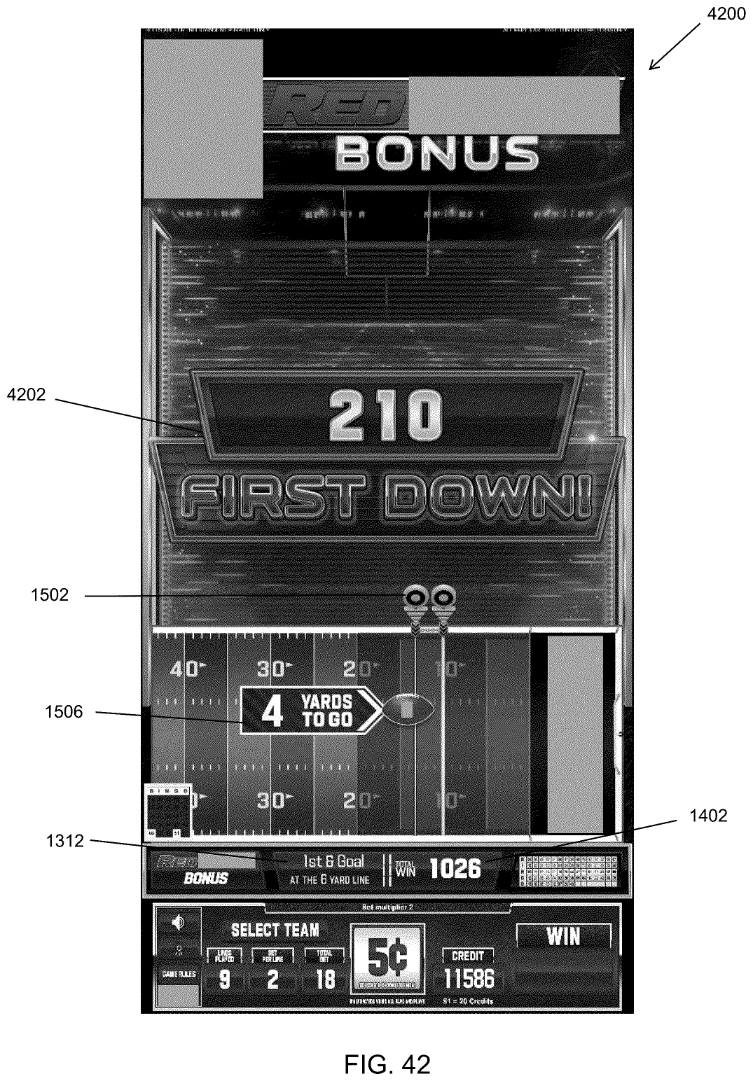

Accordingly, example screenshots and/or interfaces 4200, 4300, 4400, 4500, 4600, 4700, 4800, and 4900 of FIGS. 42-49 respectively illustrate a transition of markers 1502, 1504, message 1506, and message 1312 being updated to correspond to an eight-yard gain associated with the selection of audible option 1308 (e.g., and resulting in a first down). Credit meter 1402 is also updated to 1026 credits based on the 746-credit amount associated with selection of audible option 1308.

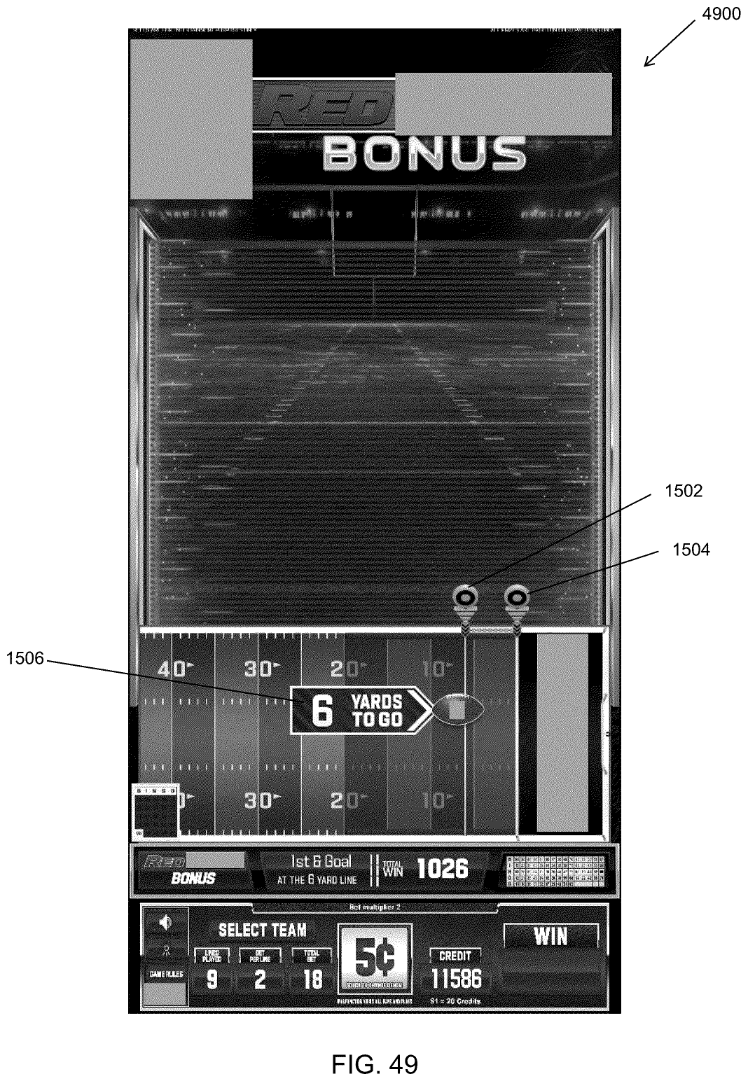

Further a first down message 4202 is provided to help communicate that a first down has been achieved in the red zone bonus feature. As shown in the transition of FIGS. 42-49, marker 1502 approaches marker 1504 until marker 1502 reaches marker 1504, at which point marker 1504 transitions to being updated to being associated with a new line to gain (e.g., in this case, the goal line because another first down cannot be achieved based on advancing yards—because football 410 is at the 6-yard line, as shown in FIG. 49, and thus 10 more yards cannot be achieved. In other words, less than 10 yards remain until the goal line is reached). Once marker 1504 is updated, marker 1502 continues to be updated to correspond to the new location of football 410.

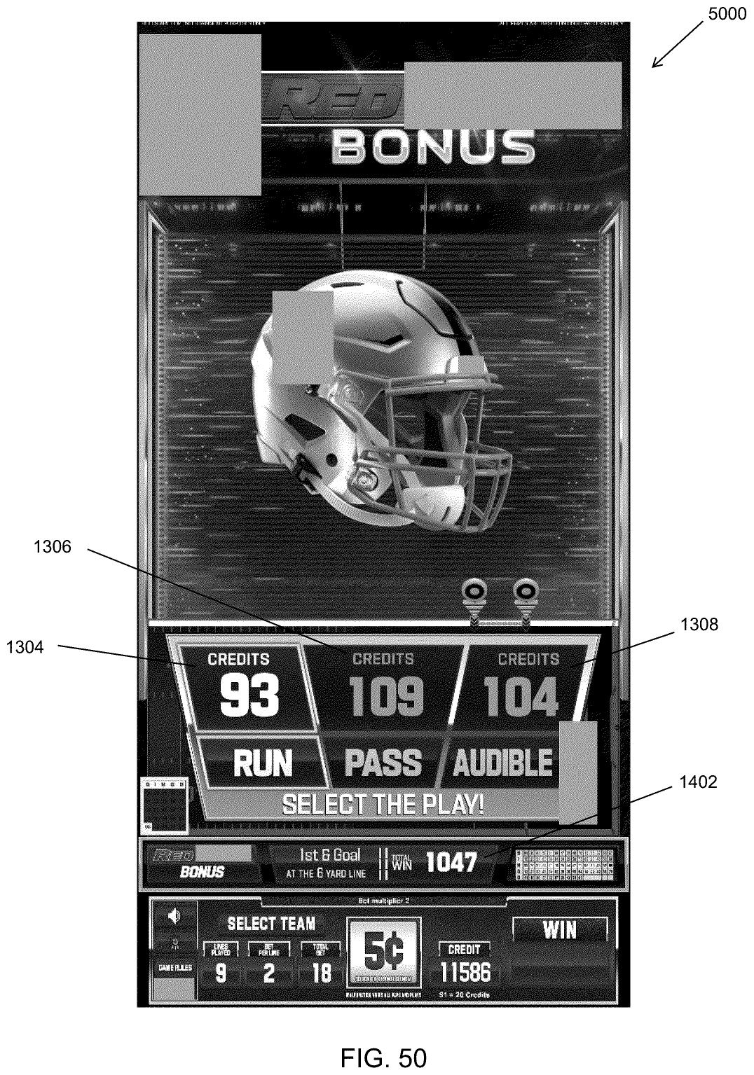

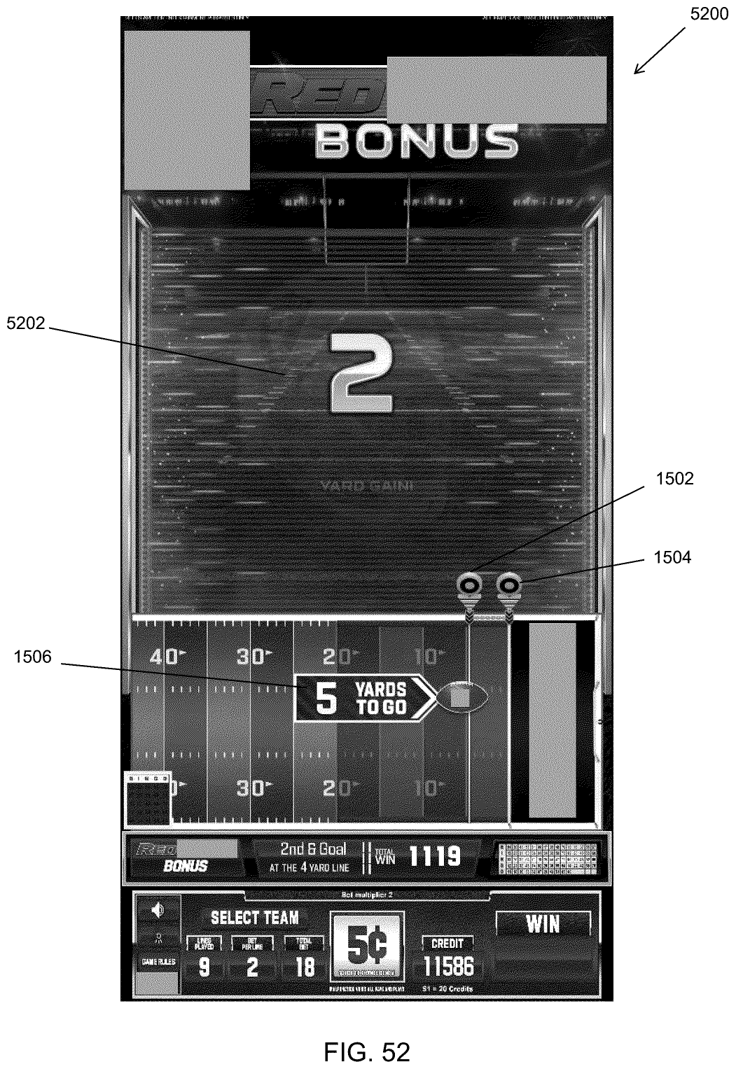

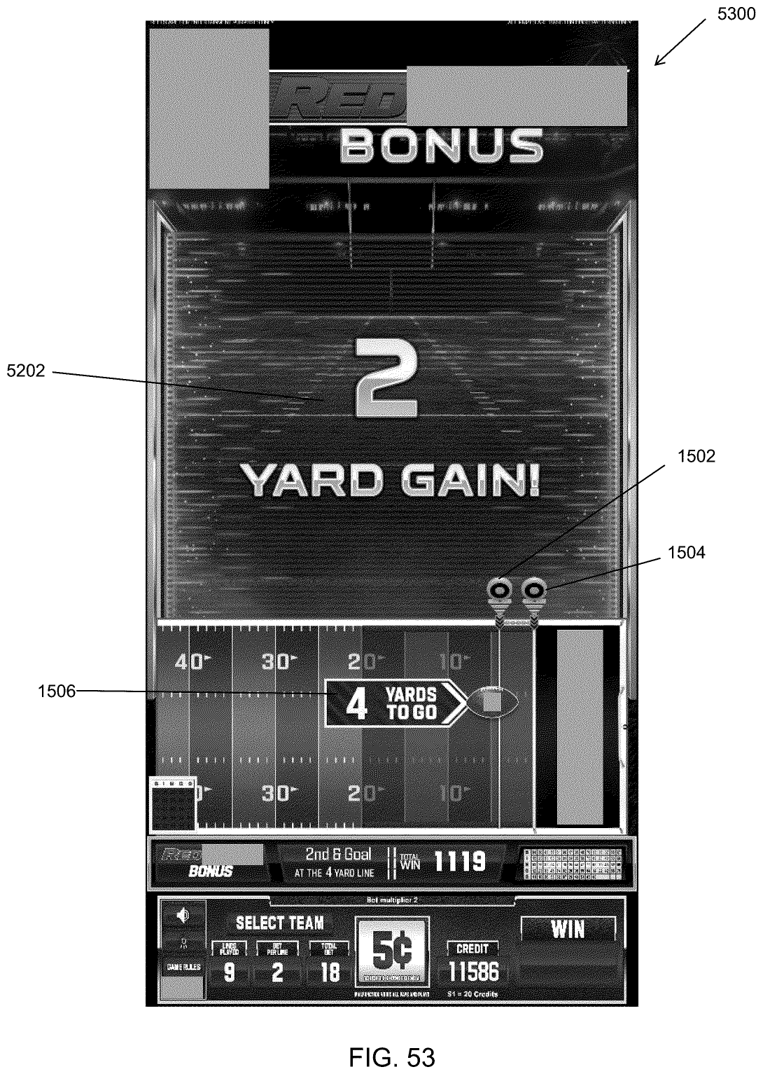

FIGS. 50-53 illustrate an example two-yard gain resulting from a run play selection in the red zone bonus feature.

Continuing the above Class II example, at screenshot and/or interface 5000 of FIG. 50, the selected script indicates that a fourth play in the red zone bonus feature should provide 93 credits. Accordingly, a 93-credit amount is shown as being associated with run option 1304 after run option 1304 is selected (e.g., and would have been shown as being associated with pass option 1306 if pass option 1306 was selected, or audible option 1308 if audible option 1308 was selected).

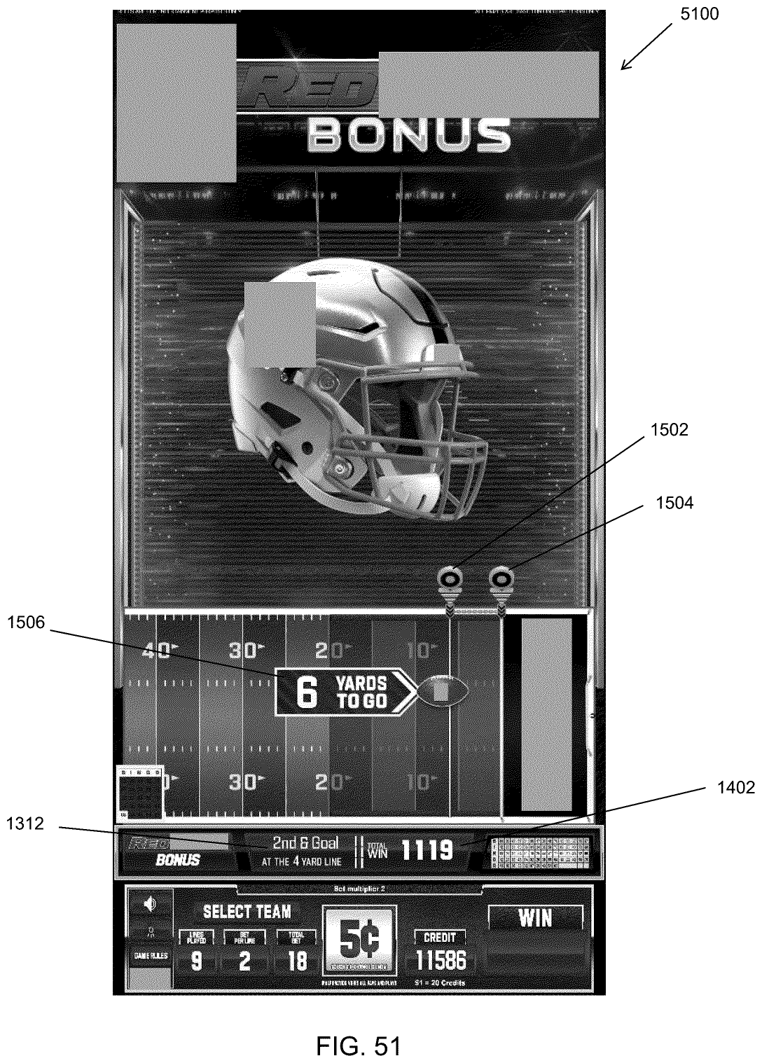

Accordingly, example screenshots and/or interfaces 5100, 5200, and 5300 of FIGS. 51-53 respectively illustrate a transition of marker 1502, message 1506, and message 1312 being updated to correspond to a two-yard gain associated with the selection of run option 1304. Credit meter 1402 is also updated to 11586 credits based on the 93-credit amount associated with selection of run option 1304. A message 5202 associated with the two-yard gain is also provided for efficient communication.

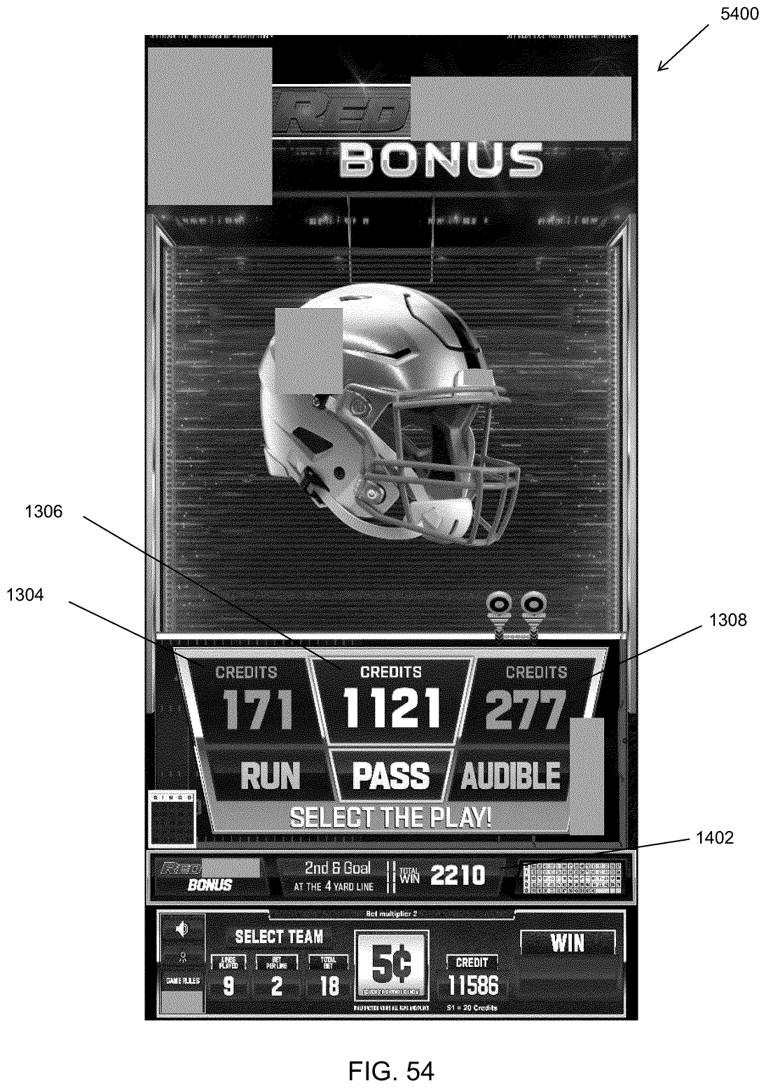

FIGS. 54-58 illustrate an example touchdown being achieved in response to a pass play selection in the red zone bonus feature (e.g., including a video clip being displayed of a pass play resulting in a touchdown, for example, from a prior football game including the team selected as a theme for the game).

Continuing the above Class II example, at screenshot and/or interface 5400 of FIG. 54, the selected script indicates that a fifth play in the red zone bonus feature should provide 1121 credits. Accordingly, a 1121-credit amount is shown as being associated with pass option 1306 after pass option 1306 is selected (e.g., and would have been shown as being associated with run option 1304 if run option 1304 was selected, or audible option 1308 if audible option 1308 was selected).

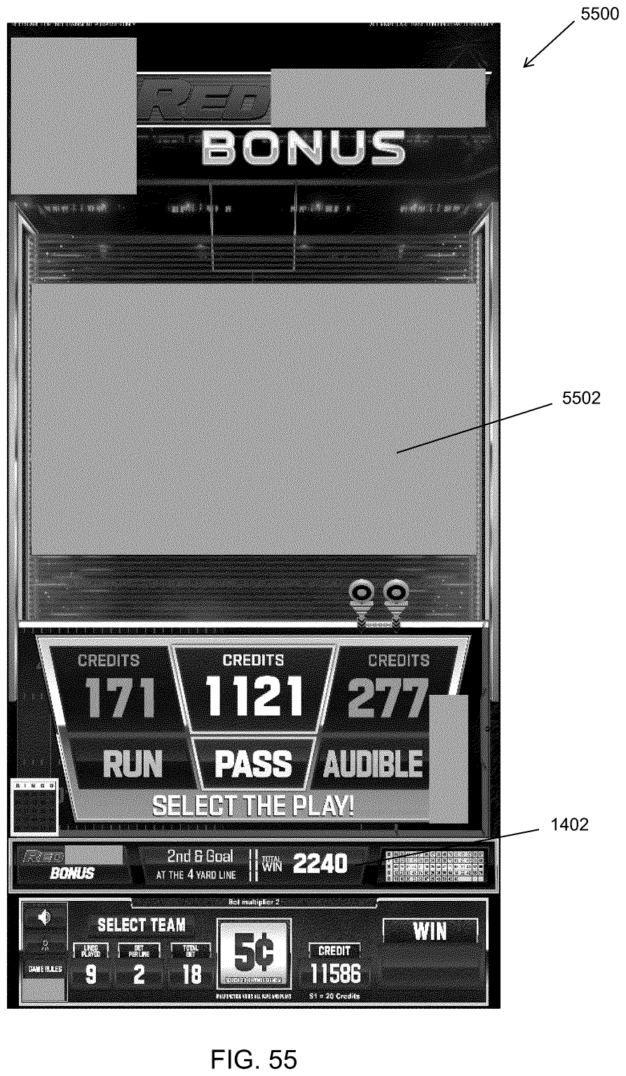

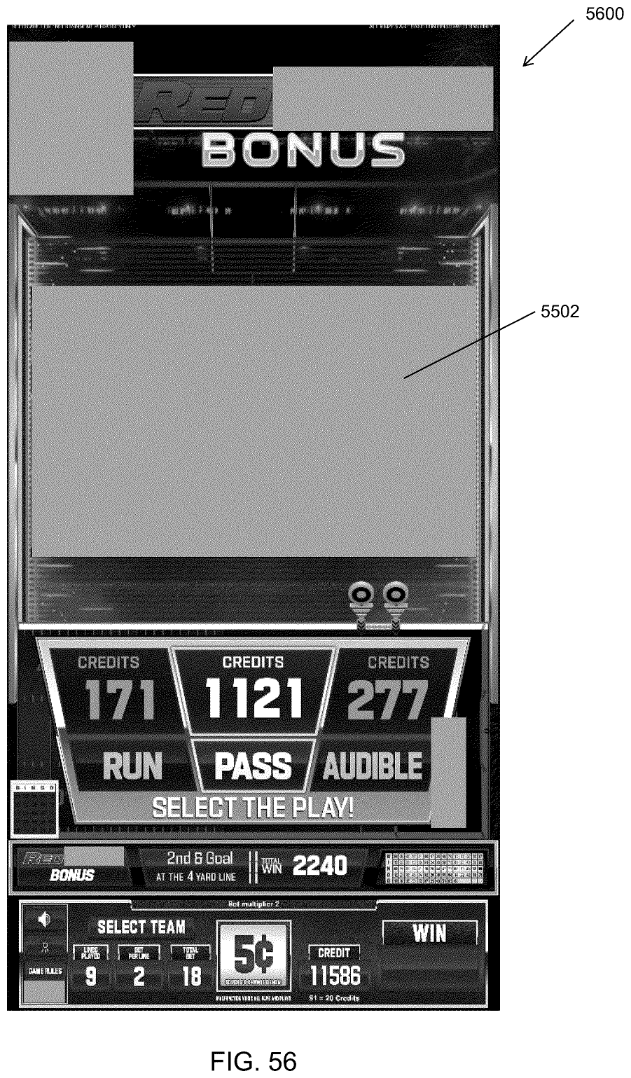

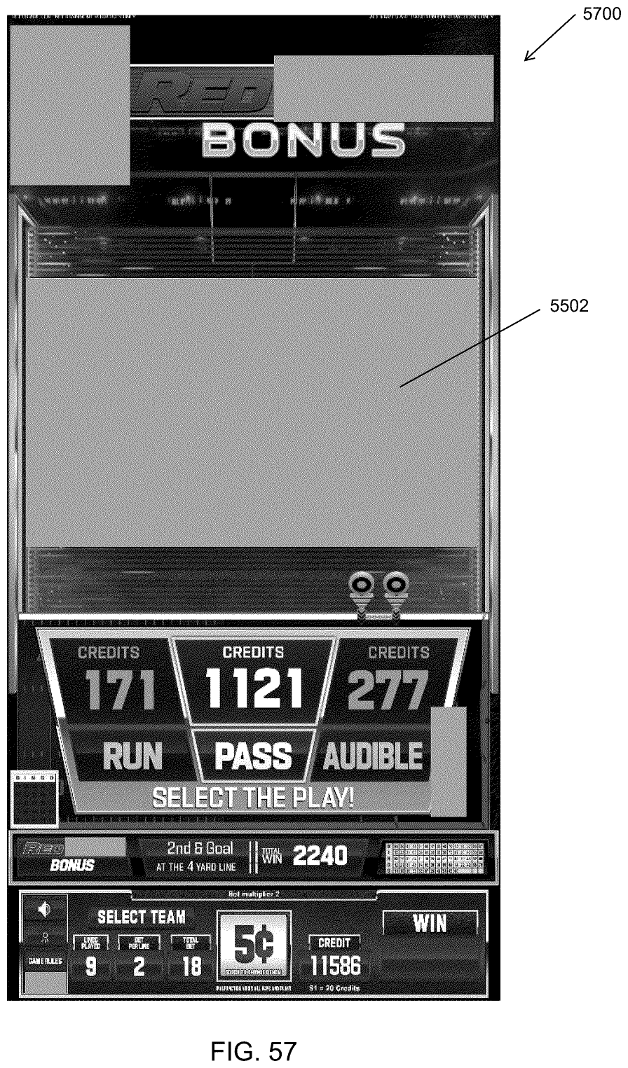

Further, the script indicates that the fifth play in the red zone bonus feature should result in a touchdown. Accordingly, in screenshots and/or interfaces 5500, 5600, and 5700 of FIGS. 55, 56, and 57 respectively, display area 5502 is provided to include a video clip of a touchdown from a football game. For example, a lookup may be performed for a video corresponding to the selected team, a touchdown being scored, and/or the type of selected play (e.g., in this instance, a pass play). Accordingly, based on the lookup, a video is displayed at display area 5502 of the selected team performing a pass play to score a touchdown to communicate that a touchdown has been achieved in the red zone bonus game. For example, FIG. 55 may include a portion of the video where a quarterback passes the ball, FIG. 56 may include a portion of the video where a receiver receives the pass, and FIG. 57 may include a portion of the video where the receiver crosses the goal line with the ball for a touchdown.

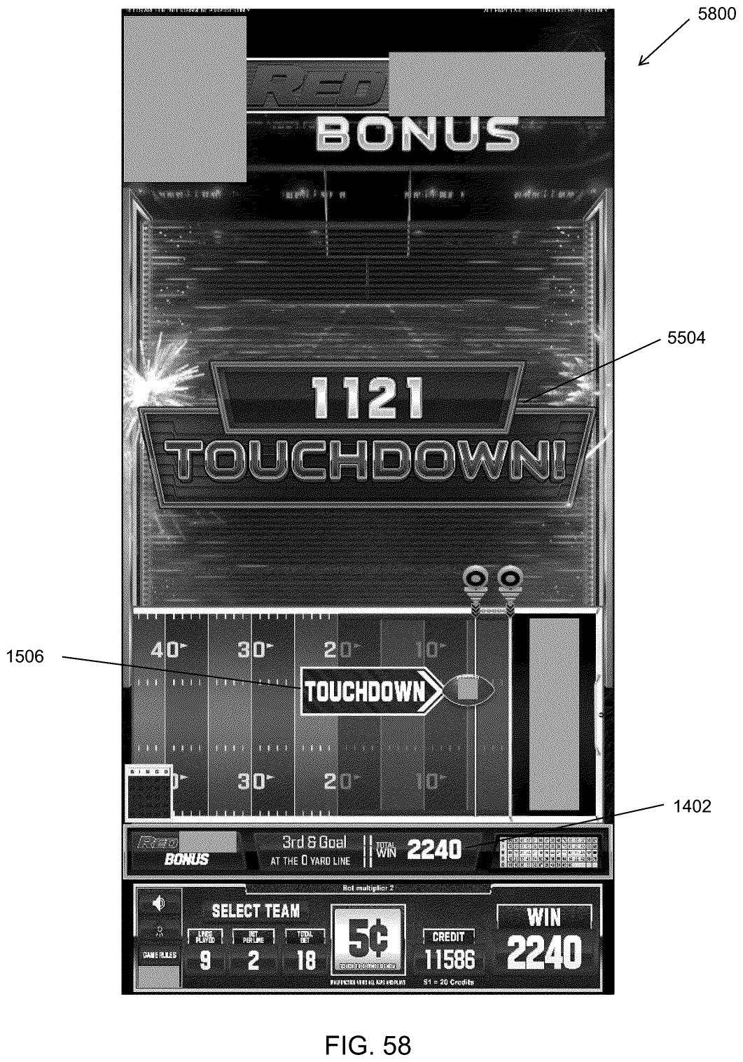

Accordingly, example screenshot and/or interface 5800 of FIG. 58 illustrates message 1506 being updated to correspond to a touchdown being scored. A message 5504 associated with the touchdown score is also provided for efficient communication. Credit meter 1402 has also been updated to 2240 credits to account for the 1121-credit amount for the touchdown score.

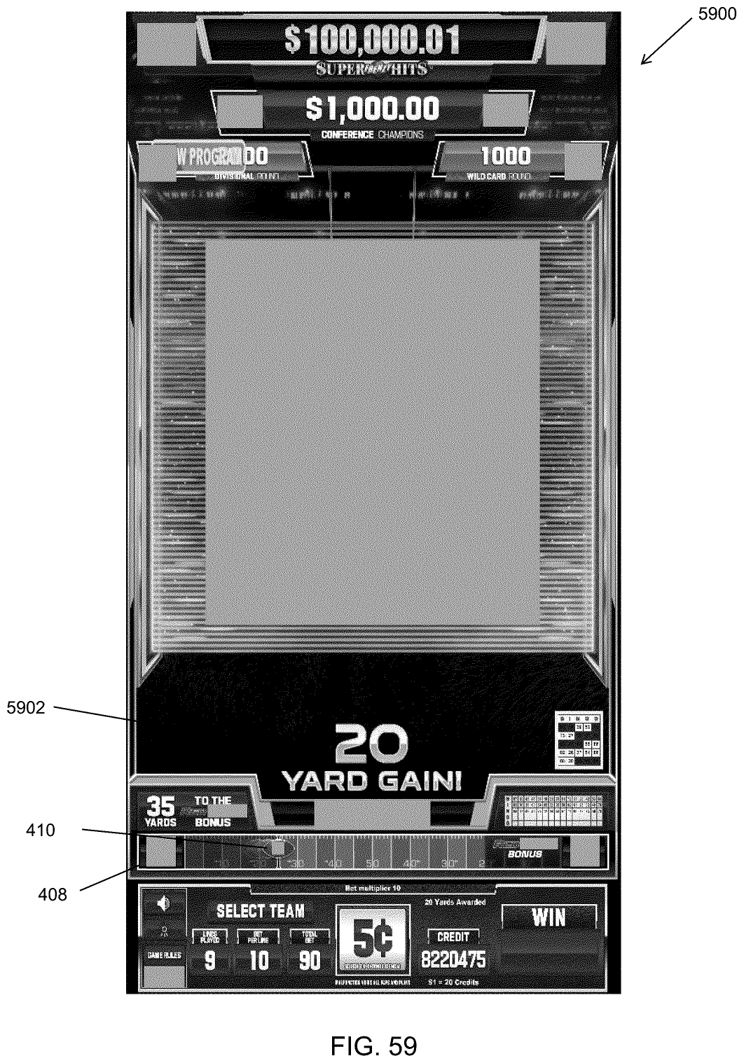

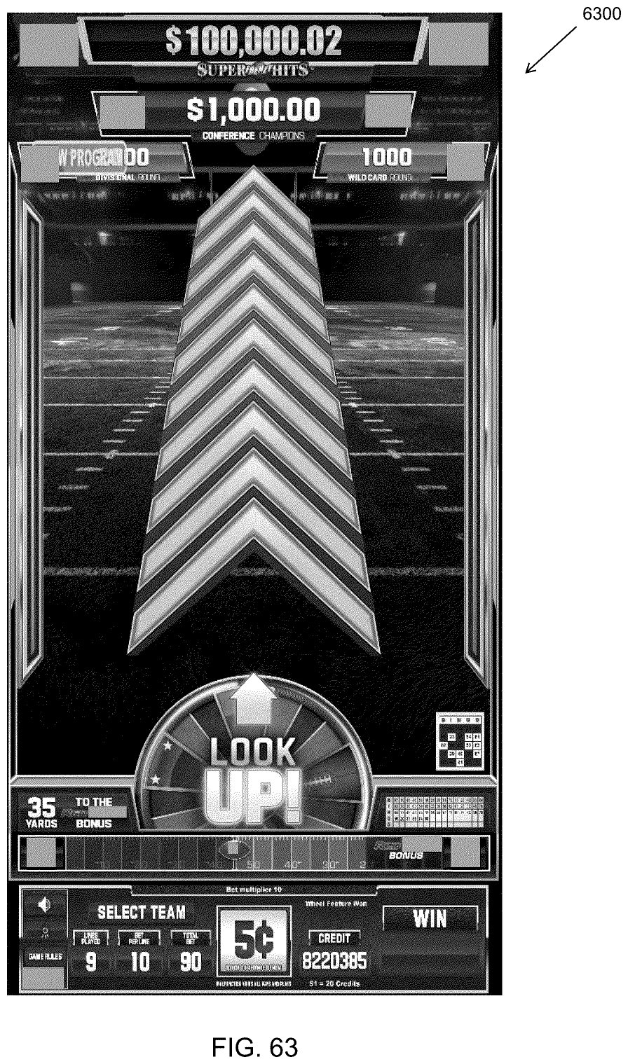

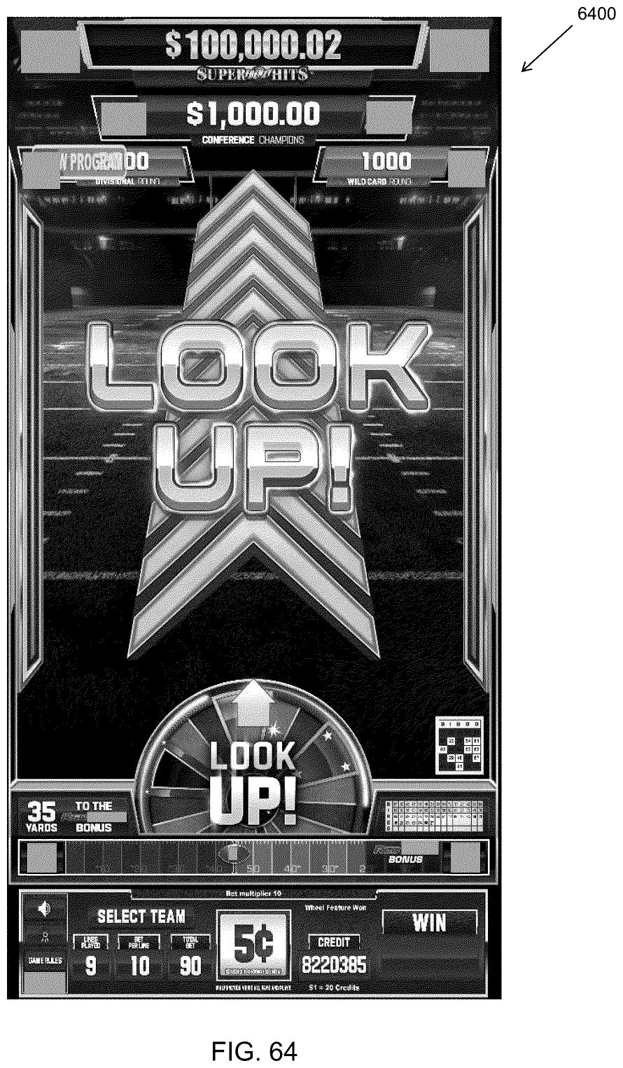

In some embodiments a wheel bonus is provided (e.g., randomly, from a standard/base spin, from last spin of a feature/bonus, etc.). Example screenshots and/or interfaces 5900, 6000, 6100, 6200, 6300, 6400, and 6500 of FIGS. 59, 60, 61, 62, 63, 64, and 65 respectively illustrate an example play of the wheel bonus.

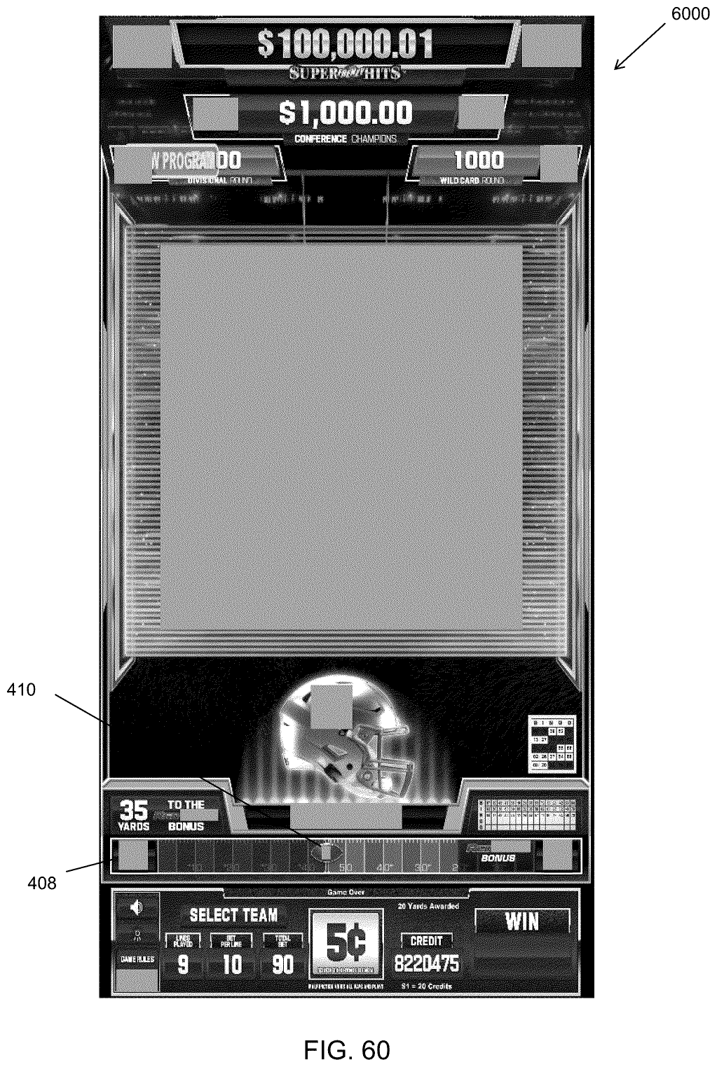

A player presses play, in this example for the base game, and, as shown in FIG. 59, a 20-yard gain is provided. Accordingly, football 410 is displayed as moving across field 408 and a message 5902 associated with the 20-yard game is provided. Once football 410 has reached an appropriate position on field 408, as shown in FIG. 60 and corresponding to the 20-yard gain, the wheel bonus is provided.

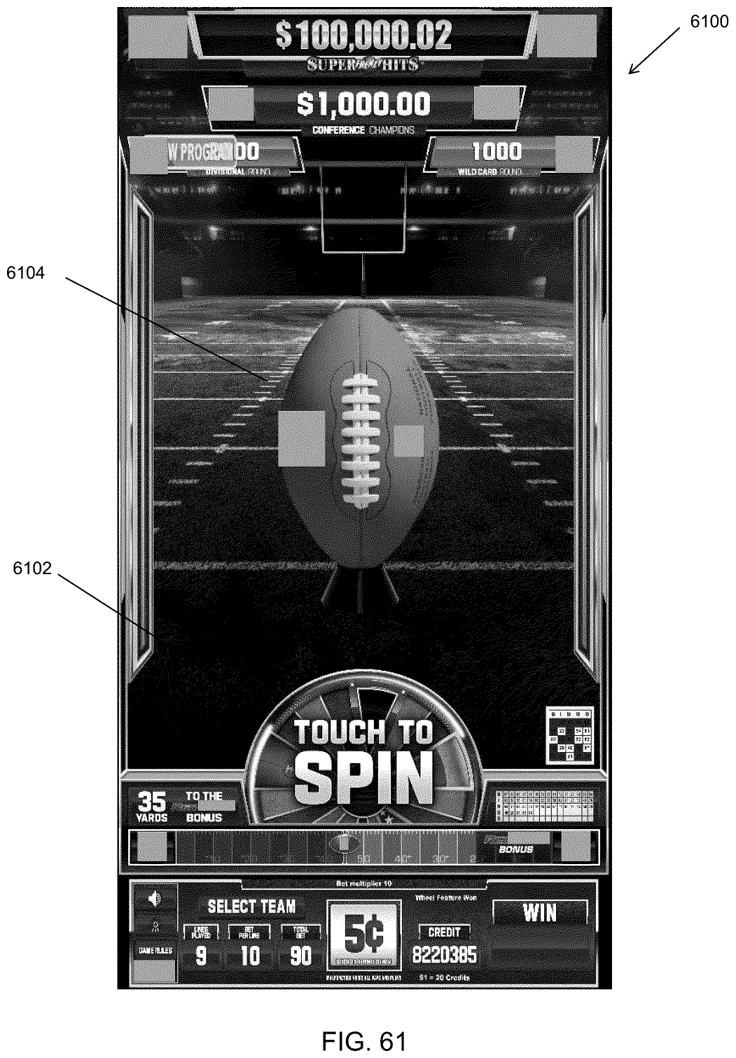

FIG. 61 illustrates a first screenshot and/or interface 6100 of the wheel bonus including a button 6102 (e.g., with “TOUCH TO SPIN” thereon communicating how to initiate a spin of the wheel) and the beginning of a field goal animation 6104 associated with a spin of the wheel. Lighting and music are provided and a bonus logo appears on a top screen. The player initiates a spin (e.g., presses button 6102, presses “spin”, with a physical lever, a play button, or touching the banner). Lighting changes, dimming of a top screen occurs, a wheel spins, a wheel wedge is won (e.g., the wheel spins and an indicator, such as an arrow, points to the wedge that is won), and a value associated with that wedge is provided.

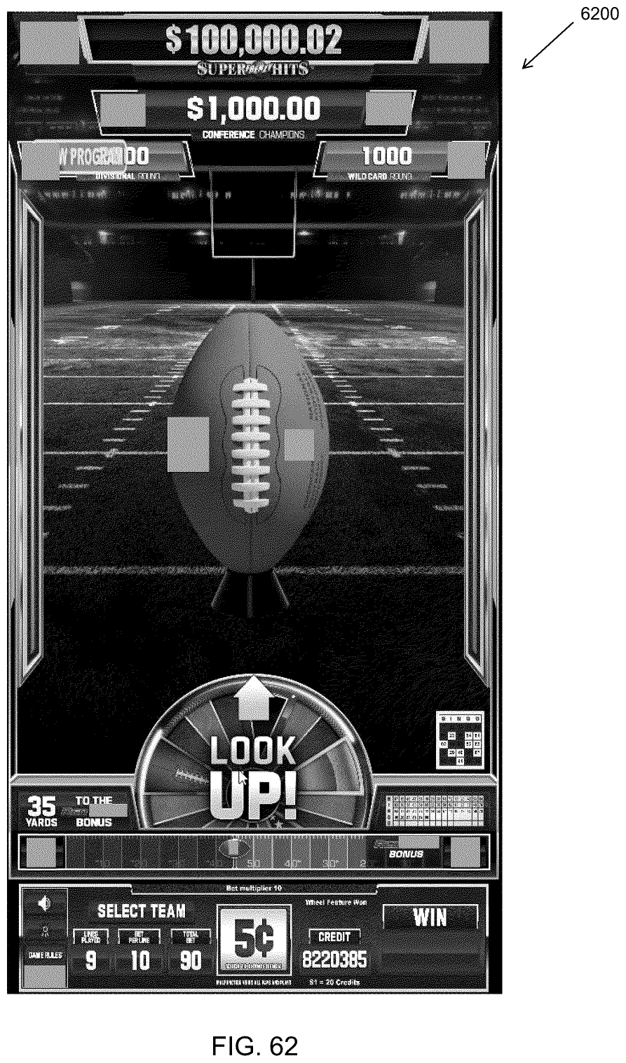

Animation 6104 continues through screenshots and/or interfaces 6200, 6300, and 6400 of FIGS. 62, 63, and 64 respectively (e.g., including arrows communicating that a player should “LOOK UP,” for example, at a wheel on an upper screen that is spinning). The value on a wedge is provided. Associated lighting and music are provided along with a video celebration on a top screen.

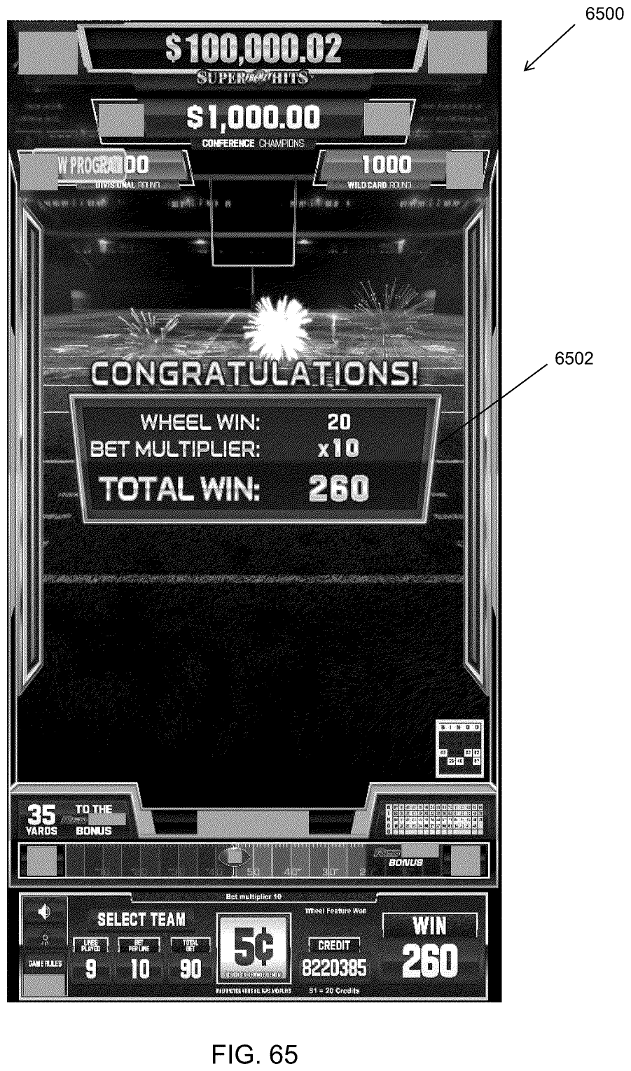

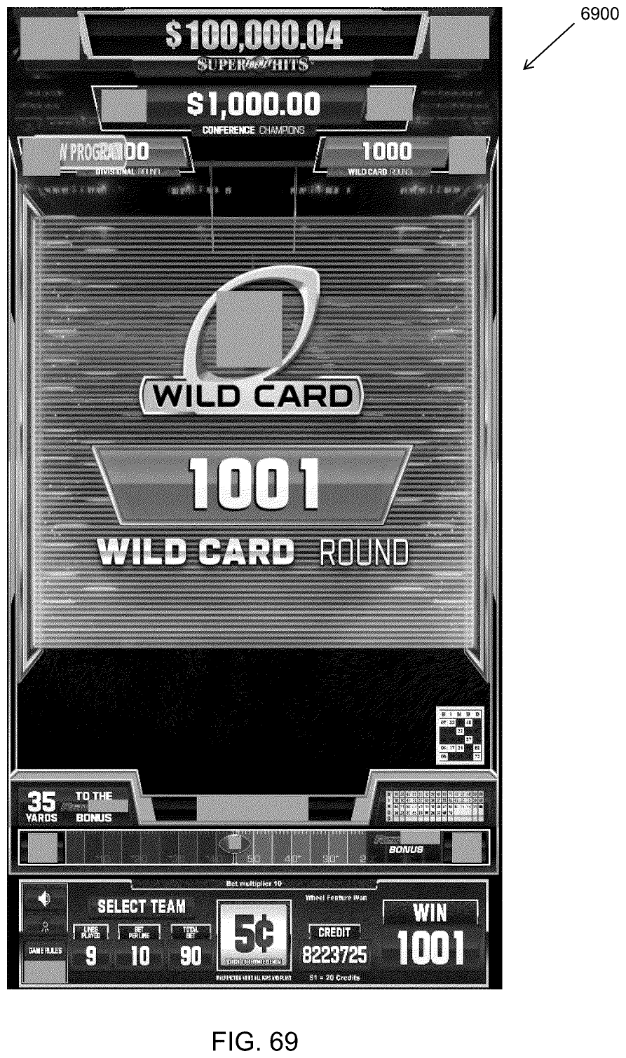

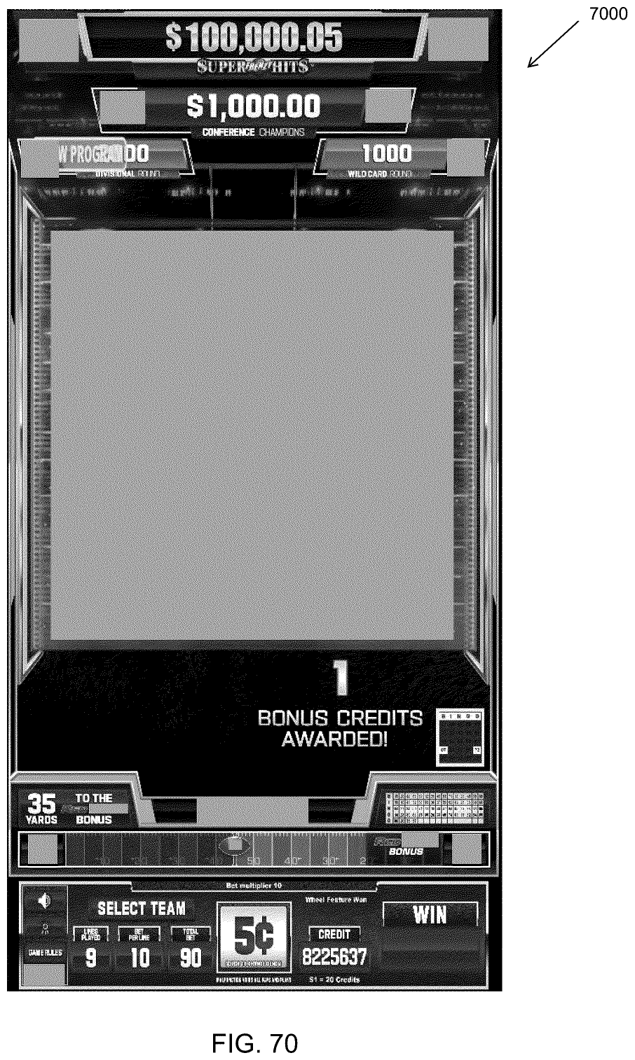

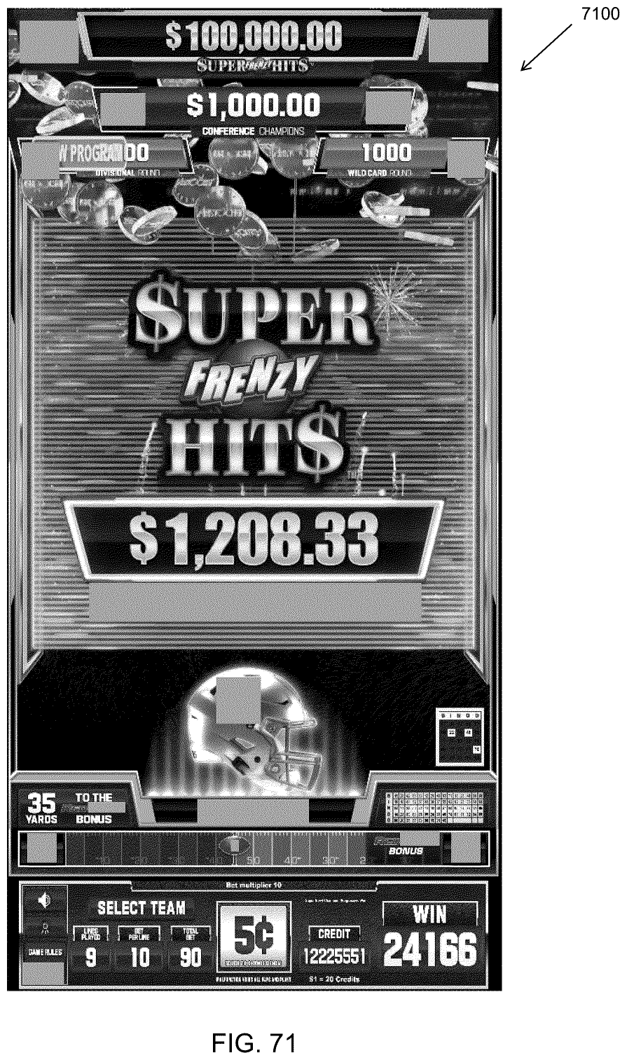

In this example, the value provided based on the wedge is 20 credits, with a 10× multiplier, and the addition of an amount of credits from the play that led to the wheel spin (e.g., in this case, 60 credits), resulting in a total win of 260 credits, as shown at message 6502 of screenshot and/or interface 6500 of FIG. 65. The value provided may be a jackpot associated with a theme of the game (e.g., playoff wins such as wild card round, divisional round, conference round, or championship round—see FIGS. 69-71 as examples).

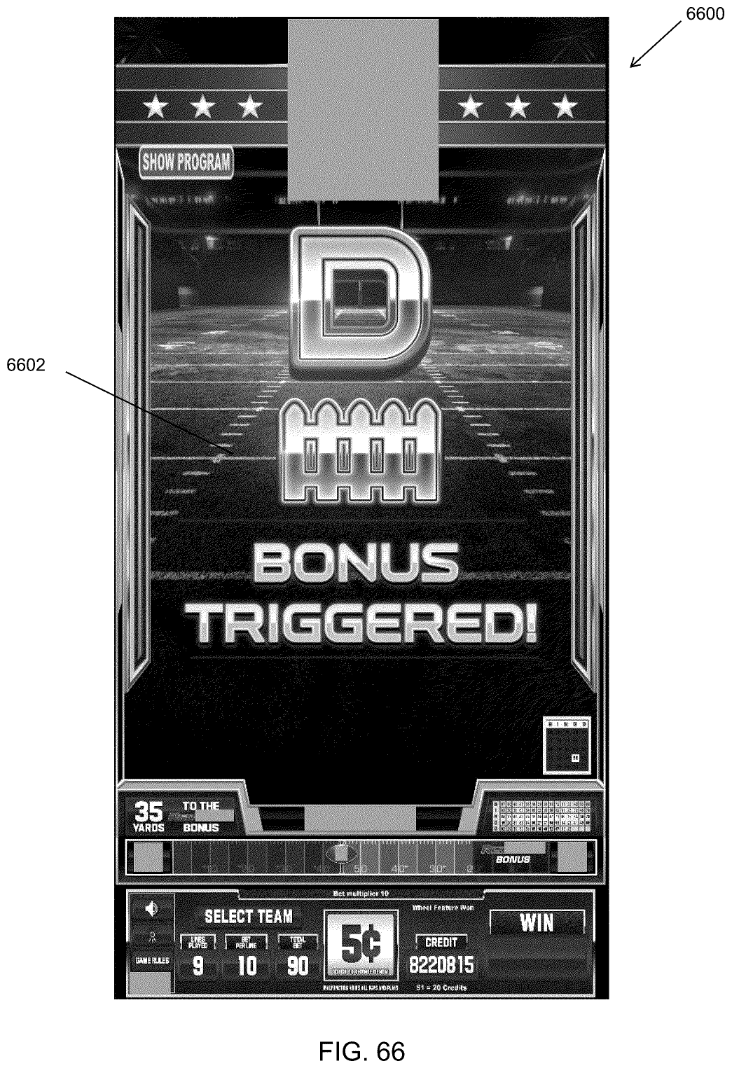

In some embodiments, a defensive stand feature is provided (e.g., if a defense, or “D-FENCE”, wedge is won during the wheel bonus, is provided randomly, etc.). Screenshots and/or interfaces 6600, 6700, and 6800 of FIGS. 66, 67, and 68 respectively illustrate one example of the defensive stand feature.

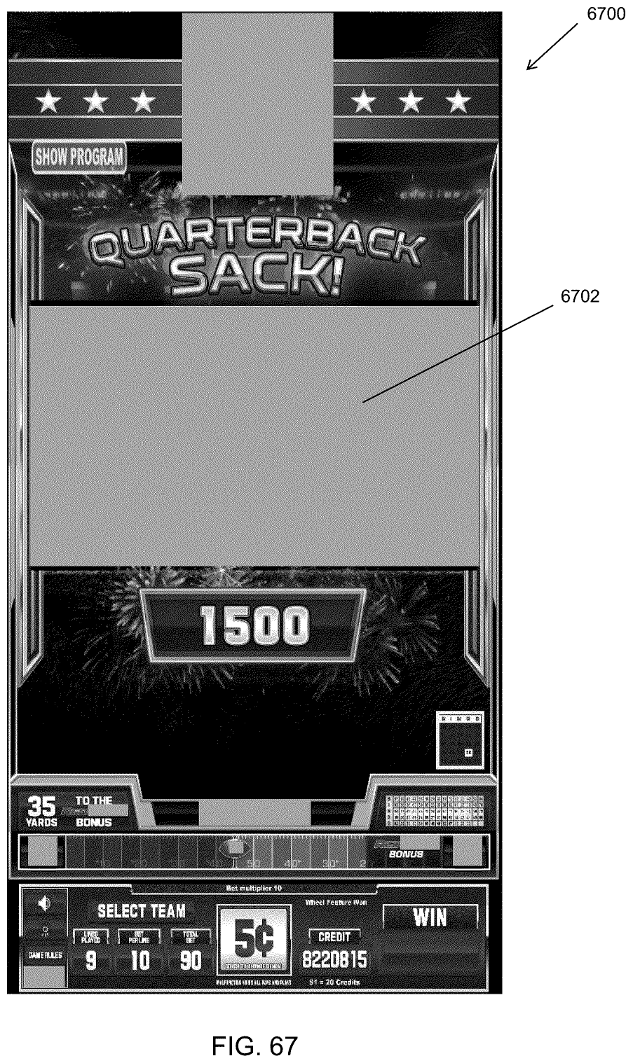

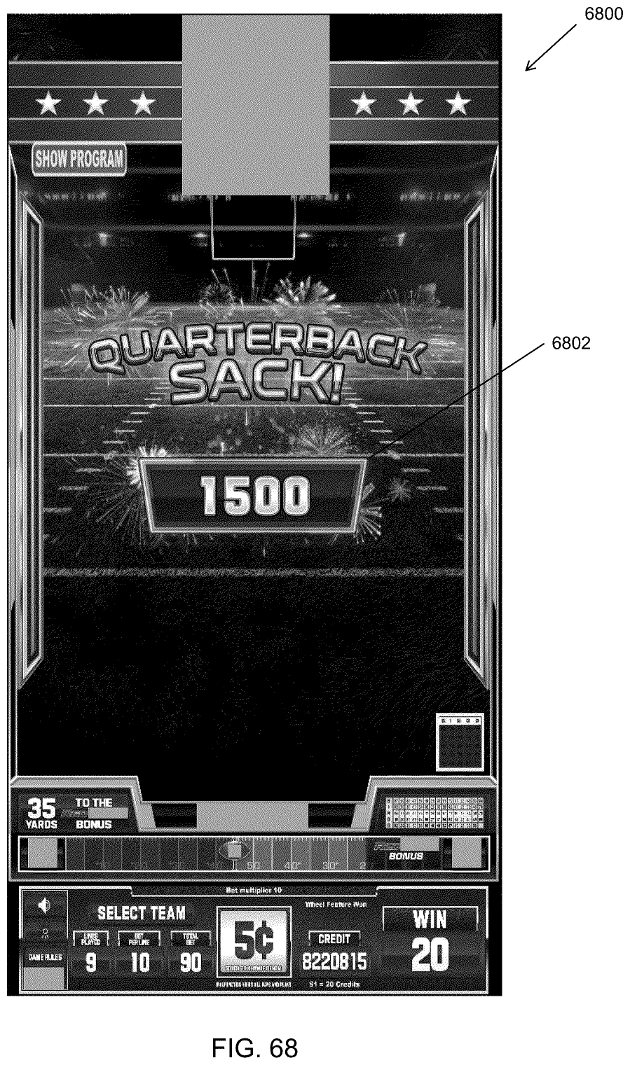

A message 6602 is provided to indicate that the defensive stand feature has been triggered. A lookup may be performed for a video clip of the selected team performing a defensive play. For instance, FIGS. 67 and 68 illustrate an example where a “SACK” defensive play is provided. Accordingly, a lookup is performed for a video of the selected team achieving a sack in a football game.

The selected video plays using the selected team's video clips at display area 6702 of FIG. 67. Different video clips are associated with different wins in memory. For example, a low win is associated with a blocked field goal or stop at the goal-line, a medium win is associated with a strip-sack, fumble recovery, or interception, and a big win is associated with a defensive touchdown (e.g., any of the above for a defensive touchdown, such as a pick-six or strip and score).

Credits are provided (e.g., in increments to the final total as the video completes), as shown at message 6802 of FIG. 68., and the game transitions back to the base game.

Screenshots and/or interfaces 6900, 7000, 7100 of FIGS. 69, 70, and 71 respectively illustrate presentations of various jackpot awards (e.g., wild card, division, conference, super).

In some embodiments, special lighting effects are used during the RZRS feature, big wins, or big “plays” or collection yards for the collection mechanic. Lighting/Music/Presentation may be provided during the wheel bonus trigger, an RZRS play, a red zone bonus play with of five or more re-spins, a big win of 10× bet or higher, a big play to trigger the red zone bonus feature, or a jackpot trigger.

In some embodiments, a default home team may be selected (e.g., by a casino operator) and, after a predetermined period of time with no plays of the game (e.g., thirty seconds after cash-out), the game may revert to a theme of the default home team.

In some embodiments, audio will play upon cash in, along with denomination and team selection occurring. The game may utilize multiple audio assets (e.g., as described herein) including audio effects that accompany graphic and lighting effects to make the gameplay experience more fun and immersive (e.g., voice overs from broadcasts of actual professional or amateur football games).

An attract mode is also provided that includes an animation within the comic in the top screen, a 3D Logo rotating on the top video screen, random video clips shown in rotation, and jackpots shown in rotation when the game is not being played.

FIG. 72 illustrates an example method 7200 of electronic gaming including a collection mechanic and a pick feature, in accordance with the present disclosure.

In the example embodiment, method 7200 includes causing display 7202 of an electronic game including an advanceable path (e.g., field 408) wherein the advanceable path includes a plurality of thresholds and wherein a collection of collectibles (e.g., yards) is associated with advancement across the advanceable path and causing 7204 advancement across the advanceable path based on the collection of the collectibles over one or more plays of the electronic game.

In the example embodiment, method 7200 also includes determining 7206 that a first threshold of advancement across the advanceable path has been achieved (e.g., advancement to red zone 414) and initiating 7208 a pick feature in response to the first threshold being achieved.

In the example embodiment, method 7200 further includes, for at least one play in the pick feature, receiving 7210 a selection of an advancement option of a plurality of advancement options (e.g., options 1304, 1306, 1308) wherein each of the plurality of advancement options is associated with a number of collectibles, determining 7212 an amount of advancement between the first threshold of advancement and a second threshold of advancement (e.g., the end zone) across the advanceable path associated with the advancement option, causing 7214 the amount of advancement to be displayed, and causing 7216 the pick feature to end upon an end condition of a plurality of end conditions being satisfied wherein the plurality of end conditions includes at least one of the second threshold of advancement being satisfied (e.g., a touchdown) or a predetermined amount of advancement not being achieved across a predetermined number of plays of the pick feature (e.g., no first down and/or touchdown achieved).

In some embodiments, method 7200 includes receiving at least one message from a server wherein the electronic game is a Class II electronic game and wherein the at least one message is associated with at least one of a bingo card or a ball call for the electronic game.

While the disclosure has been described with respect to the figures, it will be appreciated that many modifications and changes may be made by those skilled in the art without departing from the spirit of the disclosure. Any variation and derivation from the above description and figures are included in the scope of the present disclosure as defined by the claims.

What is claimed is:

1. An electronic gaming device comprising:
at least one memory with instructions stored thereon; and
at least one processor in communication with the at least one memory, wherein the instructions, when executed by the at least one processor, cause the at least one processor to:
cause display of an electronic game comprising an advanceable path, wherein the advanceable path comprises a plurality of thresholds, and wherein a collection of collectibles is associated with advancement across the advanceable path;
cause advancement across the advanceable path based on the collection of the collectibles over one or more plays of the electronic game;
determine that a first threshold of advancement across the advanceable path has been achieved;
initiate a pick feature in response to the first threshold being achieved; and
for at least one play in the pick feature:
receive a selection of an advancement option of a plurality of advancement options, wherein each of the plurality of advancement options is associated with a number of collectibles;
determine an amount of advancement between the first threshold of advancement and a second threshold of advancement across the advanceable path associated with the advancement option;
cause the amount of advancement to be displayed; and
cause the pick feature to end upon an end condition of a plurality of end conditions being satisfied, wherein the plurality of end conditions includes at least one of the second threshold of advancement being satisfied or a predetermined amount of advancement not being achieved across a predetermined number of plays of the pick feature.

2. The electronic gaming device of claim 1, wherein the instructions further cause the at least one processor to provide a predetermined starting number of plays for the pick feature.

3. The electronic gaming device of claim 2, wherein the instructions further cause the at least one processor to:
track a number of plays remaining in the pick feature, wherein the number of plays advances between the predetermined starting number of plays and the predetermined number of plays; and
when the predetermined amount of advancement is achieved before the predetermined number of plays is reached, cause the number of plays remaining to be reset to the predetermined starting number of plays.

4. The electronic gaming device of claim 1, wherein the plurality of advancement options includes a pass option, a run option, and an audible option.

5. The electronic gaming device of claim 1, wherein a theme of the electronic game is gridiron football, wherein the second threshold of advancement being satisfied is associated with a touchdown, and wherein the predetermined amount of advancement not being achieved across the predetermined number of plays is associated with a failed fourth down conversion.

6. The electronic gaming device of claim 5, wherein the plurality of end conditions further includes a second pick feature, wherein the second pick feature comprises a field goal feature that allows for selection of a field goal option.

7. The electronic gaming device of claim 1, wherein the electronic game is a Class II electronic game.

8. The electronic gaming device of claim 7, wherein the instructions further cause the at least one processor to receive at least one message from a server, and wherein the at least one message is associated with at least one of a bingo card or a ball call for the electronic game.

9. The electronic gaming device of claim 8, wherein the instructions further cause the at least one processor to provide a total output amount at the end of the pick feature, and wherein the total output amount is determined based at least in part on the at least one message.

10. At least one non-transitory computer-readable storage medium with instructions stored thereon that, in response to execution by at least one processor, cause the at least one processor to:
cause display of an electronic game comprising an advanceable path, wherein the advanceable path comprises a plurality of thresholds, and wherein a collection of collectibles is associated with advancement across the advanceable path;
cause advancement across the advanceable path based on the collection of the collectibles over one or more plays of the electronic game;
determine that a first threshold of advancement across the advanceable path has been achieved;
initiate a pick feature in response to the first threshold being achieved; and
for at least one play in the pick feature:
receive a selection of an advancement option of a plurality of advancement options, wherein each of the plurality of advancement options is associated with a number of collectibles;
determine an amount of advancement between the first threshold of advancement and a second threshold of advancement across the advanceable path associated with the advancement option;
cause the amount of advancement to be displayed; and
cause the pick feature to end upon an end condition of a plurality of end conditions being satisfied, wherein the plurality of end conditions includes at least one of the second threshold of advancement being satisfied or a predetermined amount of advancement not being achieved across a predetermined number of plays of the pick feature.

11. The at least one non-transitory computer-readable storage medium of claim 10, wherein the instructions further cause the at least one processor to provide a predetermined starting number of plays for the pick feature.

12. The at least one non-transitory computer-readable storage medium of claim 11, wherein the instructions further cause the at least one processor to:
track a number of plays remaining in the pick feature, wherein the number of plays advances between the predetermined starting number of plays and the predetermined number of plays; and
when the predetermined amount of advancement is achieved before the predetermined number of plays is reached, cause the number of plays remaining to be reset to the predetermined starting number of plays.

13. The at least one non-transitory computer-readable storage medium of claim 10, wherein the plurality of advancement options includes a pass option, a run option, and an audible option.

14. The at least one non-transitory computer-readable storage medium of claim 10, wherein a theme of the electronic game is gridiron football, wherein the second threshold of advancement being satisfied is associated with a touchdown, and wherein the predetermined amount of advancement not being achieved across the predetermined number of plays is associated with a failed fourth down conversion.

15. The at least one non-transitory computer-readable storage medium of claim 14, wherein the plurality of end conditions further includes a second pick feature, wherein the second pick feature comprises a field goal feature that allows for selection of a field goal option.

16. The at least one non-transitory computer-readable storage medium of claim 10, wherein the electronic game is a Class II electronic game.

17. The at least one non-transitory computer-readable storage medium of claim 16, wherein the instructions further cause the at least one processor to receive at least one message from a server, and wherein the at least one message is associated with at least one of a bingo card or a ball call for the electronic game.

18. The at least one non-transitory computer-readable storage medium of claim 17, wherein the instructions further cause the at least one processor to provide a total output amount at the end of the pick feature, and wherein the total output amount is determined based at least in part on the at least one message.

19. A method of electronic gaming implemented by at least one processor in communication with at least one memory, the method comprising:
causing display of an electronic game comprising an advanceable path, wherein the advanceable path comprises a plurality of thresholds, and wherein a collection of collectibles is associated with advancement across the advanceable path;
causing advancement across the advanceable path based on the collection of the collectibles over one or more plays of the electronic game;
determining that a first threshold of advancement across the advanceable path has been achieved;
initiating a pick feature in response to the first threshold being achieved; and
for at least one play in the pick feature:
receiving a selection of an advancement option of a plurality of advancement options, wherein each of the plurality of advancement options is associated with a number of collectibles;
determining an amount of advancement between the first threshold of advancement and a second threshold of advancement across the advanceable path associated with the advancement option;
causing the amount of advancement to be displayed; and
causing the pick feature to end upon an end condition of a plurality of end conditions being satisfied, wherein the plurality of end conditions includes at least one of the second threshold of advancement being satisfied or a predetermined amount of advancement not being achieved across a predetermined number of plays of the pick feature.

20. The method of claim 19, further comprising receiving at least one message from a server, wherein the electronic game is a Class II electronic game, and wherein the at least one message is associated with at least one of a bingo card or a ball call for the electronic game.
